(19) United States
(12) Patent Application Publication
(10) Pub. No.: US 2024/0196415 A1
(43) Pub. Date: Jun. 13, 2024

(54) METHOD AND APPARATUS FOR INDICATING DYNAMIC WAVEFORM SWITCHING MODE IN WIRELESS COMMUNICATION SYSTEM

(71) Applicant: Samsung Electronics Co., Ltd., Gyeonggi-do (KR)

(72) Inventors: Jaewon LEE, Gyeonggi-do (KR); Youngbum KIM, Gyeonggi-do (KR); Cheolkyu SHIN, Gyeonggi-do (KR); Kyungjun CHOI, Gyeonggi-do (KR)

(21) Appl. No.: 18/508,767

(22) Filed: Nov. 14, 2023

(30) Foreign Application Priority Data
Nov. 14, 2022 (KR) 10-2022-0151904

(51) Int. Cl. H04W 72/232; H04L 5/00; H04W 72/1268; H04W 76/20

(52) U.S. Cl. CPC H04W 72/232; H04L 5/0051; H04W 72/1268; H04W 76/20

(57) ABSTRACT

The disclosure relates to a fifth generation (5G) or sixth generation (6G) communication system for supporting higher data rates. Disclosed is a method performed by a terminal in a wireless communication system, including receiving downlink control information (DCI) from a base station, identifying whether the DCI includes a dynamic waveform indicator, and in case that the DCI includes a dynamic waveform indicator, transmitting, to the base station, an uplink signal through a physical uplink shared channel (PUSCH) based on an uplink waveform indicated by the dynamic waveform indicator.

### CROSS REFERENCE TO RELATED APPLICATION

The present application claims priority under 35 U.S.C. § 119(a) to Korean Patent Application No. 10-2022-0151904, filed in the Korean Intellectual Property Office on Nov. 14, 2022, the entire content of which is incorporated herein by reference.

### BACKGROUND

### 1. Field

The disclosure relates generally to a wireless communication system, and more particularly, to a method and apparatus for indicating dynamic waveform switching in a wireless communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) including 28 GHz, 39 GHz, and the like. In addition, it has been considered to implement sixth generation (6G) mobile communication technologies (referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low-latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol field regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service field regarding a 5G service based architecture or service based interface for combining network functions virtualization (NFV) and software-defined networking (SDN) technologies, and mobile edge computing (MEC) for receiving services based on UE positions.

As such 5G mobile communication systems are commercialized, it is expected that the number of devices that will be connected to communication networks will exponentially increase. Thus, it is anticipated that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources are being developed.

### SUMMARY

This disclosure has been made to address at least the above-mentioned problems and/or disadvantages and to provide at least the advantages described below.

Accordingly, an aspect of the disclosure is to provide a method and apparatus for indicating dynamic waveform switching to support the dynamic waveform switching in a wireless communication system.

In accordance with an aspect of the disclosure, a method performed by a terminal in a wireless communication system includes receiving downlink control information (DCI) from a base station, identifying whether the DCI includes a dynamic waveform indicator, and in case that the DCI includes a dynamic waveform indicator, transmitting, to the base station, an uplink signal through a physical uplink shared channel (PUSCH) based on an uplink waveform indicated by the dynamic waveform indicator.

In accordance with an aspect of the disclosure, a method performed by a base station in a wireless communication system includes transmitting DCI to a terminal, and in case that the DCI includes a dynamic waveform indicator, receiving, from the terminal, an uplink signal through a PUSCH based on an uplink waveform indicated by the dynamic waveform indicator.

In accordance with an aspect of the disclosure, a terminal in a wireless communication system includes a transceiver and a controller connected to the transceiver, the controller being configured to receive DCI from a base station, determine whether the DCI includes a dynamic waveform indicator, and in case that the DCI includes a dynamic waveform indicator, transmit, to the base station, an uplink signal through a PUSCH based on an uplink waveform indicated by the dynamic waveform indicator.

In accordance with an aspect of the disclosure, a base station in a wireless communication system includes a transceiver and a controller connected to the transceiver, the controller being configured to transmit DCI to a terminal, and in case that the DCI includes a dynamic waveform indicator, receive, from the terminal, an uplink signal through a PUSCH based on an uplink waveform indicated by the dynamic waveform indicator.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a basic structure of a time-frequency resource area in a 5G system according to an embodiment;

FIG. 2 illustrates a time domain mapping structure of a synchronization signal and beam sweeping operation according to an embodiment;

FIG. 3 illustrates of a random access procedure according to an embodiment;

FIG. 4 illustrates a procedure in which a UE reports UE capability information to a base station according to an embodiment;

FIG. 5 illustrates a control resource set (CORESET) as a time-frequency resource to which a physical downlink control channel (PDCCH) is mapped according to an embodiment;

FIG. 6 illustrates an example in which DCI and demodulation reference signal (DMRS) are mapped to REG, a basic unit of a downlink control channel according to an embodiment;

FIG. 7 illustrates base station beam allocation according to a TCI state configuration according to an embodiment;

FIG. 8 illustrates a hierarchical signaling method for dynamic allocation of PDCCH beams by NR according to an embodiment;

FIG. 9 illustrates the TCI indication medium access control control element (MAC CE) signaling structure for a PDCCH DMRS according to an embodiment;

FIG. 10 illustrates a method by which a base station and a UE transmit and receive data by considering a DL data channel and a rate matching resource according to an embodiment;

FIG. 11 illustrates an aperiodic channel state information (CSI) reporting method when a CSI-RS offset is 0 according to an embodiment;

FIG. 12 illustrates an aperiodic CSI reporting method when a CSI-RS offset is 1 according to an embodiment;

FIG. 13 illustrates a transmission block diagram for transmission signal generation in a 5G communication system according to an embodiment;

FIG. 14 illustrates a UE operation procedure related to Type 1 transform precoding determination according to an embodiment;

FIG. 15 illustrates a UE operation procedure related to Type 2 transform precoding determination according to an embodiment;

FIG. 16 illustrates a UE operation procedure related to Type 3 transform precoding determination according to an embodiment;

FIG. 17 illustrates the branching of dynamic waveform indication by schematizing overall application of transform precoding according to three PUSCH types affected by transform precoding according to an embodiment;

FIG. 18 illustrates a method of DCI-based signaling from a base station to a UE for dynamic waveform indication according to an embodiment;

FIG. 19 illustrates resource allocation type 0 of frequency domain resource allocation (FDRA) according to an embodiment;

FIG. 20 illustrates resource allocation type 1 of FDRA according to an embodiment;

FIG. 21 illustrates a transmitter and receiver of a UE according to an embodiment;

FIG. 22 is a block diagram of a structure of a UE according to an embodiment; and

FIG. 23 is a block diagram illustrating a structure of a base station according to an embodiment.

### DETAILED DESCRIPTION OF THE INVENTION

Hereinafter, embodiments of the disclosure will be described with reference to accompanying drawings. While describing the disclosure, detailed description of related well-known functions or constitutions may be omitted when it is deemed that they may unnecessarily obscure the essence of the disclosure. Also, terms used below are defined in consideration of functions in the disclosure and may have different meanings according to an intention of a user or operator, customs, or the like. Thus, the terms should be defined based on the description throughout the specification.

Advantages and features of the disclosure and methods of accomplishing the same may be understood more readily by reference to the following detailed description of the embodiments of the disclosure and the accompanying drawings. However, the embodiments of the disclosure may have different forms and should not be construed as being limited to the descriptions set forth herein. Rather, these embodiments of the disclosure are provided so that the disclosure will be thorough and complete and will fully convey the concept of the disclosure to one of ordinary skill in the art. Throughout the specification, like reference numerals denote like elements.

Herein, an element included in the disclosure is expressed in a singular or plural form depending on the presented specific embodiments. However, singular or plural expressions are selected to be suitable for situations presented for convenience of description, and the disclosure is not limited to elements in a singular or plural form, i.e., an element expressed in a plural form may be configured as a single element, or an element expressed in a singular form may be configured as a plurality of elements.

The term ‘unit in the embodiments indicates a software component or hardware component such as a field-programmable gate array (FPGA) or an application-specific integrated circuit (ASIC), and performs a specific function. However, the term unit is not limited to software or hardware. The unit may be constituted so as to be in an addressable storage medium or may be constituted so as to operate one or more processors. Thus, for example, the term unit may refer to components such as software, object-oriented software, class, and task components, and may include processes, functions, attributes, procedures, subroutines, segments of program code, drivers, firmware, micro codes, circuits, data, a database, data structures, tables, arrays, or variables. A function provided by the components and units may be associated with the smaller number of components and units or may be divided into additional components and units. The components and units may be embodied to reproduce one or more central processing units (CPUs) in a device or security multimedia card, and the unit may include at least one processor.

Terms for identifying access nodes and for denoting network entities, messages, terms denoting interfaces between network entities, various types of identification information, etc. used herein are described for convenience of description. Thus, the terms used in the disclosure are not limited and other terms denoting targets having the same technical meanings may be used.

Herein, a physical channel and a signal may be interchangeably used with data or a control signal. For example, a physical downlink shared channel (PDSCH) indicates a physical channel through which data is transmitted but may be used to indicate data. That is, transmitting a physical channel herein may indicate transmitting data or a signal through a physical channel.

In the disclosure, higher layer signaling refers to a signal transmission method for transmitting, by a base station, signals to a terminal by using a DL data channel of a physical layer, or for transmitting, by a terminal, signals to a base station by using an UL data channel of a physical layer, such as by radio resource control (RRC) signaling or a media access control (MAC) control element (CE).

For convenience of description, the disclosure uses terms and names defined in the 3^{rd} generation partnership project (3GPP) NR mobile communication standards but is not limited by the terms and name, and may be equally applied to systems conforming to other standards. A terminal herein may refer to a mobile phone, a smart phone, an Internet of things (IoT) device, a sensor, or other wireless communication devices.

Hereinafter, a base station is an entity that assigns resources of a terminal, and may be at least one of a gNode B, a gNB, an eNode B, an eNB, a Node B, BS, a wireless access unit, a base station controller, and a node on a network. A terminal may include a UE, a mobile station (MS), a cellular phone, a smartphone, a computer, or a multimedia system capable of performing a communication function. The disclosure is not limited to the above examples.

To handle mobile data traffic which has dramatically increased in the recent years, the initial standards of a next-generation communication system, 5G system or New Radio access technology (NR) after long term evolution (LTE) (or evolved universal terrestrial radio access (E-UTRA)) and LTE-advanced (LTE-A) (or E-UTRA Evolution) have been completed. Beyond the existing mobile communication systems focused on traditional voice/data communication, the 5G system aims to satisfy various services and requirements, such as enhanced mobile broadband (eMBB) service for improving existing voice/data communication, ultra-reliable and low latency communication (URLLC) service, and massive machine type communication (MTC) supporting communication between multiple things.

Compared to the legacy LTE and LTE-A systems in which a system transmission bandwidth per carrier is limited to up to 20 MHz, the 5G system mainly aims to provide ultra-high-speed data services at up to several Gbps in an ultra-wide bandwidth much wider than in the legacy LTE and LTE-A systems. Accordingly, an ultra-high frequency band from several GHz to up to 100 GHz, in which it is relatively easy to secure the ultra-wide bandwidth, is considered as a candidate frequency for the 5G system. In addition, it is possible to secure a wide-bandwidth frequency for the 5G system through frequency relocation or allocation among frequency bands included in hundreds of MHz to several GHz used in the legacy mobile communication systems.

A radio wave in the ultra-high frequency band has a wavelength of several millimeters and is also referred to as a millimeter wave (mmWave). However, the pathloss of radio waves increases in proportion to a frequency band in the ultra-high frequency band, thereby reducing the coverage of a mobile communication system.

To overcome the drawback of reduced coverage in the ultra-high frequency band, beamforming technology is applied to increase the propagation distance of radio waves by concentrating the radiation energy of the radio waves on a specific target point using a plurality of antennas. That is, a beamformed signal has a relatively narrow beam width and concentrates radiation energy in the narrow beamwidth to increase the propagation distance of radio waves. The beamforming technology may be applied to each of a transmitter and a receiver. In addition to the effect of increasing coverage, beamforming technology reduces interference in areas in other directions than a beamforming direction. For appropriate beamforming, there is a need for a method for accurately measuring a transmission/reception beam and feeding back the measurement. The beamforming technology may be applied to a control channel or a data channel in a one-to-one correspondence between a specific UE and a base station. Further, the beamforming technology may also be applied to a common signal that the base station transmits to a plurality of UEs in the system, for example, a synchronization signal, a physical broadcast channel (PBCH), a control channel carrying system information, and a data channel, to increase coverage. When the beamforming technology is applied to a common signal, beam sweeping technology may further be applied to the common signal to transmit the signal by switching beam directions. Therefore, the common signal may reach a UE at any position within a cell.

Another requirement of the 5G system is an ultra-low latency service with a transmission delay of about 1 ms between a transmitter and a receiver. As one method to reduce a transmission delay, a frame structure needs to be designed based on a short transmission time interval (TTI) shorter than in LTE and LTE-A. A TTI is a basic time unit for scheduling. In the legacy LTE and LTE-A systems, the TTI is the length of one subframe, 1 ms. For example, 0.5 ms, 0.25 ms, 0.125 ms, or the like shorter than in the legacy LTE and LTE-A systems is available as a short TTI that satisfies the requirements of the ultra-low latency service in the 5G system.

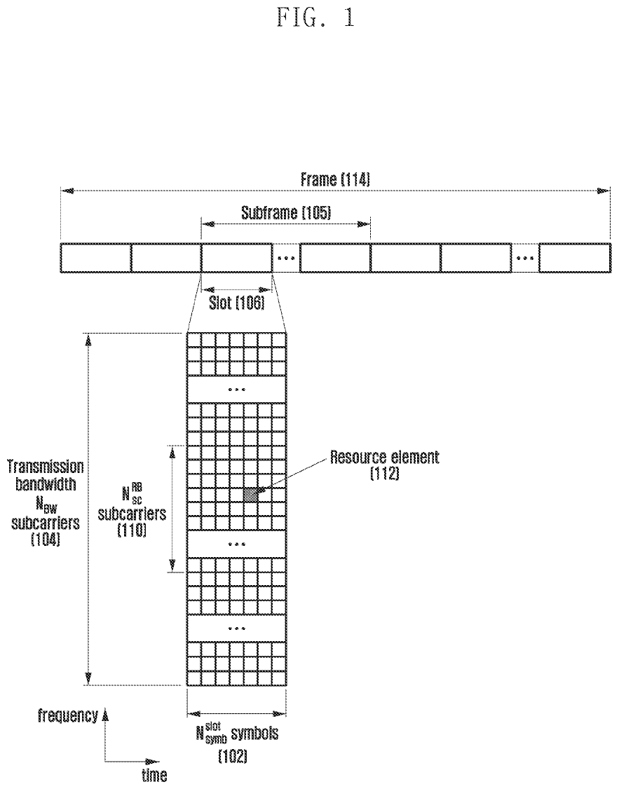

FIG. 1 illustrates a basic structure of a time-frequency resource area in a 5G system according to an embodiment. That is, FIG. 1 illustrates the basic structure of a time-frequency resource area, which is a radio resource area carrying data or a control channel in the 5G system.

In FIG. 1, the horizontal axis represents a time domain, and the vertical axis represents a frequency domain. In the 5G system, a minimum transmission unit in the time domain is an orthogonal frequency division multiplexing (OFDM) symbol. N_{symb}^{slot} symbols 102 may be gathered to constitute one slot 106, and Nₛₗₒₜ^{subframe} slots may be gathered to constitute one subframe 105. 10 subframes each being 1.0 ms long may be gathered to constitute a 10 ms frame 114. A minimum transmission unit in the frequency domain is a subcarrier, and the bandwidth of the entire system transmission bandwidth may be constituted with subcarriers 104 in total.

A basic resource unit in the time-frequency domain is a resource element (RE) 112, which may be represented by an OFDM symbol index and a subcarrier index. A resource block (RB or physical resource block (PRB)) may be defined as N_{SC}^{RB} consecutive subcarriers 110 in the frequency domain. In the 5G system, N_{SC}^{RB}=12, and a data rate may increase in proportion to the number of RBs scheduled for a UE.

In the 5G system, a base station may map data on an RB basis, and RBs included in one slot may be generally scheduled for a specific UE. That is, a basic time unit for scheduling may be a slot, and a basic frequency unit for scheduling may be an RB in the 5G system.

The number, N_{symb}^{slot}, of OFDM symbols is determined according to the length of a cyclic prefix (CP) added to each symbol to prevent inter-symbol interference. For example, N_{symb}^{slot}=14 when applying a normal CP, and N_{symb}^{slot}=12 when applying an extended CP. The extended CP is applied to a system having a longer propagation distance than the normal CP, so that orthogonality between symbols may be maintained. In the case of the normal CP, the ratio between a CP length and a symbol length is maintained constant, and thus the overhead of the CP may be maintained constant regardless of a subcarrier spacing. That is, when the subcarrier spacing is smaller, the symbol length may be increased, and accordingly, the CP length may also be increased. On the contrary, when the subcarrier spacing is larger, the symbol length may be decreased, and accordingly, the CP length may also be decreased. The symbol length and the CP length may be inversely proportional to the subcarrier spacing.

The 5G system may support various frame structures by adjusting the subcarrier spacing in order to satisfy various services and requirements. For example, as to an operating frequency band, a larger subcarrier spacing is more favorable in recovering the phase noise of a high frequency band. As to a transmission time, as the subcarrier spacing is larger, the symbol length in the time domain decreases. Thus, the slot length decreases, which is advantageous to support an ultra-low latency service such as URLLC. As to a cell size, because a larger cell may be supported with a larger CP length, a larger cell may be supported with a smaller subcarrier spacing. A cell conceptually refers to an area covered by one BS in mobile communication.

The subcarrier spacing, CP length, and so on are essential information for OFDM transmission/reception, and smooth transmission/reception is possible only when the base station and the UE recognize them as common values. Table 1 below shows the relationship among subcarrier spacing configurations μ, subcarrier spacing Δf, and CP lengths supported by the 5G system.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows the number, N_{symb}^{slot}, of symbols per slot, the number, Nₛₗₒₜ^{frame,μ}, of slots per frame, and the number, Nₛₗₒₜ^{frame,μ}, of slots per subframe for each subcarrier spacing configuration μ, in the case of the normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below shows the number, N_{symb}^{slot}, of symbols per slot, the number, Nₛₗₒₜ^{frame,μ}, of slots per frame, and the number, Nₛₗₒₜ^{frame,μ}, of slots per subframe for each subcarrier spacing configuration μ in the case of the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At the initial introduction of the 5G system, at least coexistence or a dual mode operation with the legacy LTE/LTE-A system was expected. Therefore, the legacy LTE/LTE-A may provide a stable system operation to the UE, and the 5G system may provide an advanced service to the UE. Accordingly, the frame structures of the 5G system needs to include at least the frame structure or essential parameter set (subcarrier spacing=15 kHz) of LTE/LTE-A.

For example, when comparing the frame structure with subcarrier spacing configuration μ=0 (hereinafter referred to as frame structure A) and the frame structure with subcarrier spacing configuration μ=1 (hereinafter referred to as frame structure B), in the frame structure B compared to the frame structure A, the subcarrier spacing and a size of an RB are increased to be twice as large, and a slot length and a symbol length are decreased to be twice as small. In case of frame structure B, two slots may constitute one subframe, and 20 subframes may constitute one frame.

When the frame structure of the 5G system is normalized, a subcarrier spacing, a CP length, a slot length, and the like, which are an essential parameter set, may have the integer-multiple relation therebetween according to each frame structure, so as to provide high scalability. To indicate a reference time unit unrelated to the frame structure, a subframe having a fixed length of 1 ms may be defined.

The frame structure may be applied to correspond to various scenarios. In view of a cell size, when a CP length is increased, a larger cell may be supported, and thus the frame structure A may support a relatively large cell, compared to the frame structure B. In view of an operating frequency band, when subcarrier spacing is increased, recovery from phase noise of a high frequency band is simplified, and thus the frame structure B may support a relatively high operating frequency, compared to the frame structure A. In view of a service, since a shorter length of a slot serving as a basic time unit for scheduling is more advantageous to support an ultra-low latency service such as URLLC, the frame structure B may be more appropriate for the URLLC service as compared to the frame structure A.

Hereinafter, an uplink (UL) may refer to a radio link for transmitting data or a control signal from a UE to a base station, and a downlink (DL) may refer to a radio link for transmitting data or a control signal from the base station to the UE.

In an initial access operation when the UE accesses the system for the first time, the UE may establish DL time/frequency synchronization from a synchronization signal transmitted by the base station through cell search, and may obtain cell identity (ID). In addition, the UE may receive a physical broadcast channel (PBCH) by using the obtained cell ID, and may obtain a master information block (MIB), which is essential system information, from the PBCH. Additionally, the UE may receive a system information block (SIB) transmitted by the base station to obtain cell common transmission/reception related control information. The cell common transmission/reception related control information may include random access related control information, paging related control information, common control information for various physical channels, and the like.

A synchronization signal is a reference signal for the cell search, and a subcarrier spacing appropriate for a channel environment such as phase noise and the like may be applied per frequency band. A different subcarrier spacing may be applied to the data or control channel based on a service type to support various services as described above.

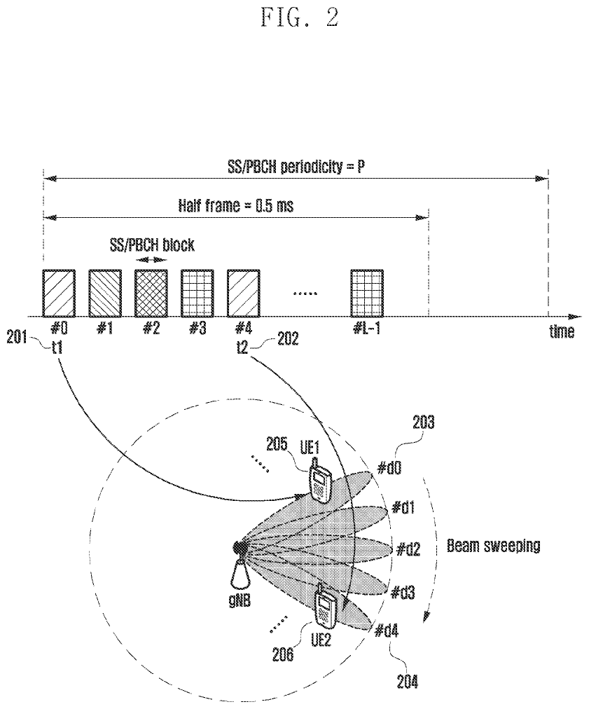

FIG. 2 illustrates a time domain mapping structure of a synchronization signal and a beam sweeping operation according to an embodiment.

For the sake of explanation, the following elements may be defined.

A primary synchronization signal (PSS) serves as a reference for DL time/frequency synchronization and provides some information about cell ID.

A secondary synchronization signal (SSS) serves as a reference for DL time/frequency synchronization, and provides some remaining information about cell ID. Additionally, the SSS may serve as a reference signal for demodulation of the PBCH.

A physical broadcast channel (PBCH) provides a master information block (MIB) which is essential system information required for transmission or reception of a data channel and a control channel of a UE. The essential system information may include search space related control information indicating radio resource mapping information of a control channel, scheduling control information for a separate data channel for transmission of system information, information such as system frame number (SFN), which is a frame unit index serving as a timing reference, and the like.

A synchronization signal/PBCH block (SS/PBCH block) or SSB is constituted of N OFDM symbols and includes a combination of a PSS, an SSS, and a PBCH. In a case of a system to which beam sweeping technology is applied, the SS/PBCH block is the smallest unit to which beam sweeping is applied. In the 5G system, N=4. The base station may transmit up to L SS/PBCH blocks, and the L SS/PBCH blocks are mapped within a half frame (0.5 ms). In addition, the L SS/PBCH blocks are periodically repeated in units of a predetermined periodicity P. The periodicity P may be notified by the base station to the UE through signaling. If there is no separate signaling for the periodicity P, the UE applies a predetermined default value.

FIG. 2 illustrates that beam sweeping is applied in units of SS/PBCH blocks according to the passage of time according to an embodiment. In FIG. 2, UE1 205 receives the SS/PBCH block using a beam emitted in a direction #d0 203 by beamforming applied to a SS/PBCH block #0 at time t1 201. In addition, UE2 206 receives the SS/PBCH block using a beam emitted in a direction #d4 204 by beamforming applied to a SS/PBCH block #4 at time t2 202. The UE may obtain, from the base station, an optimal synchronization signal through a beam, which is emitted in a direction in which the UE is located. For example, it may be difficult for the UE 1 205 to obtain time/frequency synchronization and essential system information from the SS/PBCH block through a beam emitted in a direction #d4 away from the location of the UE 1.

In addition to the initial access procedure, the UE may receive the SS/PBCH block in order to determine whether radio link quality of the current cell is maintained at a predetermined level or more. In addition, in a procedure in which the UE performs handover from a current cell to a neighboring cell, the UE may receive the SS/PBCH block of the neighboring cell in order to determine the radio link quality of the neighboring cell and obtain time/frequency synchronization of the neighboring cell.

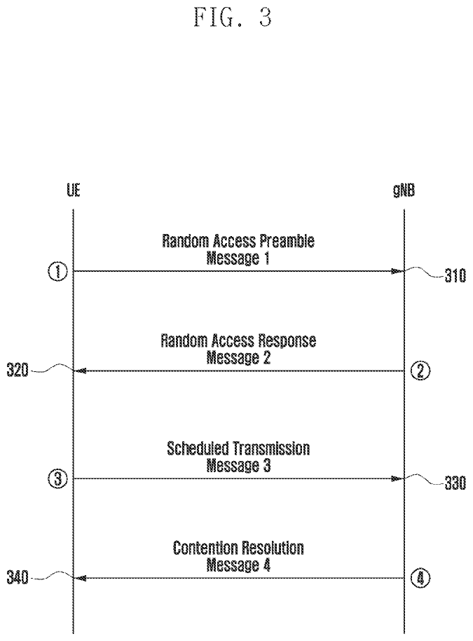

After the UE acquires MIB and system information from the base station through the initial access procedure, the UE may perform a random access procedure to switch the link with the base station to a connected state (or RRC_CONNECTED state). Upon completion of the random access procedure, the UE is switched to a connected state, and one-to-one communication is enabled between the base station and the UE. Hereinafter, a random access procedure will be described in detail In FIG. 3.

FIG. 3 illustrates a random access procedure according to an embodiment.

In step 310, the UE transmits a random access preamble to the base station. In the random access procedure, the random access preamble, which is the first message transmitted by the UE, may be referred to as message 1. The base station may measure a transmission delay value between the UE and the base station from the random access preamble and establish uplink synchronization.

In this case, the UE may randomly select a random access preamble to use in a random access preamble set given by the system information in advance. In addition, the initial transmission power of the random access preamble may be determined according to a pathloss between the base station and the UE, the pathloss measured by the UE. In addition, the UE may transmit the random access preamble by determining the transmission beam direction of the random access preamble based on a synchronization signal received from the base station.

In step 320, the base station transmits a UL transmission timing adjustment instruction to the UE based on the transmission delay value measured from the random access preamble received in the step 310. In addition, the base station may transmit a UL resource and a power control instruction to be used by the UE as scheduling information. Control information for a UL transmission beam of the UE may be included in the scheduling information.

If the UE does not receive a random access response (RAR) (or message 2), which is scheduling information for message 3, from the base station within a predetermined period of time in step 320, step 310 may be performed. If the step 310 is performed again, the UE increases the random access preamble transmission power by a predetermined operation and transmits the same (power ramping), thereby increasing the random access preamble reception probability of the base station.

In step 330, the UE transmits UL data (message 3) including the UE ID of the UE itself to the base station by using the UL resource, which is allocated in step 320, through a UL physical uplink shared channel (PUSCH). The transmission timing of the UL data channel for transmission of message 3 may follow the timing control instruction, which has been received from the base station in step 320. In addition, the transmission power of the UL data channel for transmission of message 3 may be determined by considering the power ramping value of the random access preamble and the power control instruction, which are received from the base station in step 320. The UL data channel for transmission of message 3 may refer to the first UL data signal transmitted by the UE to the base station after transmission of the random access preamble by the UE.

In step 340, when it is determined that the UE has performed random access without collision with another UE, the base station transmits data (message 4) including the ID of the UE, which has transmitted UL data in step 330, to the corresponding UE. When a signal, which has been transmitted by the base station in step 340, is received from the base station, the UE may determine that the random access is successful. In addition, the UE may transmit hybrid automatic repeat request acknowledgement (HARQ-ACK) information indicating whether message 4 has been successfully received, to the base station through a physical uplink control channel (PUCCH).

If the base station fails to receive the data signal from the UE because the data transmitted by the UE in step 330 collides with the data of the other UE, the base station may not perform any more data transmission to the UE. Accordingly, when the UE fails to receive the data, which is transmitted from the base station in step 340, within a predetermined period of time, it may be determined that the random access procedure has failed and process may start again from step 310.

Upon successful completion of the random access procedure, the UE is switched to a connected state, and one-to-one communication between the base station and the UE may be possible. The base station may receive a report of UE capability information from the UE in the connected state, and may adjust scheduling with reference to the UE capability information of the corresponding UE. The UE may inform the base station of whether the UE itself supports a predetermined function, the maximum allowable value of the function supported by the UE, and the like, through the UE capability information. Accordingly, the UE capability information reported by each UE to the base station may be a different value for each UE.

As an example, the UE may report UE capability information including at least a part of the following control information, as the UE capability information, to the base station.
Control information related to a frequency band supported by the UE.
Control information related to a channel bandwidth supported by the UE.
Control information related to a maximum modulation method supported by the UE.
Control information related to the maximum number of beams supported by the UE.
Control information related to the maximum number of layers supported by the UE.
Control information related to CSI reporting supported by the UE.
Control information relating to whether the UE supports frequency hopping.
Bandwidth related control information when carrier aggregation (CA) is supported.
Control information relating to whether cross carrier scheduling is supported when CA is supported.

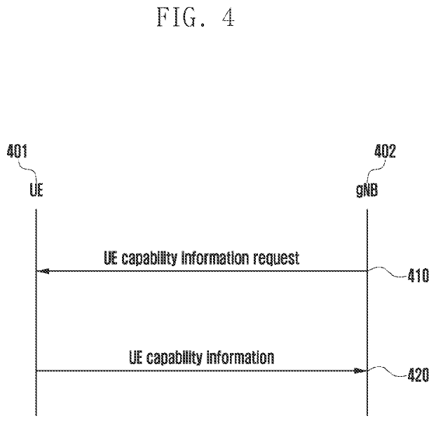

FIG. 4 illustrates a procedure in which a UE reports UE capability information to a base station.

In FIG. 4, in step 410, a base station 402 may transmit a UE capability information request message to a UE 401. In response to a request for UE capability information from the base station, the UE transmits UE capability information to the base station in step 420.

Through the above procedure, the UE connected to the base station is in the RRC_CONNECTED state, and the UE connected to the base station may perform one-to-one communication. Conversely, a UE that is not connected is in the RRC IDLE state, and the operation of the UE in that state is classified as follows.
Operation of a UE-specific discontinuous reception (DRX) cycle configured by a higher layer.
Operation of receiving a paging message from a core network.
Obtaining of system information.
Neighboring cell related measurement operation and cell reselection.

In the 5G system, a new state of the UE called RRC INACTIVE was defined to reduce the energy and time consumed for the UE's initial access. The UE in RRC INACTIVE performs the following operations in addition to the operations performed by the UE in RRC IDLE.
Storage of access stratum (AS) information required for cell access.
UE-specific DRX cycle operation configured by an RRC layer.
Configuration of RAN-based notification area (RNA) that may be used during handover by the RRC layer and periodic update performance.
Monitoring of RAN-based paging messages transmitted through I-RNTI.

Hereinafter, a scheduling method in which a base station transmits DL data to a UE or indicates the UE to transmit UL data will be described.

DCI is control information transmitted by a base station to a UE through the DL and may include DL data scheduling information or UL data scheduling information regarding a predetermined UE. The base station may independently perform channel coding of DCI for each UE, and then may transmit the channel-coded DCI to each UE through the PDCCH.

The base station may operate the DCI for a UE to be scheduled, by applying a certain DCI format determined depending on whether it is scheduling information about DL data (e.g., a DL assignment) or scheduling information about UL data (a UL grant), whether the DCI is for power control, or the like.

The base station may transmit, to the UE, DL data through a PDSCH which is a physical channel for DL data transmission. The base station may inform of the UE scheduling information, such as a specific mapping position in the time and frequency domain of the PDSCH, a modulation scheme, HARQ-related control information, and power control information through DCI related to scheduling information for DL data in the DCI that is transmitted through the PDCCH.

The UE may transmit, to the base station, UL data through a PUSCH which is a physical channel for UL data transmission. The base station may inform of the UE scheduling information, such as a specific mapping position in the time and frequency domain of the PUSCH, a modulation scheme, HARQ-related control information, and power control information through DCI related to scheduling information for UL data in the DCI that is transmitted through the PDCCH.

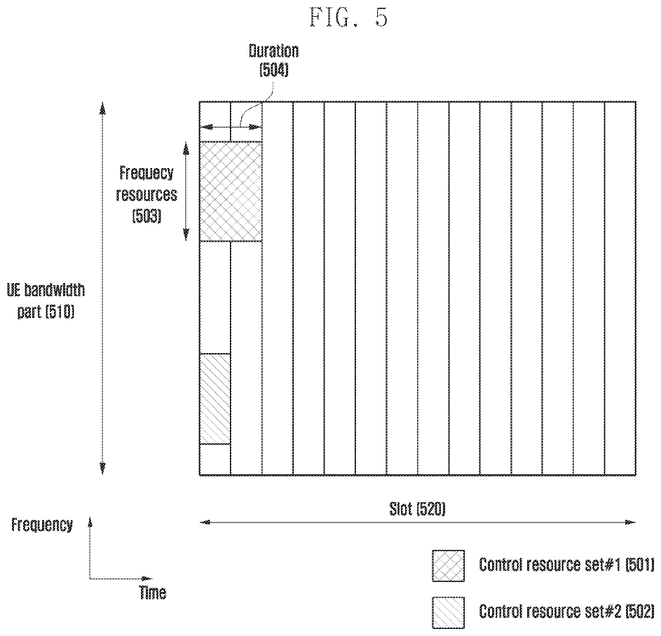

FIG. 5 illustrates a control resource set (CORESET) as a time-frequency resource to which a PDCCH is mapped according to an embodiment.

In FIG. 5, a UE BWP 510 is configured on the frequency axis and two control resource sets (control resource set #1 (501) and control resource set #2 (502)) are configured in one slot (520) on the time axis. The control resource sets 501 and 502 may be configured to a specific frequency resource 503 within the entire UE BWP 510 on the frequency axis. One or more OFDM symbols may be configured on the time axis, and this may be defined as control resource set duration 504.

The control resource set #1 (501) may be configured to a control resource set length of 2 symbols, and control resource set #2 (502) may be configured to a control resource set length of 1 symbol.

The base station may configure one or more CORESETs to the UE through a higher layer signaling (e.g., system information, master information block (MIB), radio resource control (RRC) signaling). Configurating the CORESET to the UE refers to providing information such as a CORESET identity, a frequency position of the CORESET, and a symbol length of the CORESET. The information provided to the UE by the base station to configure the CORESET may include some information about the information included in Table 4 below.

TABLE 4

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF TCI- |

StateId OPTIONAL, -- Cond NotSIB-initialBWP

| | |
|---|---|
| tci-StatesPDCCH-ToReleaseList | SEQUENCE(SIZE (1..maxNrofTCI-StatesPDCCH)) OF TCI- |

StateId OPTIONAL, -- Cond NotSIB-initialBWP

| | |
|---|---|
| tci-PresentInDCI | ENUMERATED {enabled} |

OPTIONAL, -- Need S

| | |
|---|---|
| pdcch-DMRS-ScramblingID | INTEGER (0..65535) |

OPTIONAL, -- Need S
...,
}

A CORESET may include of N_{RB}^{CORESET} RBs in the frequency domain and N_{symb}^{CORESET} ∈{1,2,3} symbols in the time domain. The NR PDCCH may include one or more control channel elements (CCEs). One CCE may include six RE groups (REGs), and an REG may be defined as one RB during one OFDM symbol. In one CORESET, REGs may be indexed in time-first order, starting with REG index 0 from the lowest RB in the first OFDM symbol of the CORESET.

An interleaved scheme and a non-interleaved scheme may be supported to transmit a PDCCH. The base station may configure for the UE whether to transmit the PDCCH in the interleaved or non-interleaved scheme on a CORESET basis by higher-layer signaling. Interleaving may be performed in units of an REG bundle. An REG bundle may be defined as a set of one or more REGs. The UE may determine a CCE-to-REG mapping scheme for a corresponding CORESET based on the interleaved or non-interleaved transmission scheme configured by the base station in the manner described in Table 5 below.

TABLE 5
The CCE-to-REG mapping for a control-resource set can be interleaved or non-interleaved
and is described by REG bundles:

| | |
|---|---|
| - | REG bundle i is defined as REGs {iL,iL + 1,...,iL + L − 1} where L is the REG bundle |
| | size, i = 0,1, ... , N_{REG}^{CORESET}/L − 1, and N_{REG}^{CORESET} = N_{RB}^{CORESET}N_{symb}^{CORESET} is the number |
| | of REGs in the CORESET |
| - | CCE j consists of REG bundles {f(6j/L),f(6j/L + 1),...,f(6j/L + 6/L − 1)} where f(•) is |
| | an interleaver |

For non-interleaved CCE-to-REG mapping, L = 6 and f(x) = x.
For interleaved CCE-to-REG mapping, L ∈ {2,6}for N_{symb}^{CORESET} = 1 and L ∈ {N_{symb}^{CORESET}, 6}
for N_{symb}^{CORESET} ∈ {2,3}. The interleaver is defined by

```
  f(x) = (rC + c + n_{shift}) mod (N_{REG}^{CORESET}/L)
      x = cR + r
      r = 0,1, ... , R − 1
      c = 0,1, ... , C − 1
    C = N_{REG}^{CORESET}/(LR)
```

where R ∈ {2,3,6} .

The base station may indicate configuration information such as a symbol to which the PDCCH is mapped in a slot and a transmission period of the PDCCH to the UE by signaling.

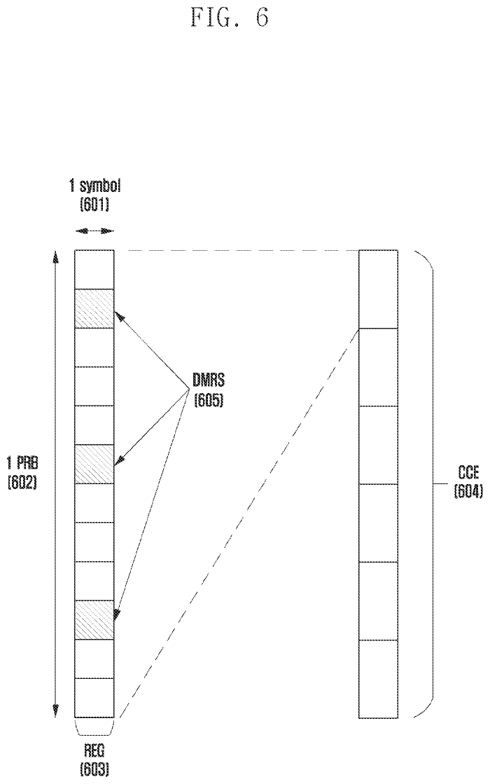

FIG. 6 illustrates an example in which DCI and DMRS are mapped to REG, a basic unit of a DL control channel according to an embodiment.

In FIG. 6, a basic unit of a DL control channel, that is, REG 603, may include both REs to which DCI is mapped and an area to which DMRS 605, a reference signal for decoding the same, is mapped. In addition, three DMRSs 605 may be transmitted within one REG 603.

The number of CCEs required to transmit a PDCCH may be 1, 2, 4, 8, or 16 according to an aggregation level (AL), and different numbers of CCEs may be used for link adaptation of a DL control channel. For example, in case of AL=L, one downlink control channel may be transmitted in L CCEs. Without information about the DL control channel, the UE detects a signal, which is blind decoding. For the blind decoding, a search space being a set of CCEs may be defined. The search space is a set of downlink control channel candidates including CCEs that the UE should attempt to decode at a given AL. There are various ALs at which 1, 2, 4, 8, and 16 CCEs are bundled to form one bundle, and thus the UE may have a plurality of search spaces. A search space set may be defined as a set of search spaces for all configured ALs.

Search spaces may be classified into a common search space (CSS) and a UE-specific search space (US S). A certain group of UEs or all UEs may monitor the CSS of a PDCCH to receive cell-common control information such as dynamic scheduling of an SIB or a paging message. For example, the UE may receive scheduling assignment information about a PDSCH for system information reception by monitoring the CSS of the PDCCH. Since a certain group of UEs or all UEs should receive the PDCCH, the CSS may be defined as a set of preset CCEs. The UE may receive scheduling assignment information about a UE-specific PDSCH or PUSCH by monitoring an USS of the PDCCH. The USS may be UE-specifically defined by a function of a UE ID and various system parameters.

The base station may configure configuration information about a search space of a PDCCH for the UE by higher-layer signaling (e.g., an SIB, an MIB, or RRC signaling). For example, the base station may configure the UE with the number of PDCCH candidate groups for each AL L, the monitoring periodicity of a search space, a monitoring occasion in each symbol of a slot for the search space, a search space type (CSS or USS), a combination of a DCI format and an RNTI to be monitored in the search space, and a CORESET index to be monitored in the search space. For example, parameters for a PDCCH search space may include information described in Table 6 below.

TABLE 6

| SearchSpace ::= | SEQUENCE { | |
|---|---|---|
| searchSpaceId | SearchSpaceId, | |
| controlResourceSetId | ControlResourceSetId | OPTIONAL, -- Cond |

SetupOnly

| monitoringSlotPeriodicityAndOffset | CHOICE { | |
|---|---|---|
| sl1 | NULL, | |
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559) | |
| } | | OPTIONAL, -- Cond Setup4 |
| duration | INTEGER (2..2559) | OPTIONAL, -- Need S |

| | |
|---|---|
| monitoringSymbolsWithinSlot | BIT STRING (SIZE (14)) OPTIONAL, - |

- Cond Setup

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond Setup |

| | |
|---|---|
| searchSpaceType | CHOICE { |
| common | SEQUENCE { |
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, --. Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

```
OPTIONAL -- Need R
        },
        ...
      }
OPTIONAL, -- Need R
```

| | |
|---|---|
| dci-Format2-1 | SEQUENCE { |

```
        ...
      }
OPTIONAL, -- Need R
```

| | |
|---|---|
| dci-Format2-2 | SEQUENCE { |

```
        ...
      }
OPTIONAL, -- Need R
```

| | |
|---|---|
| dci-Format2-3 | SEQUENCE { |
| dummy1 | ENUMERATED {sl1, sl2, s1l4, sl5, sl8, |

sl10, sl16, sl20} OPTIONAL, -- Cond Setup

| | |
|---|---|
| dummy2 | ENUMERATED {n1, n2}, |

```
      ...
      }
OPTIONAL -- Need R
    },
```

| | |
|---|---|
| ue-Specific | SEQUENCE { |
| dci-Formats | ENUMERATED {formats0-0-And-1-0, |

```
formats0-1-And-1-1},
      ...,
      [[
```

| | |
|---|---|
| dci-Formats-MT-r16 | ENUMERATED {formats2-5} |

OPTIONAL, -- Need R

| | |
|---|---|
| dci-FormatsSL-r16 | ENUMERATED {formats0-0-And-1-0, formats0-1- |

And-1-1, formats3-0, formats3-1,

formats3-0-And-3-1}

OPTIONAL, -- Need R

| | |
|---|---|
| dci-FormatsExt-r16 | ENUMERATED {formats0-2-And-1-2, formats0-1- |

```
And-1-1And-0-2-And-1-2}
OPTIONAL -- Need R
      ]]
    }
  }
OPTIONAL -- Cond Setup2
}
```

According to the configuration information, the base station may configure one or more search space sets for the UE. The base station may configure search space set 1 and search space set 2 for the UE. In search space set 1, the UE may be configured to monitor DCI format A scrambled with an X-RNTI in a CSS, and in search space set 2, the UE may be configured to monitor DCI format B scrambled with a Y-RNTI in an USS.

According to the configuration information, one or more search space sets may exist in the CSS or the USS. For example, search space set #1 and search space set #2 may be configured as the CSS, and search space set #3 and search space set #4 may be configured as the USS.

In the CSS, the UE may monitor the following DCI format and RNTI combinations, but that the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI
DCI format 2_4 with CRC scrambled by CI-RNTI
DCI format 2_5 with CRC scrambled by AI-RNTI
DCI format 2_6 with CRC scrambled by PS-RNTI
DCI format 2_7 with CRC scrambled by PEI-RNTI

In the USS, the UE may monitor the following DCI format and RNTI combinations. The disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above RNTIs may be defined and used as follows.
Cell RNTI (C-RNTI): UE-specific PDSCH or PUSCH scheduling
Temporary cell RNTI (TC-RNTI): UE-specific PDSCH scheduling
Configured scheduling RNTI (CS-RNTI): Semi-statically configured UE-specific PDSCH scheduling
Random access RNTI (RA-RNTI): PDSCH scheduling in the random access stage
Paging RNTI (P-RNTI): PDSCH scheduling for paging transmission
System information RNTI (SI-RNTI): PDSCH scheduling for system information transmission
Interruption RNTI (INT-RNTI): To indicate whether PDSCH is punctured
Transmit power control for PUSCH RNTI (TPC-PUSCH-RNTI): To indicate power control instruction for PUSCH
TPC for PUCCH RNTI (TPC-PUCCH-RNTI): To indicate power control instruction for PUCCH
TPC for SRS RNTI (TPC-SRS-RNTI): To indicate power control instruction for SRS

The above-described DCI formats may follow the definitions shown in Table 7 below.

TABLE 7

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |
| 2_4 | Notifying the PRB(s) and OFDM symbol(s) where UE cancels |
| | the corresponding UL transmission from the UE |
| 2_5 | Notifying the availability of soft resources |
| 2_6 | Notifying the power saving information outside DRX Active |
| | Time for one or more UEs |
| 2_7 | Notifying paging early indication and TRS availability indication |
| | for one or more UEs. |
| 3_0 | Scheduling of NR sidelink in one cell |
| 3_1 | Scheduling of LTE sidelink in one cell |
| 4_0 | Scheduling of PDSCH with CRC scrambled by MCCH-RNTI/G- |
| | RNTI for broadcast |
| 4_1 | Scheduling of PDSCH with CRC scrambled by G-RNTI/GCS- |
| | RNTI for multicast |
| 4_2 | Scheduling of PDSCH with CRC scrambled by G-RNTI/GCS- |
| | RNTI for multicast |

A search space for an AL L in a CORESET p and a search space set s may be expressed in Equation (1) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad ( 1 )$$

In Equation (1):
L: aggregation level
nci: Carrier index
NCCE,p: The number of total CCEs present in the control resource set p
n_{s,f}^{u}: slot index
M^{(L)} p·s, max: The number of PDCCH candidates of aggregation level L
m_{s,n}CI=M^{(L)} p·s, max −1: index of PDCCH candidates of aggregation level L
i=0, . . . , L−1
Y_{p,n}_{_{s,f}}_{^{μ}}=(Aₚ·Y_{p,n}_{_{s,f}}_{^{μ}}₋₁)modD, Y_{p,-1}=n_{RNTI}≠0, A₀=39827, A₁=39829, A₂=39839, and D=65537
nRNTI: UE identifier

The value of Y_{p,n}_{_{s,f}}_{^{μ}} may correspond to 0 in the CSS.

The value of Y_{p,n}_{_{s,f}}_{^{μ}} may correspond to a value changed according to a UE ID (a C-RNTI or an ID configured for the UE by the base station) and a time index in the USS.

A base station can configure and indicate a TCI state relating to a PDCCH (or PDCCH DMRS) through proper signaling. According to the above description, a base station can configure and indicate a TCI state relating to a PDCCH (or PDCCH DMRS) through proper signaling. The TCI state indicates a quasi-co-location (QCL) relationship between a PDCCH (or PDCCH DMRS) and another RS or a channel. The fact that a reference antenna port A (reference RS #A) and a target antenna port B (target RS #B) are QCLed to each other implies that a UE is allowed to apply all or a part of large-scale channel parameters estimated in the antenna port A to perform a channel measurement in the antenna port B. QCL may require different parameters to be involved according to situations including time tracking affected by average delay and delay spread, frequency tracking affected by Doppler shift and Doppler spread, radio resource management (RRM) affected by average gain, and beam management (BM) affected by spatial parameter. Accordingly, NR supports four types of QCL relationships shown in Table 8 below.

TABLE 8

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may be a generic term that indicates a part or all of various parameters including Angle of arrival (AoA), power angular spectrum (PAS) of AoA, angle of departure (AoD), PAS of AoD, transmit/receive channel correlation, transmit/receive beamforming, and spatial channel correlation.

The QCL relationship can be configured for the UE through an RRC parameter TCI-State and QCL-Info as shown in Table 9 below. In Table 9 below, the base station may configure at least one TCI state for the UE to notify the UE of a maximum of two QCL relationships (qcl-Type1 and qcl-Type2) relating to an RS with reference to ID of the TCI state, that is, a target RS. Each of pieces of QCL information (QCL-Info) included in the TCI state includes a serving cell index and a BWP index of a reference RS indicated by a corresponding piece of QCL information, the type and ID of the reference RS, and a QCL type as shown above in Table 8.

TABLE 9

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |
| ... | | |
| } | | |
| QCL-Info ::= | SEQUENCE { | |
| cell | ServCellIndex | OPTIONAL, -- Need R |
| bwp-Id | BWP-Id | OPTIONAL, -- Cond CSI-RS-Indicated |

| referenceSignal | CHOICE { |
|---|---|
| csi-rs | NZP-CSI-RS-ResourceId, |
| ssb | SSB-Index |
| }, | |
| qcl-Type | ENUMERATED {typeA, typeB, typeC, typeD}, |

...
}

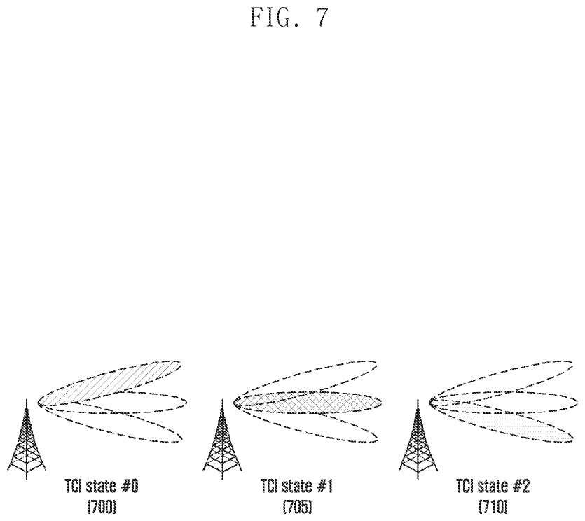

FIG. 7 illustrates base station beam allocation according to a TCI state configuration according to an embodiment.

In FIG. 7, a base station may transfer information relating to N number of different beams through N number of different TCI states to a UE. For example, in the case of N=3, the base station may allow a qcl-Type 2 parameter included in three TCI states 700, 705, and 710 to be associated with a CSI-RS or SSB corresponding to different beams and to be configured to be of QCL type D, so as to indicate that antenna ports with reference to the different TCI states 700, 705, and 710 are associated with different spatial Rx parameters, that is, different beams.

Specifically, a combination of TCI states applicable to a PDCCH DMRS antenna port is as shown in Table 10 below. In Table 10, a combination in the fourth row is assumed by the UE before RRC configuration, and cannot be configured after RRC connection.

TABLE 10

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | | |
| | (CSI) | | | |
| 4 | SS/PBCH | QCL-TypeA | SS/PBCH | QCL-TypeD |
| | Block | | Block | |

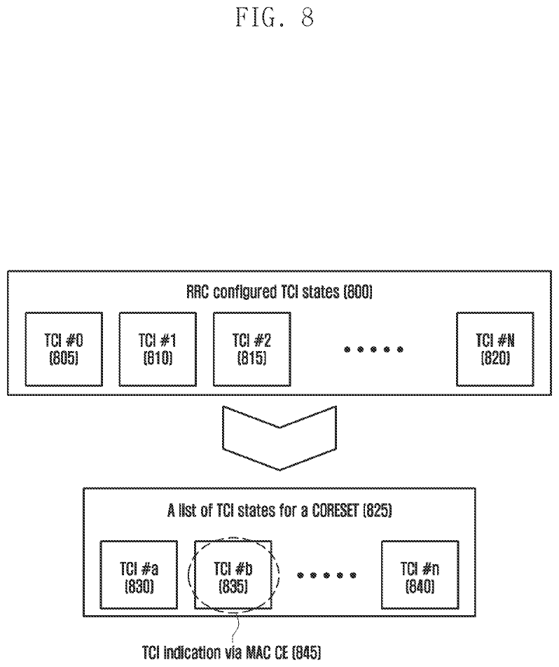

NR supports a hierarchical signaling method as illustrated in FIG. 8 for dynamic allocation of PDCCH beams.

FIG. 8 illustrates a hierarchical signaling method for dynamic allocation of PDCCH beams by NR according to an embodiment.

In FIG. 8, a base station may configure N number of TCI states 805, 810, . . . , and 820 for a UE through RRC signaling (800), and may configure some of the TCI states as TCI states for a CORESET (825). After the configuration, the base station may indicate one of TCI states 830, 835, and 840 for the CORESET to the UE through MAC CE signaling (845). After the indication, the UE receives a PDCCH, based on beam information included in a TCI state indicated by the MAC CE signaling.

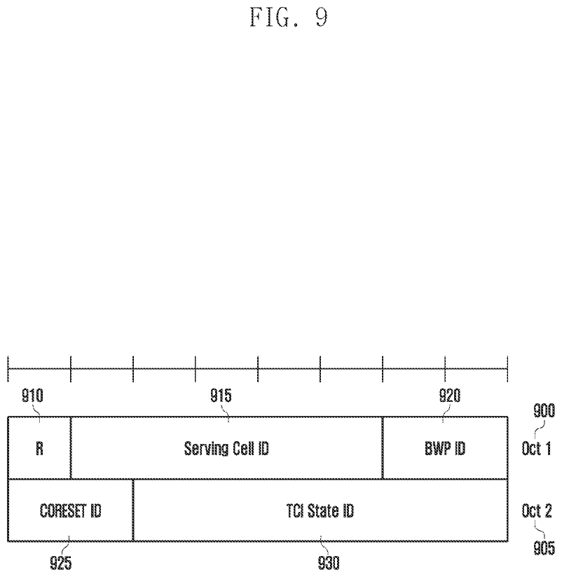

FIG. 9 illustrates the TCI indication MAC CE signaling structure for a PDCCH DMRS according to an embodiment.

In FIG. 9, the TCI indication MAC CE signaling for a PDCCH DMRS is constituted by 2 bytes (16 bits) and includes a reserved bit 910 formed of one bit, a serving cell ID 915 formed of five bits, a BWP ID 920 formed of two bits, a CORESET ID 925 formed of two bits, and a TCI state ID 930 formed of six bits.

A base station may indicate one TCI state in a TCI state list included in a configuration of a CORESET through MAC CE signaling. During a time interval from the TCI state indication to an indication of another TCI state in the corresponding CORESET through another MAC CE signaling, a UE may assume that the same QCL information is applied to one or more search spaces connected to the CORESET.

In this PDCCH beam allocation method, it is difficult to indicate a beam switching earlier than an MAC CE signaling delay, and there is a shortage in that the same beam is collectively applied for each CORESET regardless of the characteristics of search spaces, so that flexible PDCCH beam management is difficult. The following, therefore, provides a more flexible PDCCH beam configuration and management method. Herein, some distinguishable examples are provided, but the examples are not mutually exclusive, and can be properly combined with each other according to a situation for application.

A base station may configure, for a UE, one or more TCI states with respect to a particular control resource set, and may activate one of the configured TCI states through an MAC CE activation instruction. For example, {TCI state #0, TCI state #1, TCI state #2} is configured for control resource set #1 as TCI states, and the base station may transmit an instruction of activating that a TCI state relating to control resource set #1 is assumed to be TCI state #0, through an MAC CE to the UE. Based on the activation instruction relating to a TCI state, received through the MAC CE, the UE may correctly receive a DMRS in the control resource set, based on QCL information in the activated TCI state.

With respect to a control resource set (control resource set #0) configured to have an index of 0, if the UE has failed to receive an MAC CE activation instruction relating to a TCI state of control resource set #0, the UE may assume that a DMRS transmitted in control resource set #0 is QCLed with an SS/PBCH block identified in an initial access process or a non-contention-based random access process that is not triggered by a PDCCH instruction.

With respect to a control resource set (control resource set #X) configured to have an index of a value other than zero, if a TCI state relating to control resource set #X is not configured for the UE, or if one or more TCI states are configured for the UE, but the UE has failed to receive an MAC CE activation instruction of activating one of the TCI states, the UE may assume that a DMRS transmitted in control resource set #X is QCLed with an SS/PBCH block identified in an initial access process.

In a 5G system, scheduling information on a physical uplink shared channel, PUSCH) or a physical downlink shared channel, PDSCH) is transferred through DCI from a base station to a UE. The UE may monitor a fallback DCI format and a non-fallback DCI format for a PUSCH or a PDSCH. The fallback DCI format may be configured by a fixed field pre-defined between a base station and a UE, and the non-fallback DCI format may include a configurable field.

DCI may undergo a channel coding and modulation process, and then be transmitted through a PDCCH. A cyclic redundancy check (CRC) may be attached to a DCI message payload, and the CRC may be scrambled by an RNTI corresponding to the identity of the UE. Different types of RNTIs may be used according to the purpose of a DCI message, for example, UE-specific data transmission, a power control instruction, an RAR message, or the like. That is, a RNTI is not explicitly transmitted, and is transmitted after being included in a CRC calculation process. If the UE has received a DCI message transmitted on a PDCCH, the UE may identify a CRC by using an assigned RNTI, and if a CRC identification result is correct, the UE may identify that the message has been transmitted to the UE.

For example, DCI scheduling a PDSCH, for system information (SI) may be scrambled by a SI-RNTI. DCI scheduling a PDSCH for an RAR message may be scrambled by a RA-RNTI. DCI scheduling a PDSCH for a paging message may be scrambled by a P-RNTI. DCI notifying of a slot format indicator (SFI) may be scrambled by a SFI-RNTI. DCI notifying of a transmit power control (TPC) may be scrambled by a TPC-RNTI. DCI scheduling a UE-specific PDSCH or PUSCH may be scrambled by a cell RNTI (C-RNTI).

DCI format 0_0 may be used for fallback DCI scheduling a PUSCH, and in this case, a CRC may be scrambled by a C-RNTI. DCI format 0_0 having a CRC scrambled by a C-RNTI may include, for example, the following information as shown in Table 11 below.

TABLE 11

| - | Identifier for DCI formats - 1 bit | |
|---|---|---|
| | - | The value of this bit field is always set to 0, indicating an UL DCI format |
| - | Frequency domain resource assignment - ┌log₂(N_{RB}^{UL,BWP}(N_{RB}^{UL,BWP} +1)/2)┐ bits where N_{RB}^{UL,BWP} is | |
| | defined in subclause 7.3.1.0 | |
| | - | For PUSCH hopping with resource allocation type 1: |

| | |
|---|---|
| - | N_{UL}_{_{—}}ₕₒₚ MSB bits are used to indicate the frequency offset according to Subclause 6.3 of [6, TS |
| | 38.214], where N_{UL}_{_{—}}ₕₒₚ = 1 if the higher layer parameter frequencyHoppingOffsetLists contains |
| | two offset values and N_{UL}_{_{—}}ₕₒₚ = 2 if the higher layer parameter frequencyHoppingOffsetLists |
| | contains four offset values |
| - | ┌log₂(N_{RB}^{UL,BWP}(N_{RB}^{UL,BWP} +1)/2)┐ − N_{UL}_{_{—}}ₕₒₚ bits provides the frequency domain resource allocation |
| | according to Subclause 6.1.2.2.2 of [6, TS 38.214] |

| | |
|---|---|
| - | For non-PUSCH hopping with resource allocation type 1: |

| | |
|---|---|
| - | ┌log₂(N_{RB}^{UL,BWP}(N_{RB}^{UL,BWP} +1)/2)┐ bits provides the frequency domain resource allocation according |
| | to Subclause 6.1.2.2.2 of [6, TS 38.214] |

| - | Time domain resource assignment - 4 bits as defined in Subclause 6.1.2.1 of [6, TS 38.214] | |
|---|---|---|
| - | Frequency hopping flag - 1 bit according to Table 7.3.1.1.1-3, as defined in Subclause 6.3 of [6, TS | |
| | 38.214] | |
| - | Modulation and coding scheme - 5 bits as defined in Subclause 6.1.4.1 of [6, TS 38.214] | |
| - | New data indicator - 1 bit | |
| - | Redundancy version - 2 bits as defined in Table 7.3.1.1.1-2 | |
| - | HARQ process number - 4 bits | |
| - | TPC command for scheduled PUSCH - 2 bits as defined in Subclause 7.1.1 of [5, TS 38.213] | |
| - | Padding bits, if required. | |
| - | UL/SUL indicator - 1 bit for UEs configured with supplementaryUplink in ServingCellConfig in the cell | |
| | as defined in Table 7.3.1.1.1-1 and the number of bits for DCI format 1_0 before padding is larger than the | |
| | number of bits for DCI format 0_0 before padding; 0 bit otherwise. The UL/SUL indicator, if present, | |
| | locates in the last bit position of DCI format 0_0, after the padding bit(s). | |
| | - | If the UL/SUL indicator is present in DCI format 0_0 and the higher layer parameter pusch-Config is |
| | | not configured on both UL and SUL the UE ignores the UL/SUL indicator field in DCI format 0_0, |
| | | and the corresponding PUSCH scheduled by the DCI format 0_0 is for the UL or SUL for which high |
| | | layer parameter pucch-Config is configured; |
| | - | If the UL/SUL indicator is not present in DCI format 0_0 and pucch-Config is configured, the |
| | | corresponding PUSCH scheduled by the DCI format 0_0 is for the UL or SUL for which high layer |
| | | parameter pucch-Config is configured. |
| | - | If the UL/SUL indicator is not present in DCI format 0_0 and pucch-Config is not configured, the |
| | | corresponding PUSCH scheduled by the DCI format 0_0 is for the uplink on which the latest PRACH |
| | | is transmitted. |

DCI format 0_1 may be used for non-fallback DCI scheduling a PUSCH, and in this case, a CRC may be scrambled by a C-RNTI. DCI format 0_1 having a CRC scrambled by a C-RNTI may include, for example, the following information as shown in Table 12 below.

```
TABLE 12
Identifier for DCI formats - 1 bit
  The value of this bit field is always set to 0, indicating an UL DCI format
Carrier indicator - 0 or 3 bits, as defined in Subclause 10.1 of [5, TS38.213].
UL/SUL indicator - 0 bit for UEs not configured with supplementaryUplink in ServingCellConfig in the
cell or UEs configured with supplementaryUplink in ServingCellConfig in the cell but only PUCCH
carrier in the cell is configured for PUSCH transmission; otherwise, 1 bit as defined in Table 7.3.1.1.1-1.
Bandwidth part indicator - 0, 1 or 2 bits as determined by the number of UL BWPs n_{BWP,RRC} configured
by higher layers, excluding the initial UL bandwidth part. The bitwidth for this field is determined as
┌log₂ (n_{Bwp})┐bits, where
  n_{BWP} = n_{BWP,RRC} + 1 if n_{BWP,RRC} ≤ 3, in which case the bandwidth part indicator is equivalent to the
  ascending order of the higher layer parameter BWP-Id;
  otherwise n_{Bwp} = n_{BWP,RRC}, in which case the bandwidth part indicator is defined in Table 7.3.1.1.2-1;
If a UE does not support active BWP change via DCI, the UE ignores this bit field.
Frequency domain resource assignment - number of bits determined by the following, where N_{RB}^{UL,BWP} is
the size of the active UL bandwidth part:
  N_{RBG} bits if only resource allocation type 0 is configured, where N_{RBG} is defined in Subclause
  6.1.2.2.1 of [6, TS 38.214],
  ┌1og₂ (N_{RB}^{UL,BWP} (N_{RB}^{UL,BWP} + 1)/2)┐ bits if only resource allocation type 1 is configured, or
  max (┌1og₂ (N_{RB}^{UL,BWP} (N_{RB}^{UL,BWP} + 1)/2)┐, N_{RBG} ) + 1 bits if both resource allocation type 0 and 1 are
  configured.
  If both resource allocation type 0 and 1 are configured, the MSB bit is used to indicate resource
  allocation type 0 or resource allocation type 1, where the bit value of 0 indicates resource allocation
  type 0 and the bit value of 1 indicates resource allocation type 1.
  For resource allocation type 0, the N_{RGB} LSBs provide the resource allocation as defined in
  Subclause 6.1.2.2.1 of [6, TS 38.214].
  For resource allocation type 1, the ┌log₂ (N_{RB}^{UL,BWP} (N_{RB}^{UL,BWP} + 1)/2)┐ LSBs provide the resource
  allocation as follows:
    For PUSCH hopping with resource allocation type 1:
      N_{UL}_hop MSB bits are used to indicate the frequency offset according to Subclause 6.3 of
      [6, TS 38.214], where N_{UL}_hop = 1 if the higher layer parameter frequencyHoppingOffsetLists
      contains two offset values and N_{UL}_hop = 2 if the higher layer parameter
      frequencyHoppingOffsetLists contains four offset values
      ┌log₂ (N_{RB}^{UL,BWP} (N_{RB}^{UL,BWP} + 1)/2)┐ − N_{UL}_hop bits provides the frequency domain resource
      allocation according to Subclause 6.1.2.2.2 of [6, TS 38.214]
    For non-PUSCH hopping with resource allocation type 1:
      ┌log₂ (N_{RB}^{UL,BWP} (N_{RB}^{UL,BWP} + 1)/2)┐ bits provides the frequency domain resource allocation
      according to Subclause 6.1.2.2.2 of [6, TS 38.214]
  If “Bandwidth part indicator” field indicates a bandwidth part other than the active bandwidth part and
  if both resource allocation type 0 and 1 are configured for the indicated bandwidth part, the UE
  assumes resource allocation type 0 for the indicated bandwidth part if the bitwidth of the “Frequency
  domain resource assignment” field of the active bandwidth part is smaller than the bitwidth of the
  “Frequency domain resource assignment” field of the indicated bandwidth part.
Time domain resource assignment - 0, 1, 2, 3, or 4 bits as defined in Subclause 6.1.2.1 of [6, TS38.214].
The bitwidth for this field is determined as ┌log₂ (I)┐ bits, where I is the number of entries in the higher
layer parameter pusch-TimeDomainAllocationList if the higher layer parameter is configured; otherwise I
is the number of entries in the default table.
Frequency hopping flag - 0 or 1 bit:
  0 bit if only resource allocation type 0 is configured or if the higher layer parameter frequencyHopping
  is not configured;
  1 bit according to Table 7.3.1.1.1-3 otherwise, only applicable to resource allocation type 1, as defined
  in Subclause 6.3 of [6, TS 38.214].
Modulation and coding scheme - 5 bits as defined in Subclause 6.1.4.1 of [6, TS 38.214]
New data indicator - 1 bit
Redundancy version - 2 bits as defined in Table 7.3.1.1.1-2
HARQ process number - 4 bits
1^{st} downlink assignment index - 1 or 2 bits:
  1 bit for semi-static HARQ-ACK codebook;
  2 bits for dynamic HARQ-ACK codebook.
2^{nd} downlink assignment index - 0 or 2 bits:
  2 bits for dynamic HARQ-ACK codebook with two HARQ-ACK sub-codebooks;
  0 bit otherwise.
TPC command for scheduled PUSCH - 2 bits as defined in Subclause 7.1.1 of [5, TS38.213]
$SRS resource indicator - ⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ or ⌈ {log}_{2} ( {N}_{SRS} ) ⌉ bits , where {N}_{SRS} is the$
number of configured SRS resources in the SRS resource set associated with the higher layer parameter
usage of value ‘codeBook’ or ‘nonCodeBook’,
  $⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits according to Tables 7.3 \text{.1} \text{.1} \text{.2} - 28 / 29 / 30 / 31 if the higher layer$
  parameter txConfig = nonCodebook, where N_{SRS} is the number of configured SRS resources in the
  SRS resource set associated with the higher layer parameter usage of value ‘nonCodeBook’ and
    if UE supports operation with maxMIMO-Layers and the higher layer parameter maxMIMO-Layers
    of PUSCH-ServingCellConfig of the serving cell is configured, Lₘₐₓ is given by that parameter
    otherwise, Lₘₐₓ is given by the maximum number of layers for PUSCH supported by the UE for the
    serving cell for non-codebook based operation.
  ┌log₂ (N_{SRS})┐ bits according to Tables 7.3.1.1.2-32 if the higher layer parameter txConfig = codebook,
  where N_{SRS} is the number of configured SRS resources in the SRS resource set associated
  with the higher layer parameter usage of value 'codeBook'.
Precoding information and number of layers - number of bits determined by the following:
  0 bits if the higher layer parameter txConfig = nonCodeBook;
  0 bits for 1 antenna port and if the higher layer parameter txConfig = codebook;
  4, 5, or 6 bits according to Table 7.3.1.1.2-2 for 4 antenna ports, if txConfig = codebook, and according
  to whether transform precoder is enabled or disabled, and the values of higher layer parameters
  maxRank, and codebookSubset;
  2, 4, or 5 bits according to Table 7.3.1.1.2-3 for 4 antenna ports, if txConfig = codebook, and according
  to whether transform precoder is enabled or disabled, and the values of higher layer parameters
  maxRank, and codebookSubset;
  2 or 4 bits according to Table7.3.1.1.2-4 for 2 antenna ports, if txConfig = codebook, and according to
  whether transform precoder is enabled or disabled, and the values of higher layer parameters maxRank
  and codebookSubset;
  1 or 3 bits according to Table7.3.1.1.2-5 for 2 antenna ports, if txConfig = codebook, and according to
  whether transform precoder is enabled or disabled, and the values of higher layer parameters maxRank
  and codebookSubset.
Antenna ports - number of bits determined by the following
  2 bits as defined by Tables 7.3.1.1.2-6, if transform precoder is enabled, dmrs-Type = 1, and maxLength = 1;
  4 bits as defined by Tables 7.3.1.1.2-7, if transform precoder is enabled, dmrs-Type = 1, and maxLength = 2;
  3 bits as defined by Tables 7.3.1.1.2-8/9/10/11, if transform precoder is disabled, dmrs-Type = 1, and
  maxLength = 1, and the value of rank is determined according to the SRS resource indicator field if the
  higher layer parameter txConfig = nonCodebook and according to the Precoding information and
  number of layers field if the higher layer parameter txConfig = codebook;
  4 bits as defined by Tables 7.3.1.1.2-12/13/14/15, if transform precoder is disabled, dmrs-Type = 1, and
  maxLength = 2, and the value of rank is determined according to the SRS resource indicator field if the
  higher layer parameter txConfig = nonCodebook and according to the Precoding information and
  number of layers field if the higher layer parameter txConfig = codebook;
  4 bits as defined by Tables 7.3.1.1.2-16/17/18/19, if transform precoder is disabled, dmrs-Type = 2, and
  maxLength = 1, and the value of rank is determined according to the SRS resource indicator field if the
  higher layer parameter txConfig = nonCodebook and according to the Precoding information and
  number of layers field if the higher layer parameter txConfig = codebook;
  5 bits as defined by Tables 7.3.1.1.2-20/21/22/23, if transform precoder is disabled, dmrs-Type = 2, and
  maxLength = 2, and the value of rank is determined according to the SRS resource indicator field if the
  higher layer parameter txConfig = nonCodebook and according to the Precoding information and
  number of layers field if the higher layer parameter txConfig = codebook.
where the number of CDM groups without data of values 1, 2, and 3 in Tables 7.3.1.1.2-6 to 7.3.1.1.2-23
refers to CDM groups {0}, {0, 1}, and {0, 1, 2} respectively.
If a UE is configured with both dmrs-UplinkForPUSCH-MappingTypeA and dmrs-UplinkForPUSCH-
MappingTypeB, the bitwidth of this field equals max {x_{A}, x_{B}} , where x_{A} is the “Antenna ports”
bitwidth derived according to dmrs-UplinkForPUSCH-MappingTypeA and x_{B} is the “Antenna ports”
bitwidth derived according to dmrs-UplinkForPUSCH-MappingTypeB. A number of |x_{A} − x_{B}| zeros are
padded in the MSB of this field, if the mapping type of the PUSCH corresponds to the smaller value of
x_{A} and x_{B}.
SRS request - 2 bits as defined by Table 7.3.1.1.2-24 for UEs not configured with supplementaryUplink in
ServingCellConfig in the cell; 3 bits for UEs configured with supplementaryUplink in ServingCellConfig
in the cell where the first bit is the non-SUL/SUL indicator as defined in Table 7.3.1.1.1-1 and the second
and third bits are defined by Table 7.3.1.1.2-24. This bit field may also indicate the associated CSI-RS
according to Subclause 6.1.1.2 of [6, TS 38.214].
CSI request - 0, 1, 2, 3, 4, 5, or 6 bits determined by higher layer parameter reportTriggerSize.
CBG transmission information (CBGTI) - 0 bit if higher layer parameter codeBlockGroupTransmission
for PDSCH is not configured, otherwise, 2, 4, 6, or 8 bits determined by higher layer parameter
maxCodeBlockGroupsPerTransportBlock for PUSCH.
PTRS-DMRS association - number of bits determined as follows
  0 bit if PTRS-UplinkConfig is not configured and transform precoder is disabled, or if transform
  precoder is enabled, or if maxRank = 1;
  2 bits otherwise, where Table 7.3.1.1.2-25 and 7.3.1.1.2-26 are used to indicate the association between
  PTRS port(s) and DMRS port(s) for transmission of one PT-RS port and two PT-RS ports respectively,
  and the DMRS ports are indicated by the Antenna ports field.
If “Bandwidth part indicator” field indicates a bandwidth part other than the active bandwidth part and the
“PTRS-DMRS association” field is present for the indicated bandwidth part but not present for the active
bandwidth part, the UE assumes the “PTRS-DMRS association” field is not present for the indicated
bandwidth part.
beta_offset indicator - 0 if the higher layer parameter betaOffsets = semiStatic; otherwise 2 bits as defined
by Table 9.3-3 in [5, TS 38.213].
DMRS sequence initialization - 0 bit if transform precoder is enabled; 1 bit if transform precoder is disabled.
UL-SCH indicator - 1 bit. A value of “1” indicates UL-SCH shall be transmitted on the PUSCH and a
value of “0” indicates UL-SCH shall not be transmitted on the PUSCH. Except for DCI format 0_1 with
CRC scrambled by SP-CSI-RNTI, a UE is not expected to receive a DCI format 0_1 with UL-SCH
indicator of “0” and CSI request of all zero(s).
```

DCI format 1_0 may be used for fallback DCI scheduling a PDSCH, and in this case, a CRC may be scrambled by a C-RNTI. DCI format 1_0 having a CRC scrambled by a C-RNTI may include, for example, the following information as shown in Table 13 below.

TABLE 13

| | |
|---|---|
| - | Identifier for DCI formats - 1 bits |
| | - The value of this bit field is always set to 1, indicating a DL DCI format |
| - | Frequency domain resource assignment - ┌log₂(N_{RB}^{DL,BWP}(N_{RB}^{DL,BWP} +1)/2)┐ bits where N_{RB}^{DL,BWP} is given |
| | by subclause 7.3.1.0 |

If the CRC of the DCI format 1_0 is scrambled by C-RNTI and the “Frequency domain resource assignment”
field are of all ones, the DCI format 1_0 is for random access procedure initiated by a PDCCH order, with all
remaining fields set as follows:

| | |
|---|---|
| - | Random Access Preamble index - 6 bits according to ra-PreambleIndex in Subclause 5.1.2 of [8, |
| | TS38.321] |
| - | UL/SUL indicator - 1 bit. If the value of the “Random Access Preamble index” is not all zeros and if the |
| | UE is configured with supplementaryUplink in ServingCellConfig in the cell, this field indicates which UL |
| | carrier in the cell to transmit the PRACH according to Table 7.3.1.1.1-1; otherwise, this field is reserved |
| - | SS/PBCH index - 6 bits. If the value of the “Random Access Preamble index” is not all zeros, this field |
| | indicates the SS/PBCH that shall be used to determine the RACH occasion for the PRACH transmission; |
| | otherwise, this field is reserved. |
| - | PRACH Mask index - 4 bits. If the value of the “Random Access Preamble index” is not all zeros, this |
| | field indicates the RACH occasion associated with the SS/PBCH indicated by “SS/PBCH index” for the |
| | PRACH transmission, according to Subclause 5.1.1 of [8, TS38.321]; otherwise, this field is reserved |
| - | Reserved bits - 10 bits |

Otherwise, all remaining fields are set as follows:

| | |
|---|---|
| - | Time domain resource assignment - 4 bits as defined in Subclause 5.1.2.1 of [6, TS 38.214] |
| - | VRB-to-PRB mapping - 1 bit according to Table 7.3.1.2.2-5 |
| - | Modulation and coding scheme - 5 bits as defined in Subclause 5.1.3 of [6, TS 38.214] |
| - | New data indicator - 1 bit |
| - | Redundancy version - 2 bits as defined in Table 7.3.1.1.1-2 |
| - | HARQ process number - 4 bits |
| - | Downlink assignment index - 2 bits as defined in Subclause 9.1.3 of [5, TS 38.213], as counter DAI |
| - | TPC command for scheduled PUCCH - 2 bits as defined in Subclause 7.2.1 of [5, TS 38.213] |
| - | PUCCH resource indicator - 3 bits as defined in Subclause 9.2.3 of [5, TS 38.213] |
| - | PDSCH-to-HARQ_feedback timing indicator - 3 bits as defined in Subclause 9.2.3 of [5, TS38.213] |

DCI format 1_1 may be used for non-fallback DCI scheduling a PDSCH, and in this case, a CRC may be scrambled by a C-RNTI. DCI format 1_1 having a CRC scrambled by a C-RNTI may include the following information as shown in Table 14 below.

TABLE 14

| - | Identifier for DCI formats - 1 bits | |
|---|---|---|
| | - | The value of this bit field is always set to 1, indicating a DL DCI format |
| - | Carrier indicator - 0 or 3 bits as defined in Subclause 10.1 of [5, TS 38.213]. | |
| - | Bandwidth part indicator - 0, 1 or 2 bits as determined by the number of DL BWPs n_{BWP,RRC} configured | |
| | by higher layers, excluding the initial DL bandwidth part. The bitwidth for this field is determined as | |
| | ┌log₂(n_{BWP})┐ bits, where | |
| | - | n_{BWP} = n_{BWP,RRC} + 1 if n_{BWP,RRC} ≤ 3 , in which case the bandwidth part indicator is equivalent to the |
| | | ascending order of the higher layer parameter BWP-Id; |
| | - | otherwise n_{BWP} = n_{BWP,RRC} , in which case the bandwidth part indicator is defined in Table 7.3.1.1.2-1; |
| | If a UE does not support active BWP change via DCI, the UE ignores this bit field. | |
| - | Frequency domain resource assignment - number of bits determined by the following, where N_{RB}^{DL,BWP} is | |
| | the size of the active DL bandwidth part: | |
| | - | N_{RBG} bits if only resource allocation type 0 is configured, where N_{RBG} is defined in Subclause |
| | | 5.1.2.2.1 of [6, TS38.214], |
| | - | ┌log₂(N_{RB}^{DL,BWP}(N_{RB}^{DL,BWP} +1)/2)┐ bits if only resource allocation type 1 is configured, or |
| | - | max (┌log₂(N_{RB}^{DL,BWP}(N_{RB}^{DL,BWP} +1)/2)┐ ,N_{RBG})+1 bits if both resource allocation type 0 and 1 are |
| | | configured. |
| | - | If both resource allocation type 0 and 1 are configured, the MSB bit is used to indicate resource |
| | | allocation type 0 or resource allocation type 1, where the bit value of 0 indicates resource allocation |
| | | type 0 and the bit value of 1 indicates resource allocation type 1. |
| | - | For resource allocation type 0, the N_{RBG} LSBs provide the resource allocation as defined in Subclause |
| | | 5.1.2.2.1 of [6, TS 38.214]. |
| | - | For resource allocation type 1, the ┌log₂(N_{RB}^{DL,BWP}(N_{RB}^{DL,BWP} +1)/2)┐ LSBs provide the resource |
| | | allocation as defined in Subclause 5.1.2.2.2 of [6, TS 38.214] |
| | If “Bandwidth part indicator” field indicates a bandwidth part other than the active bandwidth part and if | |
| | both resource allocation type 0 and 1 are configured for the indicated bandwidth part, the UE assumes | |
| | resource allocation type 0 for the indicated bandwidth part if the bitwidth of the “Frequency domain | |
| | resource assignment” field of the active bandwidth part is smaller than the bitwidth of the “Frequency | |
| | domain resource assignment” field of the indicated bandwidth part. | |
| - | Time domain resource assignment - 0, 1, 2, 3, or 4 bits as defined in Subclause 5.1.2.1 of [6, TS 38.214]. | |
| | The bitwidth for this field is determined as [log₂(I)] bits, where I is the number of entries in the higher | |
| | layer parameter pdsch-TimeDomainAllocationList if the higher layer parameter is configured; otherwise I | |
| | is the number of entries in the default table. | |
| - | VRB-to-PRB mapping - 0 or 1 bit: | |
| | - | 0 bit if only resource allocation type 0 is configured or if interleaved VRB-to-PRB mapping is not |
| | | configured by high layers; |
| | - | 1 bit according to Table 7.3.1.2.2-5 otherwise, only applicable to resource allocation type 1, as defined |
| | | in Subclause 7.3.1.6 of [4, TS 38.211]. |

| | |
|---|---|
| - | PRB bundling size indicator - 0 bit if the higher layer parameter prb-BundlingType is not configured or is |
| | set to ‘static’, or 1 bit if the higher layer parameter prb-BundlingType is set to ‘dynamic’ according to |
| | Subclause 5.1.2.3 of [6, TS 38.214]. |
| - | Rate matching indicator - 0, 1, or 2 bits according to higher layer parameters rateMatchPatternGroup1 |
| | and rateMatchPatternGroup2, where the MSB is used to indicate rateMatchPatternGroup1 and the LSB |
| | is used to indicate rateMatchPatternGroup2 when there are two groups. |
| - | ZP CSI-RS trigger - 0, 1, or 2 bits as defined in Subclause 5.1.4.2 of [6, TS 38.214]. The bitwidth for this |
| | field is determined as ┌log₂(n_{ZP} +1)┐ bits, where n_{ZP} is the number of aperiodic ZP CSI-RS resource |
| | sets configured by higher layer. |

For transport block 1:

| | |
|---|---|
| - | Modulation and coding scheme - 5 bits as defined in Subclause 5.1.3.1 of [6, TS 38.214] |
| - | New data indicator - 1 bit |
| - | Redundancy version - 2 bits as defined in Table 7.3.1.1.1-2 |

For transport block 2 (only present if maxNrofCodeWordsScheduledByDCI equals 2):

| | - | Modulation and coding scheme - 5 bits as defined in Subclause 5.1.3.1 of [6, TS 38.214] |
|---|---|---|
| | - | New data indicator - 1 bit |
| | - | Redundancy version - 2 bits as defined in Table 7.3.1.1.1-2 |
| | If “Bandwidth part indicator” field indicates a bandwidth part other than the active bandwidth part and the | |
| | value of maxNrofCodeWordsScheduledByDCI for the indicated bandwidth part equals 2 and the value of | |
| | maxNrofCodeWordsScheduledByDCI for the active bandwidth part equals 1, the UE assumes zeros are | |
| | padded when interpreting the “Modulation and coding scheme”, “New data indicator”, and “Redundancy | |
| | version” fields of transport block 2 according to Subclause 12 of [5, TS38.213], and the UE ignores the | |
| | “Modulation and coding scheme”, “New data indicator”, and “Redundancy version” fields of transport | |
| | block 2 for the indicated bandwidth part. | |
| - | HARQ process number - 4 bits | |
| - | Downlink assignment index - number of bits as defined in the following | |
| | - | 4 bits if more than one serving cell are configured in the DL and the higher layer parameter pdsch- |
| | | HARQ-ACK-Codebook=dynamic, where the 2 MSB bits are the counter DAI and the 2 LSB bits are |
| | | the total DAI; |
| | - | 2 bits if only one serving cell is configured in the DL and the higher layer parameter pdsch-HARQ- |
| | | ACK-Codebook=dynamic, where the 2 bits are the counter DAI; |
| | - | 0 bits otherwise. |
| - | TPC command for scheduled PUCCH - 2 bits as defined in Subclause 7.2.1 of [5, TS 38.213] | |
| - | PUCCH resource indicator - 3 bits as defined in Subclause 9.2.3 of [5, TS 38.213] | |
| - | PDSCH-to-HARQ_feedback timing indicator - 0, 1, 2, or 3 bits as defined in Subclause 9.2.3 of [5, TS | |
| | 38.213]. The bitwidth for this field is determined as [log₂(I)] bits, where I is the number of entries in the | |
| | higher layer parameter dl-DataToUL-ACK. | |
| - | Antenna port(s) - 4, 5, or 6 bits as defined by Tables 7.3.1.2.2-1/2/3/4, where the number of CDM groups | |
| | without data of values 1, 2, and 3 refers to CDM groups {0}, {0,1}, and {0, 1,2} respectively. The antenna | |
| | ports {p_{0,...,} p_{υ-1}} shall be determined according to the ordering of DMRS port(s) given by Tables | |
| | 7.3.1.2.2-1/2/3/4. | |
| | If a UE is configured with both dmrs-DownlinkForPDSCH-MappingTypeA and dmrs- | |
| | DownlinkForPDSCH-MappingTypeB, the bitwidth of this field equals max{x_{A},x_{B}}, where x_{A} is the | |
| | “Antenna ports” bitwidth derived according to dmrs-DownlinkForPDSCH-MappingTypeA and x_{B} is the | |
| | “Antenna ports” bitwidth derived according to dmrs-DownlinkForPDSCH-MappingTypeB. A number of | |
| | \|x_{A} − x_{B}\| zeros are padded in the MSB of this field, if the mapping type of the PDSCH corresponds to the | |
| | smaller value of x_{A} and x_{B} . | |
| - | Transmission configuration indication - 0 bit if higher layer parameter tci-PresentInDCI is not enabled; | |
| | otherwise 3 bits as defined in Subclause 5.1.5 of [6, TS38.214]. | |
| | If “Bandwidth part indicator” field indicates a bandwidth part other than the active bandwidth part, | |
| | - | if the higher layer parameter tci-PresentInDCI is not enabled for the CORESET used for the PDCCH |
| | | carrying the DCI format 1_1, |

| | |
|---|---|
| - | the UE assumes tci-PresentInDCI is not enabled for all CORESETs in the indicated bandwidth |
| | part; |

| | |
|---|---|
| - | otherwise, |

| | |
|---|---|
| - | the UE assumes tci-PresentInDCI is enabled for all CORESETs in the indicated bandwidth part. |

| | |
|---|---|
| - | SRS request - 2 bits as defined by Table 7.3.1.1.2-24 for UEs not configured with supplementaryUplink in |
| | ServingCellConfig in the cell; 3 bits for UEs configured with supplementaryUplink in ServingCellConfig |
| | in the cell where the first bit is the non-SUL/SUL indicator as defined in Table 7.3.1.1.1-1 and the second |
| | and third bits are defined by Table 7.3.1.1.2-24. This bit field may also indicate the associated CSI-RS |
| | according to Subclause 6.1.1.2 of [6, TS 38.214]. |
| - | CBG transmission information (CBGTI) - 0 bit if higher layer parameter codeBlockGroupTransmission |
| | for PDSCH is not configured, otherwise, 2, 4, 6, or 8 bits as defined in Subclause 5.1.7 of [6, TS38.214], |
| | determined by the higher layer parameters maxCodeBlockGroupsPerTransportBlock and |
| | maxNrofCodeWordsScheduledByDCI for the PDSCH. |
| - | CBG flushing out information (CBGFI) - 1 bit if higher layer parameter codeBlockGroupFlushIndicator |
| | is configured as “TRUE”, 0 bit otherwise. |
| - | DMRS sequence initialization - 1 bit. |

Hereinafter, a method for assigning time domain resources for a data channel in a 5G communication system will be described.

A base station may configure, for a UE, a table relating to time domain resource allocation information for a PDSCH and a PUSCH through higher layer signaling (e.g. RRC signaling). The base station may configure, for a PDSCH, a table constituted by a maximum of 16 entries (maxNrofDL-Allocations=16), and may configure, for a PUSCH, a table constituted by a maximum of 16 entries (maxNrofUL-Allocations=16). The time domain resource allocation information may include, for example, PDCCH-to-PDSCH slot timing (a time interval expressed in the units of slots, between a time point at which a PDCCH is received, and a time point at which a PDSCH scheduled by the received PDCCH is transmitted, the timing is indicated by K₀) or PDCCH-to-PUSCH slot timing (a time interval expressed in the units of slots, between a time point at which a PDCCH is received, and a time point at which a PUSCH scheduled by the received PDCCH is transmitted, the timing is indicated by K₂), information relating to the location of a starting symbol of a PDSCH or a PUSCH scheduled in a slot, and the scheduled length, a mapping type of a PDSCH or a PUSCH, and the like. For example, a UE may receive the information as shown in Tables 15 and 16 below by a base station.

TABLE 15
PDSCH-TimeDomainResourceAllocationList information element

PUSCH-TimeDomainResourceAllocationList := SEQUENCE (SIZE(1..maxNrofDL-Allocations)) OF
PDSCH-TimeDomainResourceAllocation

| | |
|---|---|
| PDSCH-TimeDomainResourceAllocation ::= | SEQUENCE { |
| k0 | INTEGER(0..32) |

OPTIONAL, -- Need S

| | |
|---|---|
| mappingType | ENUMERATED {typeA, typeB}, |
| startSymbolAndLength | INTEGER (0..127) |

}

TABLE 16
PUSCH-TimeDomainResourceAllocation information element

| | |
|---|---|
| PUSCH-TimeDomainResourceAllocationList ::= | SEQUENCE (SIZE(1..maxNrofUL-Allocations)) OF |

PUSCH-TimeDomainResourceAllocation

| | |
|---|---|
| PUSCH-TimeDomainResourceAllocation ::= | SEQUENCE { |
| k2 | INTEGER(0..32) OPTIONAL, -- Need S |
| mappingType | ENUMERATED {typeA, typeB}, |
| startSymbolAndLength | INTEGER (0..127) |

}

The base station may indicate the UE of one of the entries of the table relating to the time domain resource allocation information through L1 signaling (e.g. DCI) (e.g. the base station may indicate one of the entries to the UE through a time domain resource allocation field in DCI). The UE may obtain time domain resource allocation information relating to a PDSCH or PUSCH, based on DCI received from the base station.

Hereinafter, a method for allocating frequency domain resources for a data channel in a 5G communication system will be described.

In 5G, two types, such as resource allocation type 0 and resource allocation type 1, are supported as a method for indicating frequency domain resource allocation information for the PDSCH and the PUSCH.

Resource Allocation Type 0

The base station may inform the UE of RB allocation information in the form of a bitmap for a resource block group (RBG). In this case, the RBG may include a set of successive virtual RBs (VRBs), and the size P of the RBG may be determined on the basis of a value configured as a higher-layer parameter (rbg-Size) and a value of the size of a BWP defined in Table 17 below.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A total number N_{RBG} of RBGs of a BWP i having the size of N_{BWP}_{ᵢ}^{size} may be defined as follow equation (2).

$$\begin{matrix}■ {N}_{RBG} = ⌈ {N}_{{BWP}_{i}}^{size} + ( {N}_{{BWP}_{i}}^{start} mod P ) ⌉ / P , where \\ ◆ the size of the first RBG is {RBG}_{0}^{size} = P - ( {N}_{{BWP}_{i}}^{start} mod P ) , \\ ◆ the size of last RBG is {RBG}_{last}^{size} = ( {N}_{{BWP}_{i}}^{start} + {N}_{{BWP}_{i}}^{start} ) mod P , if \\ ( {N}_{{BWP}_{i}}^{start} + {N}_{{BWP}_{i}}^{start} ) mod P > 0 and P otherwise , \\ ◆ the size of all other RBGs is P .\end{matrix} \qquad Equation ( 2 )$$

The respective bits in a bitmap having the bit size of N RBG may correspond to respective RBGs. Indexes may be assigned to the RBGs in the order of increasing frequencies from the lowest frequency of BWP. For N RBG RBGs within the BWP, RBGs from RBG #0 to RBG #(N_{RBG}−1) may be mapped to bits from the MSB to the LSB in the RBG bitmap. When a specific bit value within the bitmap is 1, the UE may determine that an RBG corresponding to the corresponding bit value is allocated. When a specific bit value within the bitmap is 0, the UE may determine that an RBG corresponding to the corresponding bit value is not allocated.

Resource Allocation Type 1

The base station may inform the UE of the RB allocation information including information on a start location and a length of successively allocated VRBs. In this case, interleaving or non-interleaving may be additionally applied to the successively allocated VRBs. A resource allocation field of resource allocation type 1 may include a Resource Indication Value (MV), and the MV may include a start point RBₛₜₐᵣₜ of the VRB and a length L_{RBS} of successively allocated RBs. More specifically, the MV within the BWP having the size of N_{BWP}^{size} may be defined as below.
if (L_{RBs}−1)≤└N_{BWP}^{size}/2┘ then

RIV=N_{BWP}^{size}(L_{RBs}−1)+RBₛₜₐᵣₜ
else

RIV=N_{BWP}^{size}(N_{BWP}^{size}−L_{RBs}−1)+(N_{BWP}^{size}−1−RBₛₜₐᵣₜ)
where L_{RBs}≥1 and shall not exceed N_{BWP}^{size}−RBₛₜₐᵣₜ.

To support non-approval-based transmission/reception for the PDSCH or the PUSCH, the base station may configure various transmission/reception parameters and time and frequency transmission resources for the PDSCH and PUSCH, to the UE in a semi-static manner.

More specifically, to support DL semi-persistent scheduling (SPS), the base station may configure the following information as shown in Table 18 below to the UE via higher layer signaling (e.g., RRC signaling).

TABLE 18

| | |
|---|---|
| SPS-Config ::= | SEQUENCE { |
| periodicity | ENUMERATED {ms10, ms20, ms32, ms40, ms64, ms80, ms128, |

ms160, ms320, ms640,

spare6, spare5, spare4, spare3, spare2,

spare1},

| | |
|---|---|
| nrofHARQ-Processes | INTEGER (1..8), |
| n1PUCCH-AN | PUCCH-ResourceId |

OPTIONAL, -- Need M

| | |
|---|---|
| mcs-Table | ENUMERATED {qam64LowSE} |

OPTIONAL, -- Need S
...,
}

DL SPS may be configured in a primary cell or a secondary cell, and DL SPS may be configured in one cell within one cell group.

In 5G, for two types of non-approval (named Configured Grant, Grant free, etc.)-based transmission methods for the PUSCH, non-approval-based PUSCH transmission type-1 (Type-1 PUSCH transmission with a configured grant) and non-approval-based PUSCH transmission type-2 (Type-2 PUSCH transmission with a configured grant) are supported.

Type-1 PUSCH Transmission with a Configured Grant

In Type-1 PUSCH transmission with a configured grant, a base station may configure a specific time/frequency resource 600 that allows non-approval-based PUSCH transmission to the UE through RRC signaling. For example, referring back to FIG. 6, time axis allocation information 601, frequency axis allocation information (PRB) 602, periodicity information 603, etc. for the resource 600 may be configured. In addition, the base station may configure various parameters for PUSCH transmission (e.g., frequency hopping, DMRS configuration, MCS table, MCS, resource block group (RBG) size, number of repetitive transmissions, redundancy version (RV), etc.) to the UE through higher layer signaling. The configuration information in Table 19 below may be included.

TABLE 19

| | |
|---|---|
| ConfiguredGrantConfig ::= | SEQUENCE { |
| frequencyHopping | ENUMERATED {mode1, mode2} |

OPTIONAL, -- Need S

| | |
|---|---|
| cg-DMRS-Configuration | DMRS-UplinkConfig, |
| mcs-Table | ENUMERATED {qam256, spare 1} |

OPTIONAL, -- Need S

| | |
|---|---|
| mcs-TableTransformPrecoder | ENUMERATED {qam256, spare1} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, resourceAllocationType1, |

dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

sym2, sym7, sym1x14, sym2x14, sym4x14, sym5x14,

sym8x14, sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |

| | |
|---|---|
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |

| | |
|---|---|
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs-1), |

```
      ...,
  }
  OPTIONAL, -- Need R
```

When receiving configuration information for Type-1 PUSCH transmission with a configured grant from the base station, the UE may periodically transmit PUSCH to the configured resource 600 without approval from the base station. Various parameters required to transmit PUSCH (e.g., frequency hopping, DMRS configuration, MCS, RBG size, number of repetitive transmissions, RV, precoding and number of layers, antenna port, frequency hopping offset etc.) may follow the configuration values notified by the base station.

Type-2 PUSCH Transmission with a Configured Grant

In Type-2 PUSCH transmission with a configured grant, a base station may configure some (e.g., periodicity information 603, etc.) of the information about the specific time/frequency resource 600 that allows non-approval-based PUSCH transmission to the UE through RRC signaling. In addition, the base station may configure various parameters for PUSCH transmission (e.g., frequency hopping, DMRS configuration, MCS table, MCS, RBG size, number of repetitive transmissions, redundancy version (RV), etc.) to the UE through higher layer signaling. The base station may configure the configuration information in Table 20 below to the UE through higher layer signaling.

TABLE 20

| | |
|---|---|
| ConfiguredGrantConfig ::= | SEQUENCE { |

| | |
|---|---|
| frequencyHopping | ENUMERATED {mode1, mode2} |

OPTIONAL, -- Need S

| | |
|---|---|
| cg-DMRS-Configuration | DMRS-UplinkConfig, |

| | |
|---|---|
| mcs-Table | ENUMERATED {qam256, spare1} |

OPTIONAL, -- Need S

| | |
|---|---|
| mcs-TableTransformPrecoder | ENUMERATED {qam256, spare 1} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, resourceAllocationType1, |

dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |

| | |
|---|---|
| transformPrecoder | ENUMERATED {enabled} |

OPTIONAL, -- Need S

| | |
|---|---|
| nrofHARQ-Processes | INTEGER(1..16), |
| repK | ENUMERATED {n1, n2, n4, n8}, |

| | |
|---|---|
| repK-RV | ENUMERATED {s1-0231, s2-0303, s3-0000} |

OPTIONAL, -- Need R

| | |
|---|---|
| periodicity | ENUMERATED { |

sym2, sym7, sym1x14, sym2x14, sym4x14, sym5x14,

sym8x14, sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R
}

The base station may transmit, to the UE, DCI including a specific DCI field value, for the purpose of scheduling activation or scheduling release for DL SPS and UL grant Type 2.

The base station may configure a configured scheduling-RNTI (CS-RNTI) to the UE, and the UE may monitor a DCI format in which a CRC is scrambled with CS-RNTI. When the CRC of the DCI format received by the UE is scrambled with CS-RNTI, a new data indicator (NDI) is set to “0”, and a DCI field satisfies Table 21 below, the UE may consider the DCI as an instruction activating transmission/reception for DL SPS or UL grant Type 2.

TABLE 21

| | DCI format | DCI format | DCI format |
|---|---|---|---|
| | 0_0/0_1 | 1_0 | 1_1 |
| HARQ process number | set to all ‘0’s | set to all ‘0’s | set to all ‘0’s |
| Redundancy version | set to ‘00’ | set to ‘00’ | For the enabled |
| | | | transport block: |
| | | | set to ‘00’ |

The base station may configure a configured scheduling-RNTI (CS-RNTI) to the UE, and the UE may monitor a DCI format in which CRC is scrambled with CS-RNTI. When the CRC of the DCI format received by the UE is scrambled with CS-RNTI, an NDI is set to “0”, and a DCI field satisfies Table 22 below, the UE may consider the DCI as an instruction releasing transmission/reception for DL SPS or UL grant Type 2.

TABLE 22

| | DCI format 0_0 | DCI format 1_0 |
|---|---|---|
| HARQ process number | set to all ‘0’s | set to all ‘0’s |
| Redundancy version | set to ‘00’ | set to ‘00’ |
| Modulation and coding scheme | set to all ‘1’s | set to all ‘1’s |
| Frequency domain resource | set to all ‘1’s | set to all ‘1’s |
| assignment | | |

The DCI indicating release for DL SPS or UL grant Type 2 follows a DCI format corresponding to DCI format 0_0 or DCI format 1_0, and DCI format 0_0 or DCI format 1_0 does not include a carrier indicator field (CIF), so that, in order to receive a release instruction for DL SPS or UL grant Type 2 for a specific cell, the UE should always monitor PDCCH in a cell in which the DL SPS or UL grant Type 2 is configured. Even if the specific cell is configured for cross-carrier scheduling, the UE should always monitor DCI format 1_0 or DCI format 0_0 in the corresponding cell in order to receive the release instruction for DL SPS or UL grant Type 2 configured in the corresponding cell.

The UE may be configured with multiple cells or component carriers (CCs) from the base station and may be configured to perform cross-carrier scheduling on cells configured for the UE. If the cross-carrier scheduling is configured for a specific cell (cell A or a scheduled cell), PDCCH monitoring for cell A may not be performed in cell A, but may be performed in other cells (cell B or a scheduling cell) indicated for the cross-carrier scheduling. In this case, different numerologies may be configured for the scheduled cell (cell A) and the scheduling cell (cell B). The numerology may include a subcarrier spacing, a cyclic prefix, and the like. When the numerologies of cell A and cell B are different from each other, the following minimum scheduling offset may be additionally considered between the PDCCH and the PDSCH when the PDCCH of cell B schedules the PDSCH of cell A.

Cross-Carrier Scheduling Method

When a subcarrier spacing μ_{B} of cell B is less than a subcarrier spacing μ_{A} of cell A, the PDSCH may be scheduled from a subsequent PDSCH slot that corresponds to X symbols after from the last symbol of the PDCCH received in cell B. Here, X may vary according to μ B, wherein X=4 symbols may be defined when μ_{B}=15 kHZ, X=4 symbols may be defined when μ_{B}=30 kHZ, and X=8 symbols may be defined when μ_{B}=60 kHZ.

When the subcarrier spacing μ_{B} of cell B is greater than subcarrier spacing μ_{A} of cell A, the PDSCH may be scheduled from a time point corresponding to X symbols after the last symbol of the PDCCH received in cell B. Here, X may vary according to μ_{B}, wherein X=4 symbols may be defined when μ_{B}=30 kHZ, X=8 symbols may be defined when μ_{B}=60 kHZ, and X=12 symbols may be defined when μ_{B}=120 kHZ.

When time and frequency resources A in which symbol sequences A are to be transmitted overlap time and frequency resources B, a rate matching operation or a puncturing operation may be considered as an operation of transmitting and receiving a channel A considering resources C where the resources A and the resources B overlap.

Rate Matching Operation

From among all resources A in which symbol sequences A are to be transmitted to a UE, a base station may map and transmit symbol sequence A only to the resource region other than a resource C corresponding to a region where the resources A and resources B overlap each other. For example, when symbol sequences A include symbol #1, symbol #2, symbol #3, and symbol 4, resources A include resource #1, resource #2, resource #3, and resource #4, and resources B include resource #3 and resource #5, the base station may sequentially map the symbol sequences A to resource #1, resource #2, and resource #4 which are resources other than resource #3 corresponding to a resource C, among resource A and may transmit the same. As a result, the base station may respectively map symbol #1, symbol #2, and symbol #3 to resource #1, resource #2, and resource #4, respectively, and may transmit the same.

The UE may determine the resources A and the resources B based on scheduling information for the symbol sequences A from the base station, and thus, may determine the resource C that is a region where the resources A and the resources B overlap each other. The UE may receive the symbol sequences A by assuming that the symbol sequences A are mapped to regions other than the resource C from among all of the resources A and are transmitted. For example, when symbol sequences A include symbol #1, symbol #2, symbol #3, and symbol 4, resources A include resource #1, resource #2, resource #3, and resource #4, and resources B include resource #3 and resource #5, the UE may receive the symbol sequences A by assuming that the symbol sequences A are sequentially mapped to resource #1, resource #2, and resource #4 which are resources other than resource #3 corresponding to resource C from among the resources A. As a result, the UE may assume that symbol #1, symbol #2, and symbol #3 are respectively mapped to resource #1, resource #2, and resource #4 and are transmitted, and may perform a subsequent series of reception operations.

Puncturing Operation

From among all resources A in which symbol sequences A are to be transmitted to a UE, when there exists a resource C corresponding to a region where the resources A and resources B overlap each other, a base station may map the symbol sequences A to all of the resources A, but may not perform transmission for a resource corresponding to the resource C and may perform transmission for resources other than resource C from among all of the resources A. For example, when symbol sequences A include symbol #1, symbol #2, symbol #3, and symbol 4, resources A include resource #1, resource #2, resource #3, and resource #4, and resources B include resource #3 and resource #5, the base station may respectively map the symbol sequences A including symbol #1, symbol #2, symbol #3, and symbol #4 to resources A including resource #1, resource #2, resource #3, and resource #4, and may transmit only symbol sequences including symbol #1, symbol #2, and symbol #4 corresponding to resource #1, resource #2, and resource #4 which are resources other than resource #3 corresponding to resource C from among all of the resources A and may not transmit symbol #3 mapped to resource #3 corresponding to resource C. As a result, the base station may respectively map symbol #1, symbol #2, and symbol #4 to resource #1, resource #2, and resource #4 and may transmit the same.

The UE may determine resources A and resources B based on scheduling information for the symbol sequences A from the base station, and thus, may determine resource C as a region where resources A and resources B overlap each other. The UE may receive the symbol sequences A by assuming that the symbol sequences A are mapped to all of the resources A but symbols are transmitted only in resources other than resource C among the resource region A. For example, when symbol sequences A include symbol #1, symbol #2, symbol #3, and symbol 4, resources A include resource #1, resource #2, resource #3, and resource #4, and resources B include resource #3 and resource #5, the UE may assume that symbol #1, symbol #2, symbol #3, and symbol 4 are respectively mapped to resources A including resource #1, resource #2, resource #3, and resource #4 but symbol #3 mapped to resource #3 corresponding to resource C is not transmitted, and may receive symbol sequences by assuming that symbol #1, symbol #2, and symbol #4 corresponding to resource #1, resource #2, and resource #4 which are resources other than resource #3 corresponding to resource C from among the resources A are mapped and transmitted. As a result, the UE may assume that symbol #1, symbol #2, and symbol #4 are respectively mapped to resource #1, resource #2, and resource #4 and are transmitted, and may perform a subsequent series of subsequent reception operations.

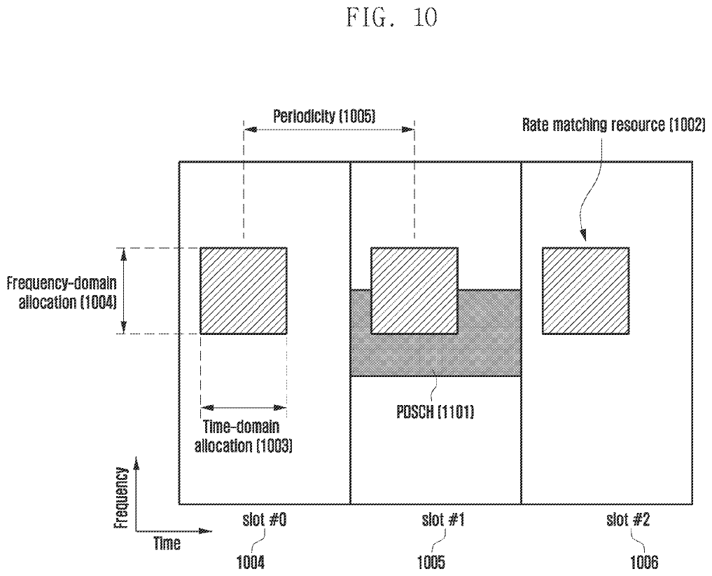

FIG. 10 illustrates a method by which a base station and a UE transmit and receive data by considering a DL data channel and a rate matching resource according to an embodiment.

In FIG. 10, PDSCH 1001 and a rate matching resource 1002 are described. A base station may configure one or more rate matching resources 1002 to a UE through RRC signaling. The configuration information of the rate matching resources 1002 may include time axis resource allocation information 1003, frequency axis resource allocation information 1004, and periodicity information 1005. Hereinafter, a bitmap corresponding to the frequency axis resource allocation information 1004 is referred to as a first bitmap, a bitmap corresponding to the time axis resource allocation information 1003 is referred to as a second bitmap, and a bitmap corresponding to the periodicity information 1005 is referred to as a third bitmap. When some or all of time and frequency resources of the scheduled data channel 1001 overlap the configured rate matching resources 1002, the base station may rate match the data channel 1001 in some of the rate matching resources 1002 and may transmit the same, and the UE may perform reception and decoding after assuming that the data channel 1001 is rate matched in some of the rate matching resources 1002.

The base station may dynamically notify the UE whether the data channel is going to be rate matched in some of the configured rate matching resources through DCI (corresponding to a rate matching indicator in the above-described DCI format). Specifically, the base station may select some of the configured rate matching resources, may group the selected resources into rate matching resource groups, and may indicate whether the data channel is rate matched with each rate matching resource group through DCI using a bitmap method with respect to the UE. For example, when four rate matching resources RMR #1, RMR #2, RMR #3 and RMR #4 are configured, the base station may configure RMG #1={RMR #1, RMR #2} and RMG #2={RMR #3, RMR #4} as rate matching groups, and may indicate whether rate matching in each of RMG #1 and RMG #2 is performed using 2 bits of a DCI field with respect to the UE. For example, the base station may indicate, to the UE, 1 when rate matching needs to be performed and may indicate 0 when it is unnecessary to perform rate matching.

5G supports RB symbol level and RE level granularity as a method for configuring a rate matching resource in a UE. In more detail, the following configuration methods may be performed.

RB Symbol Level

A UE may be configured with up to four RateMatchPattems for each BWP through higher layer signaling, and one RateMatchPattern may include the following content.

As reserved resources in a BWP, resources in which time and frequency resource regions of the reserved resources are configured in a combination of an RB level bitmap and a symbol level bitmap in a frequency axis may be included. The reserved resources may span one or two slots. A time domain pattern (periodicityAndPattem) in which time and frequency domains including each RB level and symbol level bitmap pair are repeated may be additionally configured.

A time and frequency domain resource region configured by a control resource set in a BWP and a resource region corresponding to a time domain pattern configured by a search space configuration in which the corresponding resource region is repeated may be included.

RE Level

A UE may be configured with the following information through higher layer signaling. As configuration information (Ite-CRS-ToMatchAround) for REs corresponding to an LTE cell-specific reference signal or common reference signal (CRS) pattern, the number of LTE CRS ports (nrofCRS-Ports) and LTE-CRS-vshift(s) (v-shift) value, position information (carrierFregDL) from a reference frequency point (e.g., a reference point A) to an LTE carrier center subcarrier, LTE carrier bandwidth size information (carrierBandwidthDL), and subframe configuration information (mbsfn-SubframConfigList) corresponding to multicast-broadcast single-frequency network (MBSFN) may be included. The UE may determine a position of a CRS in an NR slot corresponding to an LTE subframe based on the above information.

One or more zero power (ZP) CSI-RS resource set configuration information in a BWP may be included.

CSI may include channel quality information (CQI), a precoding matrix indicator (PMI), a CSI-RS resource indicator (CRI), an SS/PBCH block resource indicator (SSBRI), a layer indicator (LI), a rank indicator (RI), and/or an L1—reference signal received power (RSRP). A base station may control time- and frequency resources for the CSI measurement and reporting of a UE.

For the CSI measurement and reporting, the UE may be configured, through higher layer signaling, setting information for N (≥1) CSI reports (CSI-ReportConfig), setting information for M (≥1) RS transmission resources (CSI-ResourceConfig), and one or two pieces of trigger state list information (CSI-AperiodicTriggerStateList and CSI-SemiPersistentOnPUSCH-TriggerStateList).

The configuration information for the above-described CSI measurement and reporting may be more specifically as shown in Tables 23 to 29 below.

TABLE 23
The IE CSI-ReportConfig is used to configure a periodic or semi-persistent report sent on PUCCH on the cell in
which the CSI-ReportConfig is included, or to configure a semi-persistent or aperiodic report sent on PUSCH
triggered by DCI received on the cell in which the CSI-ReportConfig is included (in this case, the cell on which the
report is sent is determined by the received DCI). See TS 38.214 [19], clause 5.2.1.

CSI-ReportConfig information element

-- ASN1START
-- TAG-CSI-REPORTCONFIG-START

| | |
|---|---|
| CSI-ReportConfig ::= | SEQUENCE { |

| reportConfigId | CSI-ReportConfigId, | |
|---|---|---|
| carrier | ServCellIndex | OPTIONAL, -- |

Need S

| resourcesForChannelMeasurement | CSI-ResourceConfigId, | |
|---|---|---|
| csi-IM-ResourcesForInterference | CSI-ResourceConfigId | OPTIONAL, -- Need |

R

| | | |
|---|---|---|
| nzp-CSI-RS-ResourcesForInterference | CSI-ResourceConfigId | OPTIONAL, -- Need |

R

| | |
|---|---|
| reportConfigType | CHOICE { |

| | |
|---|---|
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF |

PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF |

PUCCH-CSI-Resource
},

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1..maxNrofUL-Allocations)) OF |

```
INTEGER(0..32)
    }
  },
```

| | |
|---|---|
| reportQuantity | CHOICE { |

| | |
|---|---|
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |

| | |
|---|---|
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

```
    } OPTIONAL -- Need S
  }
OPTIONAL, -- Need R
```

| | |
|---|---|
| timeRestrictionForChannelMeasurements | ENUMERATED {configured, notConfigured}, |
| timeRestrictionForInterferenceMeasurements | ENUMERATED {configured, notConfigured}, |
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |
| enabled | NULL, |
| disabled | SEQUENCE { |
| nrofReportedRS | ENUMERATED {n1, n2, n3, n4} |

```
OPTIONAL -- Need S
    }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS-ResourcesPerConfig)) OF |

```
PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

```
  }
OPTIONAL -- Need R
  ]]
}
CSI-ReportPeriodicity AndOffset ::= CHOICE {
```

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |

| | |
|---|---|
| uplinkBandwidthPartId | BWP-Id, |
| pucch-Resource | PUCCH-ResourceId |

}

| | |
|---|---|
| PortIndexFor8Ranks ::= | CHOICE { |

| | |
|---|---|
| portIndex8 | SEQUENCE{ |
| rank1-8 | PortIndex8 |

OPTIONAL, -- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| | |
|---|---|
| portIndex4 | SEQUENCE{ |
| rank1-4 | PortIndex4 |

OPTIONAL, -- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| | |
|---|---|
| portIndex2 | SEQUENCE{ |
| rank1-2 | PortIndex2 |

OPTIONAL, -- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

CSI-ReportConfig field descriptions

carrier
Indicates in which serving cell the CSI-ResourceConfig indicated below are to be found. If the field is absent, the
resources are on the same serving cell as this report configuration.
codebookConfig
Codebook configuration for Type-1 or Type-2 including codebook subset restriction.
cqi-FormatIndicator
Indicates whether the UE shall report a single (wideband) or multiple (subband) CQI (see TS 38.214 [19], clause
5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-ResourceConfig included in the
configuration of the serving cell indicated with the field “carrier” above. The CSI-ResourceConfig indicated here
contains only CSI-IM resources. The bwp-Id in that CSI-ResourceConfig is the same value as the bwp-Id in the
CSI-ResourceConfig indicated by resourcesForChannelMeasurement.
csi-ReportingBand
Indicates a contiguous or non-contiguous subset of subbands in the bandwidth part which CSI shall be reported
for. Each bit in the bit-string represents one subband. The right-most bit in the bit string represents the lowest
subband in the BWP. The choice determines the number of subbands (subbands3 for 3 subbands, subbands4 for
4 subbands, and so on) (see TS 38.214 [19], clause 5.2.1.4). This field is absent if there are less than 24 PRBs
(no sub band) and present otherwise (see TS 38.214 [19], clause 5.2.1.4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked ResourceConfig for channel
measurement, a port indication for each rank R, indicating which R ports to use. Applicable only for non-PMI
feedback (see TS 38.214 [19], clause 5.2.1.4.2).
The first entry in non-PMI-PortIndication corresponds to the NZP-CSI-RS-Resource indicated by the first entry in
nzp-CSI-RS-Resources in the NZP-CSI-RS-ResourceSet indicated in the first entry of nzp-CSI-RS-
ResourceSetList of the CSI-ResourceConfig whose CSI-ResourceConfigId is indicated in a CSI-MeasId together
with the above CSI-ReportConfigId; the second entry in non-PMI-PortIndication corresponds to the NZP-CSI-RS-
Resource indicated by the second entry in nzp-CSI-RS-Resources in the NZP-CSI-RS-ResourceSet indicated in
the first entry of nzp-CSI-RS-ResourceSetList of the same CSI-ResourceConfig, and so on until the NZP-CSI-RS-
Resource indicated by the last entry in nzp-CSI-RS-Resources in the in the NZP-CSI-RS-ResourceSet indicated in
the first entry of nzp-CSI-RS-ResourceSetList of the same CSI-ResourceConfig. Then the next entry corresponds
to the NZP-CSI-RS-Resource indicated by the first entry in nzp-CSI-RS-Resources in the NZP-CSI-RS-
ResourceSet indicated in the second entry of nzp-CSI-RS-ResourceSetList of the same CSI-ResourceConfig and
so on.
nrofReportedRS
The number (N) of measured RS resources to be reported per report setting in a non-group-based report. N <=
N_max, where N_max is either 2 or 4 depending on UE capability.
(see TS 38.214 [19], clause 5.2.1.4) When the field is absent the UE applies the value 1.
nzp-CSI-RS-ResourcesForInterference
NZP CSI RS resources for interference measurement. csi-ResourceConfigId of a CSI-ResourceConfig included in
the configuration of the serving cell indicated with the field “carrier” above. The CSI-ResourceConfig indicated here
contains only NZP-CSI-RS resources. The bwp-Id in that CSI-ResourceConfig is the same value as the bwp-Id in
the CSI-ResourceConfig indicated by resourcesForChannelMeasurement.
p0alpha
Index of the p0-alpha set determining the power control for this CSI report transmission (see TS 38.214 [19],
clause 6.2.1.2).
pdsch-BundleSizeForCSI
PRB bundling size to assume for CQI calculation when reportQuantity is CRI/RI/i1/CQI. If the field is absent, the
UE assumes that no PRB bundling is applied (see TS 38.214 [19], clause 5.2.1.4.2).
pmi-FormatIndicator
Indicates whether the UE shall report a single (wideband) or multiple (subband) PMI. (see TS 38.214 [19], clause
5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1.
reportSlotConfig
Periodicity and slot offset (see TS 38.214 [19], clause 5.2.1.4). If the field reportSlotConfig-v1530 is present, the
UE shall ignore the value provided in reportSlotConfig (without suffix).
reportSlotOffsetList
Timing offset Y for semi persistent reporting using PUSCH. This field lists the allowed offset values. This list must
have the same number of entries as the pusch-TimeDomainAllocationList in PUSCH-Config. A particular value is
indicated in DCI. The network indicates in the DCI field of the UL grant, which of the configured report slot offsets
the UE shall apply. The DCI value 0 corresponds to the first report slot offset in this list, the DCI value 1
corresponds to the second report slot offset in this list, and so on. The first report is transmitted in slot n + Y, second
report in n + Y + P, where P is the configured periodicity.
Timing offset Y for aperiodic reporting using PUSCH. This field lists the allowed offset values. This list must have
the same number of entries as the pusch-TimeDomainAllocationList in PUSCH-Config. A particular value is
indicated in DCI. The network indicates in the DCI field of the UL grant, which of the configured report slot offsets
the UE shall apply. The DCI value 0 corresponds to the first report slot offset in this list, the DCI value 1
corresponds to the second report slot offset in this list, and so on (see TS 38.214 [19], clause 6.1.2.1).
resourcesForChannelMeasurement
Resources for channel measurement. csi-ResourceConfigId of a CSI-ResourceConfig included in the configuration
of the serving cell indicated with the field “carrier” above. The CSI-ResourceConfig indicated here contains only
NZP-CSI-RS resources and/or SSB resources. This CSI-ReportConfig is associated with the DL BWP indicated by
bwp-Id in that CSI-ResourceConfig.
subbandSize
Indicates one out of two possible BWP-dependent values for the subband size as indicated in TS 38.214 [19],
table 5.2.1.4-2 . If csi-ReportingBand is absent, the UE shall ignore this field.
timeRestrictionForChannelMeasurements
Time domain measurement restriction for the channel (signal) measurements (see TS 38.214 [19], clause 5.2.1.1).
timeRestrictionForInterferenceMeasurements
Time domain measurement restriction for interference measurements (see TS 38.214 [19], clause 5.2.1.1).

TABLE 24
CSI-ResourceConfig
The IE CSI-ResourceConfig defines a group of one or more NZP-CSI-RS-ResourceSet, CSI-IM-
ResourceSet and/or CSI-SSB-ResourceSet.

CSI-ResourceConfig information element

-- ASN1START
-- TAG-CSI-RESOURCECONFIG-START

| | |
|---|---|
| CSI-ResourceConfig ::= | SEQUENCE { |

| | |
|---|---|
| csi-ResourceConfigId | CSI-ResourceConfigId, |
| csi-RS-ResourceSetList | CHOICE { |

| | |
|---|---|
| nzp-CSI-RS-SSB | SEQUENCE { |
| nzp-CSI-RS-ResourceSetList | SEQUENCE (SIZE (1..maxNrofNZP-CSI-RS- |

ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId
OPTIONAL -- Need R
},

| | |
|---|---|
| csi-IM-ResourceSetList | SEQUENCE (SIZE (1..maxNrofCSI-IM-ResourceSetsPerConfig)) OF |

CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

CSI-ResourceConfig field descriptions

bwp-Id
The DL BWP which the CSI-RS associated with this CSI-ResourceConfig are located in (see TS 38.214 [19],
clause 5.2.1.2.
csi-IM-ResourceSetList
List of references to CSI-IM resources used for CSI measurement and reporting in a CSI-RS resource set.
Contains up to maxNrofCSI-IM-ResourceSetsPerConfig resource sets if resource Type is ‘aperiodic’ and 1
otherwise (see TS 38.214 [19], clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and reporting in a CSI-RS resource set (see TS
38.214 [19], clause 5.2.1.2).
nzp-CSI-RS-ResourceSetList
List of references to NZP CSI-RS resources used for CSI measurement and reporting in a CSI-RS resource set.
Contains up to maxNrofNZP-CSI-RS-ResourceSetsPerConfig resource sets if resource Type is ‘aperiodic’ and 1
otherwise (see TS 38.214 [19], clause 5.2.1.2).
resource Type
Time domain behavior of resource configuration (see TS 38.214 [19], clause 5.2.1.2). It does not apply to
resources provided in the csi-SSB-ResourceSetList.

TABLE 25
NZP-CSI-RS-ResourceSet
The IE NZP-CSI-RS-ResourceSet is a set of Non-Zero-Power (NZP) CSI-RS resources (their IDs) and set-specific
parameters.

NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) |

OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R
...
}
-- TAG-NZP-CSI-RS-RESOURCESET-STOP
-- ASN1STOP

NZP-CSI-RS-ResourceSet field descriptions
aperiodicTriggeringOffset
Offset X between the slot containing the DCI that triggers a set of aperiodic NZP CSI-RS resources and the slot in
which the CSI-RS resource set is transmitted. The value 0 corresponds to 0 slots, value 1 corresponds to 1 slot,
value 2 corresponds to 2 slots, value 3 corresponds to 3 slots, value 4 corresponds to 4 slots, value 5 corresponds
to 16 slots, value 6 corresponds to 24 slots. When the field is absent the UE applies the value 0.
nzp-CSI-RS-Resources
NZP-CSI-RS-Resources associated with this NZP-CSI-RS resource set (see TS 38.214 [19], clause 5.2). For CSI,
there are at most 8 NZP CSI RS resources per resource set.
repetition
Indicates whether repetition is on/off. If the field is set to off or if the field is absent, the UE may not assume that
the NZP-CSI-RS resources within the resource set are transmitted with the same downlink spatial domain
transmission filter (see TS 38.214 [19], clauses 5.2.2.3.1 and 5.1.6.1.2). It can only be configured for CSI-RS
resource sets which are associated with CSI-ReportConfig with report of L1 RSRP or “no report”.
trs-Info
Indicates that the antenna port for all NZP-CSI-RS resources in the CSI-RS resource set is same. If the field is
absent or released the UE applies the value false (see TS 38.214 [19], clause 5.2.2.3.1).

TABLE 26
CSI-SSB-ResourceSet
The IE CSI-SSB-ResourceSet is used to configure one SS/PBCH block resource set which refers to SS/PBCH as
indicated in ServingCellConfigCommon.

CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF |

SSB-Index,
...
}
-- TAG-CSI-SSB-RESOURCESET-STOP
-- ASN1STOP

TABLE 27
CSI-IM-ResourceSet
The IE CSI-IM-ResourceSet is used to configure a set of one or more CSI Interference Management (IM) resources
(their IDs) and set-specific parameters.

CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM-ResourcesPerSet)) OF |

CSI-IM-ResourceId,
...
}
-- TAG-CSI-IM-RESOURCESET-STOP
-- ASN1STOP

CSI-IM-ResourceSet field descriptions

csi-IM-Resources
CSI-IM-Resources associated with this CSI-IM-ResourceSet (see TS 38.214 [19], clause 5.2).

TABLE 28
CSI-AperiodicTriggerStateList
The CSI-AperiodicTriggerStateList IE is used to configure the UE with a list of aperiodic trigger states. Each
codepoint of the DCI field “CSI request” is associated with one trigger state (see TS 38.321 [3], clause 6.1.3.13).
Upon reception of the value associated with a trigger state, the UE will perform measurement of CSI-RS, CSI-IM
and/or SSB (reference signals) and aperiodic reporting on L1 according to all entries in the
associatedReportConfigInfoList for that trigger state.
CSI-AperiodicTriggerStateList information element
-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) OF CSI- |

Aperiodic TriggerState

| | |
|---|---|
| CSI-AperiodicTriggerState ::= | SEQUENCE { |
| associatedReportConfigInfoList | SEQUENCE (SIZE(1..maxNrofReportConfigPerAperiodicTrigger)) |

OF CSI-AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |

CSI-AssociatedReportConfigInfo field descriptions
csi-IM-ResourcesForInterference
CSI-IM-ResourceSet for interference measurement. Entry number in csi-IM-ResourceSetList in the CSI-
ResourceConfig indicated by csi-IM-ResourcesForInterference in the CSI-ReportConfig indicated by
reportConfigId above (value 1 corresponds to the first entry, value 2 to the second entry, and so on). The indicated
CSI-IM-ResourceSet should have exactly the same number of resources like the NZP-CSI-RS-ResourceSet
indicated in resourceSet within nzp-CSI-RS.
csi-SSB-ResourceSet
CSI-SSB-ResourceSet for channel measurements. Entry number in csi-SSB-ResourceSetList in the CSI-
ResourceConfig indicated by resourcesForChannelMeasurement in the CSI-ReportConfig indicated by
reportConfigId above (value 1 corresponds to the first entry, value 2 to the second entry, and so on).
nzp-CSI-RS-ResourcesForInterference
NZP-CSI-RS-ResourceSet for interference measurement. Entry number in nzp-CSI-RS-ResourceSetList in the
CSI-ResourceConfig indicated by nzp-CSI-RS-ResourcesForInterference in the CSI-ReportConfig indicated by
reportConfigId above (value 1 corresponds to the first entry, value 2 to the second entry, and so on).
qcl-info
List of references to TCI-States for providing the QCL source and QCL type for each NZP-CSI-RS-Resource listed
in nzp-CSI-RS-Resources of the NZP-CSI-RS-ResourceSet indicated by resourceSet within nzp-CSI-RS. Each
TCI-StateId refers to the TCI-State which has this value for tci-StateId and is defined in tci-StatesToAddModList in
the PDSCH-Config included in the BWP-Downlink corresponding to the serving cell and to the DL BWP to which
the resourcesForChannelMeasurement (in the CSI-ReportConfig indicated by reportConfigId above) belong to.
First entry in qcl-info corresponds to first entry in nzp-CSI-RS-Resources of that NZP-CSI-RS-ResourceSet,
second entry in qcl-info corresponds to second entry in nzp-CSI-RS-Resources, and so on (see TS 38.214 [19],
clause 5.2.1.5.1)
reportConfigId
The reportConfigId of one of the CSI-ReportConfigToAddMod configured in CSI-MeasConfig
resourceSet
NZP-CSI-RS-ResourceSet for channel measurements. Entry number in nzp-CSI-RS-ResourceSetList in the CSI-
ResourceConfig indicated by resourcesForChannelMeasurement in the CSI-ReportConfig indicated by
reportConfigId above (value 1 corresponds to the first entry, value 2 to thesecond entry, and so on).

| Conditional | |
|---|---|
| Presence | Explanation |
| Aperiodic | The field is mandatory present if the NZP-CSI-RS- |
| | Resources in the associated resourceSet have the |
| | resourceType aperiodic. The field is absent otherwise. |
| CSI-IM- | This field is mandatory present if the CSI-ReportConfig |
| ForInterference | identified by reportConfigId is configured with csi-IM- |
| | ResourcesForInterference; otherwise it is absent. |
| NZP-CSI-RS- | This field is mandatory present if the CSI-ReportConfig |
| ForInterference | identified by reportConfigId is configured with nzp-CSI- |
| | RS-ResourcesForInterference; otherwise it is absent. |

```
TABLE 29
CSI-SemiPersistentOnPUSCH-TriggerStateList
The CSI-SemiPersistentOnPUSCH-TriggerStateList IE is used to configure the UE with list of trigger states for
semi-persistent reporting of channel state information on L1. See also TS 38.214 [19], clause 5.2.
    CSI-SemiPersistentOnPUSCH-TriggerStateList information element
-- ASN1START
-- TAG-CSI-SEMIPERSISTENTONPUSCHTRIGGERSTATELIST-START
CSI-SemiPersistentOnPUSCH-TriggerStateList ::=
      SEQUENCE(SIZE (1..maxNrOfSemiPersistentPUSCH-Triggers)) OF
CSI-SemiPersistentOnPUSCH-TriggerState
```

| | |
|---|---|
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

With respect to the CSI reporting configurations (CSI-ReportConfig), each reporting configuration CSI-ReportConfig may be associated with a CSI resource configuration associated with the corresponding report configuration, and one DL BWP identified by a higher layer parameter BWP identifier (bwp-id) given as CSI-ResourceConfig. As a time domain reporting operation for each reporting configuration CSI-ReportConfig, aperiodic, semi-persistent, and periodic types may be supported, and the types may be configured for a UE by a base station through the parameter reportConfigType configured from a higher layer. A semi-persistent CSI reporting method may support PUCCH-based semi-persistent (semi-PersistentOnPUCCH), and PUSCH-based semi-persistent (semi-PersistentOnPUSCH). In a periodic or semi-persistent CSI reporting method, a PUCCH or PUSCH resource on which CSI is to be transmitted may be configured for a UE by a base station through higher layer signaling. The period and slot offset of a PUCCH or PUSCH resource on which CSI is to be transmitted may be given by the numerology of a UL BWP configured to transmit CSI reporting. In an aperiodic CSI reporting method, a PUSCH resource on which CSI is to be transmitted may be scheduled for a UE by a base station through L1 signaling (DCI format 0_1 described above).

With respect to the CSI resource configuration (CSI-ResourceConfig), each CSI resource configuration CSI-ReportConfig may include S (where S≥1) pieces of CSI resource sets (which is given by a higher layer parameter csi-RS-ResourceSetList). A CSI resource set list may include a non-zero power (NZP) CSI-RS resource set and an SS/PBCH block set, or may include a CSI-interference measurement (CSI-IM) resource set. Each CSI resource configuration may be positioned in a DL BWP identified by a higher layer parameter bwp-id and may be connected to a CSI reporting configuration in the same DL BWP. A time domain operation of a CSI-RS resource in a CSI resource configuration may be configured to one of aperiodic, periodic, and semi-persistent by a higher layer parameter resourceType. With respect to a periodic or semi-persistent CSI resource configuration, the number of CSI-RS resource sets may be limited to be S=1, and a configured periodicity and slot offset may be given by the numerology of a DL BWP identified by a bwp-id. One or more CSI resource configurations for channel or interference measurement may be configured for a UE by a base station through higher layer signaling, and may include CSI resources such as a CSI-IM resource for interference measurement, an NZP CSI-RS resource for interference measurement, and an NZP CSI-RS resource for channel measurement.

With respect to CSI-RS resource sets associated with resource configurations having a higher layer parameter resourceType configured to aperiodic, periodic, or semi-persistent, the trigger state of a CSI reporting configuration having reporType configured to aperiodic, and a resource configuration for channel or interference measurement on one or more component cells (CCs) may be configured by a higher layer parameter CSI-AperiodicTriggerStateList.

A UE may use a PUSCH for aperiodic CSI reporting, and may use a PUCCH for periodic CSI reporting. The UE may perform semi-persistent CSI reporting using a PUSCH when the reporting is triggered or activated by DCI, and using a PUCCH after the reporting is activated by a MAC CE. As described above, a CSI resource configuration may be also configured to aperiodic, periodic, and semi-persistent. A combination of a CSI reporting configuration and a CSI resource configuration may be supported based on Table 30 below.

TABLE 30

| CSI-RS Configuration | Periodic CSI Reporting | Semi-Persistent CSI Reporting | Aperiodic CSI Reporting |
|---|---|---|---|
| Periodic CSI-RS | No dynamic | For reporting on PUCCH, | Triggered by DCI; |
| | triggering/activation | the UE receives an | additionally, activation |
| | | activation command [10, TS | command [10, TS 38.321] |
| | | 38.321]; for reporting on | possible as defined in |
| | | PUSCH, the UE receives | Subclause 5.2.1.5.1. |
| | | triggering on DCI | |
| Semi-Persistent CSI-RS | Not Supported | For reporting on PUCCH, | Triggered by DCI; |
| | | the UE receives an | additionally, activation |
| | | activation command [10, TS | command [10, TS 38.321] |
| | | 38.321]; for reporting on | possible as defined in |
| | | PUSCH, the UE receives | Subclause 5.2.1.5.1. |
| | | triggering on DCI | |
| Aperiodic CSI-RS | Not Supported | Not Supported | Triggered by DCI; |
| | | | additionally, activation |
| | | | command [10, TS 38.321] |
| | | | possible as defined in |
| | | | Subclause 5.2.1.5.1. |

Aperiodic CSI reporting may be triggered by a CSI request field included in DCI format 0_1, corresponding to scheduling DCI of a PUSCH. A UE may monitor a PDCCH, obtain DCI format 0_1, and obtain scheduling information of a PUSCH and a CSI request indicator. A CSI request indicator may be configured to have NTS(=0, 1, 2, 3, 4, 5, or 6) number of bits, and may be determined by higher layer signaling (reportTriggerSize). One trigger state among one or more aperiodic CSI reporting trigger states which may be configured by higher layer signaling (CSI-AperiodicTriggerStateList) may be triggered by a CSI request indicator.

When all of the bits in a CSI request field are 0, the bit values may indicate CSI reporting is not requested.

If the number (M) of configured CST trigger states in a CSI-AperiodicTriggerStateList is larger than 2NTs-1, M CSI trigger states may be mapped to 2NTs-1 trigger states according to a pre-defined mapping relation, and one trigger state among the 2NTs-1 trigger states may be indicated by a CSI request field.

If the number (M) of configured CSI trigger states in a CSI-AperiodicTriggerStateLite is smaller than or equal to 2NTs-1, one of M CSI trigger states may be indicated by a CST request field.

Table 31 below shows a relation between a CSI request indicator and a CSI trigger state that can be indicated by a corresponding indicator.

TABLE 31

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

A UE may measure a CSI resource in a CSI trigger state triggered by a CSI request field, and then generate CSI (which includes at least one of CQI, PMI, CRI, SSBRI, LI, RI, and L1-RSRP described above). The UE may transmit obtained CSI by using a PUSCH scheduled by a corresponding DCI format 0_1. When one bit corresponding to a UL data indicator (UL-SCH indicator) in the DCI format 0_1 indicates 1, the UE may multiplex the obtained CSI with UL data (UL-SCH) by using a PUSCH resource scheduled by the DCI format 0_1, to transmit the multiplexed CSI and data. When one bit corresponding to a UL data indicator (UL-SCH indicator) in the DCI format 0_1 indicates 0, the UE may map only the CSI to a PUSCH resource scheduled by the DCI format 0_1, without UL data (UL-SCH), to transmit the CSI.

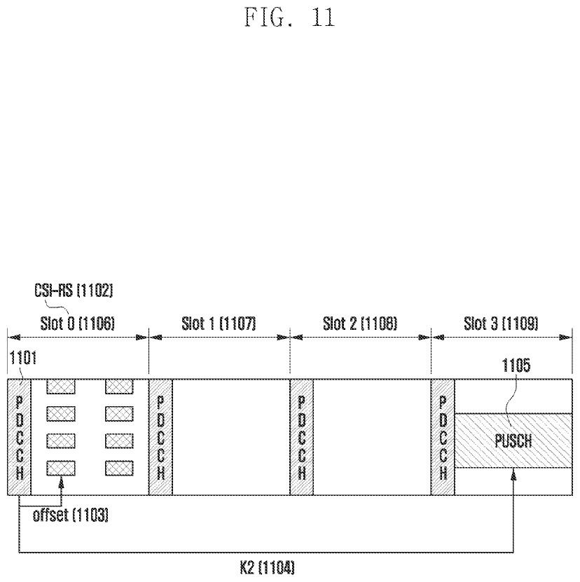

FIG. 11 illustrates an aperiodic CSI reporting method when a CSI-RS offset is 0 according to an embodiment.

In FIG. 11, a UE may obtain a DCI format 0_1 by monitoring a PDCCH 1101 and obtain scheduling information of a PUSCH 1105 and CSI request information from the DCI format 0_1. The UE may obtain resource information of a CSI-RS 1102 to be measured, from a received CSI request indicator. The UE may determine a time point at which the UE should measure a resource of the CSI-RS 1102 to be transmitted, based on a time point at which the DCI format 0_1 is received, and an offset-related parameter (the aperiodicTriggeringOffset described above) in a CSI resource set configuration (e.g., an NZP CSI-RS resource set configuration (NZP-CSI-RS-ResourceSet)). More particularly, the UE may receive an offset value X 1103 of the parameter aperiodicTriggeringOffset in an NZP-CSI-RS resource set configuration from a base station by higher layer signaling, and the configured offset value X may be an offset between a slot on which DCI triggering aperiodic CSI reporting is received, and a slot on which a CSI-RS resource is transmitted. For example, the value of the parameter aperiodicTriggeringOffset value and an offset value X 1103 may have a mapping relation therebetween as shown in Table 32 below.

TABLE 32

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

FIG. 11 illustrates an aperiodic CSI reporting method when a CSI-RS offset is 1 according to an embodiment. In FIG. 11, the above-described offset value X 1103 may be configured to be 0. In this case, a UE may receive a CSI-RS 1102 in slot (corresponding to slot 0 in FIG. 11) having received a DCI format 0_1 triggering aperiodic CSI reporting. In addition, the UE may report CSI information measured based on the received CSI-RS, through the PUSCH 1105 to the base station. The UE may obtain scheduling information of the PUSCH 1105 (information corresponding to each field of the above-described DCI format 0_1) for CSI reporting from the DCI format 0_1. For example, the UE may obtain information about a slot in which the PUSCH 1105 is to be transmitted, from time domain resource allocation information of the PUSCH 1105 included in the DCI format 0_1. In FIG. 11, the UE may obtain 3 as a K2 value 1104 corresponding to a slot offset value 1103 relating to PDCCH-to-PUSCH, and accordingly, the PUSCH 1105 is transmitted in slot 3 1109, which is spaced 3 slots apart from slot 0 1106, i.e., the time point at which the PDCCH 1101 was received.

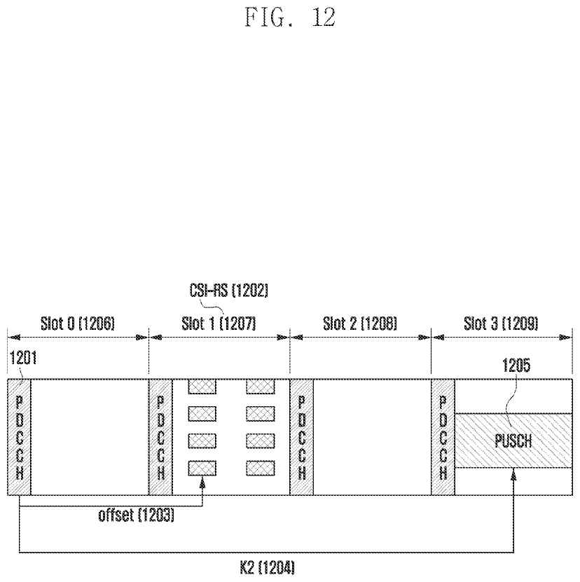

In FIG. 12, a UE may obtain a DCI format 0_1 by monitoring a PDCCH 1201 and obtain scheduling information of a PUSCH 1205 and CSI request information from the DCI format 0_1. The UE may obtain resource information of a CSI-RS 1202 to be measured, from a received CSI request indicator. In FIG. 12, the above-described offset value X 1203 relating to a CSI-RS is configured to be 1. In this case, a UE may receive a CSI-RS 1202 in a slot having received a DCI format 0_1 triggering aperiodic CSI reporting (corresponding slot 0 1206 in FIG. 12), and may report CSI information measured based on the received CSI-RS, through a PUSCH 1205 to the base station.

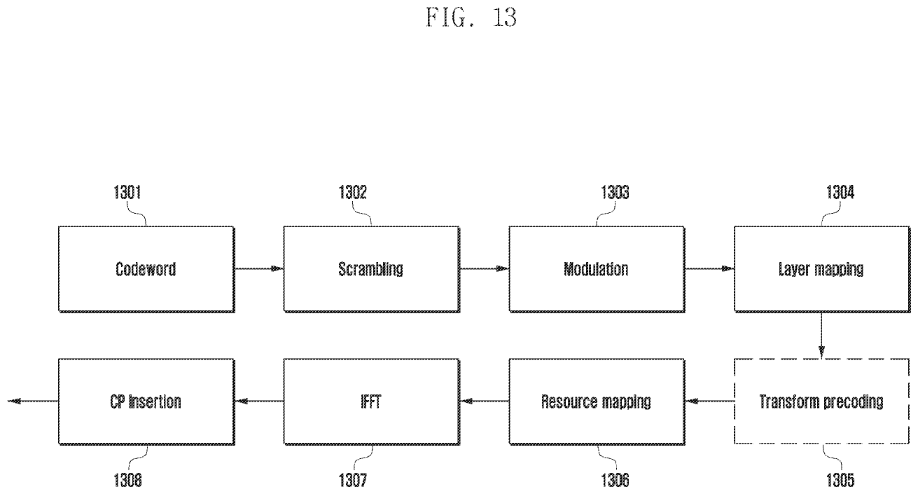

FIG. 13 illustrates a transmission block diagram for transmission signal generation in a 5G communication system according to an embodiment.

In FIG. 13, a transmitter generates a codeword 1301 and then performs scrambling 1302. The scrambled signal 1302 is modulated (1303) according to a modulation scheme such as QPSK or QAM and mapped to a layer (1304). Depending on whether the mapped signal is cyclic prefix orthogonal frequency division multiplexing (CP-OFDM) or discrete Fourier transform spread orthogonal frequency division multiplexing (DFT-S-OFDM), if the mapped signal is CP-OFDM, the signal is mapped to a resource immediately after CP-OFDM processing (1306), or if the mapped signal is DFT-S-OFDM, the signal undergoes transform precoding (1305) and then mapped to a resource (1306). In this case, in the DL, only CP-OFDM is considered, and in the UL, both CP-OFDM and DFT-S-OFDM are considered. In general, CP-OFDM has advantages over DFT-s-OFDM in an aspect, such as more flexible natural allocation and receiver complexity. In particular, the high MCS demodulation performance of CP-OFDM is better than that of DFT-s-OFDM in frequency selective channels. Therefore, CP-OFDM based waveforms may be more desirable to achieve high spectral efficiency.

Meanwhile, if a peak-to-average power ratio (PAPR) is low, high power amplifier efficiency can be expected, so low PAPR characteristics are an important factor to consider for a waveform. Because DFT-s-OFDM has a lower PAPR than that of CP-ODM, DFT-s-OFDM has an advantage over CP-OFDM in power-constrained situations. In other words, when the UE uses a low MCS in a power-constrained situation, DFT-s-OFDM can provide link performance gains. Therefore, DFT-s-OFDM may be more suitable in power-constrained scenarios.

In NR, CP-OFDM is used in the DL and CP-OFDM and DFT-s-OFDM are used in the UL for transmission and reception between the base station and the UE. Among these, UL coverage is the bottleneck, so it informs in advance which waveform to use through an RRC message. For example, as shown in Table 33 below, whether to apply transform precoding in PUSCH-Config, ConfiguredGrantConfig, Rach-ConfigCommon, and MsgA-PUSCH-Config is indicated to the UE through RRC.

TABLE 33

| | |
|---|---|
| PUSCH-Config ::= | SEQUENCE { |
| ... | |
| transformPrecoder | ENUMERATED {enabled, disabled} |
| ... | |
| } | |
| ConfiguredGrantConfig ::= | SEQUENCE { |
| ... | |
| transformPrecoder | ENUMERATED {enabled, disabled} |
| ... | |
| } | |
| RACH-ConfigCommon ::= | SEQUENCE { |
| ... | |
| msg3-transformPrecoder | ENUMERATED {enabled} |
| ...\| | |
| } | |
| MsgA-PUSCH-Config-r16 ::= | SEQUENCE { |
| ... | |
| msgA-TransformPrecoder-16 | ENUMERATED {enabled, |
| | disabled} |
| ... | |
| } | |

However, since the speed of instructing the UE whether to apply transform precoding through RRC is too slow compared to the speed at which the UE moves from a cell center to a border, or from the border to the cell center, there may be certain cases where the coverage of the UE is not satisfied. To solve this problem, a method is needed to indicate whether to apply transform precoding more dynamically than RRC.

The following discloses a method for dynamically instructing DFT-s-OFDM with low PAPR characteristics and CP-OFDM with high spectral efficiency for the UL of a cellular network, with respect to PUSCH, which is a bottleneck channel among uplink channels. Provided below is a method for instructing dynamic waveform switching for PUSCH and may also be applied to other channels (e.g., the PUCCH).

### First Embodiment

The first embodiment describes each operation of a method by which a base station dynamically instructs a UE to apply transform precoding.

In order to indicate application or non-application of transform precoding more dynamically than RRC, the following methods can be considered.

First, the base station may explicitly indicate whether to apply transform precoding through uplink scheduling DCI. In this case, new fields may be added to the existing uplink scheduling DCI format or existing fields may be reused. When a new field is added, it is possible to indicate whether to apply transform precoding through a field of at least 1 bit using an additional reserved bit in the existing uplink scheduling DCI format. When the existing field is reused in the UL scheduling DCI format, the field used for other purposes may be repurposed as a field to indicate whether to apply transform precoding or may be used to determine whether to apply transform precoding by creating an implicit rule for scheduling information.

Similar to DCI format 2_X, it is possible to indicate whether to apply transform precoding through DCI, not for scheduling purposes.

In addition to this, a method for indicating a dynamic waveform switching using MAC-CE rather than DCI may be used. In case of using a method for indicating based on the UL scheduling DCI, transform precoding may be applied to the scheduled PUSCH resources indicated by the DCI. However, since it is unclear at what point transform precoding should be applied for dynamic waveform switching indication based on DCI or MAC-CE that are not for scheduling purposes, an application delay time or application timing must be additionally indicated explicitly or implicitly.

Hereinafter, DCI is described for convenience, but the following description may also be applied to MAC-CE or other similar signaling.

The existing RRC-based semi-static waveform switching indication has up to two states for applying or not applying transform precoding. When indicating whether to apply transform precoding using the dynamic waveform indication method, a total of four states exist as shown in Table 34 below.

TABLE 34

Semi-static

| | Transform | Transform |
|---|---|---|
| | precoding | precoding |
| Dynamic | disabled | enabled |
| Transform precoding NOT indicated | Case A1 | Case B1 |
| Transform precoding indicated | Case A2 | Case B2 |

Table 34 refers to when RRC and dynamic waveform indication indicate that transform precoding is not applied (Case A1). In this case, the UE determines that transform precoding is not applied and transmits a UL signal on the scheduled PUSCH using CP-OFDM.

The following refers to when the RRC and dynamic waveform indication indicates the application of transform precoding (Case B2). In this case, the UE determines that transform precoding is applied and transmits a UL signal on the scheduled PUSCH using DFT-s-OFDM.

The following refers to when RRC and dynamic waveform indications provide different indications when RRC indicates not to apply transform precoding, but the dynamic waveform indication indicates to apply transform precoding (Case A2), and when RRC indicates to apply transform precoding, but the dynamic waveform indication indicates not to apply transform precoding (Case B1). In both cases, the dynamic waveform indication may be applied with priority because the dynamic waveform indication corresponds to the latest situation compared to the RRC (for example, Case A2 indicates to apply transform precoding by the dynamic waveform indication, so PUSCH is transmitted using DFT-s-OFDM, and Case B1 indicates not to apply transform precoding by the dynamic waveform indication, so PUSCH is transmitted using CP-OFDM).

The base station may configure information about DCI-based dynamic waveform indication to the UE through RRC, and the UE may identify the corresponding DCI. For example, in the existing operation, whether to apply transform precoding is indicated to the UE by RRC in PUSCH-Config, ConfiguredGrantConfig, Rach-ConfigCommon, and MsgA-PUSCH-Config, as shown in Table 33. When the signal to interference and noise ratio (SINR) of the UE is unstable and dynamic coverage response is required, the base station may transmit a DCI-based dynamic waveform indication to the UE. In the case of UL scheduling DCI, the UE may identify the DCI and operates according to the dynamic waveform indication. If it is indicated whether to apply transform precoding through DCI, which is not for scheduling purposes, such as DCI format 2_X, additional signaling is required to indicate the UE to additionally monitor DCI format 2_X. Therefore, if an additional state for transform precoding is configured through RRC as shown in Table 35 below, the UE may recognize the additional state in advance and monitor the corresponding DCI to determine whether to apply transform precoding.

TABLE 35

| | |
|---|---|
| PUSCH-Config::= | SEQUENCE { |
| ... | |
| transformPrecoder | ENUMERATED {enabled, disabled, |
| | both} |
| ... | |
| } | |
| ConfiguredGrantConfig ::= | SEQUENCE { |
| ... | |
| transformPrecoder | ENUMERATED {enabled, disabled, |
| | both} |
| ... | |
| } | |
| RACH-ConfigCommon ::= | SEQUENCE { |
| ... | |
| msg3-transformPrecoder | ENUMERATED {enabled} |
| ... | |
| } | |
| MsgA-PUSCH-Config-r16 ::= | SEQUENCE { |
| ... | |
| msgA-TransformPrecoder-r16 | ENUMERATED {enabled, |
| | disabled, |
| both} | |
| ... | |
| } | |

Therefore, if transform precoding is enabled or disabled, the UE determines whether to apply transform precoding based on RRC according to the existing operation. If transform precoding is in both states, the UE may monitor the corresponding DCI and determine whether to apply final transform precoding.

It is apparent that the RRC message does not include information for dynamic waveform indication, and the UE may determine whether to apply transform precoding after monitoring the corresponding DCI.

The operation of the UE applying transform precoding in the existing PUSCH is determined differently depending on the random access, dynamic grant, and configured grant and scrambled RNTI shown in Tables 33 and 35. This can be divided into three types as follows.
Type 1: RAR UL grant, fallback RAR UL grant, DCI format 0_0 with TC-RNTI
Type 2: CS-RNTI with NDI=1, C-RNTI, or MCS-C-RNTI or SP-CSI-RNTI
Type 3: Configured grant

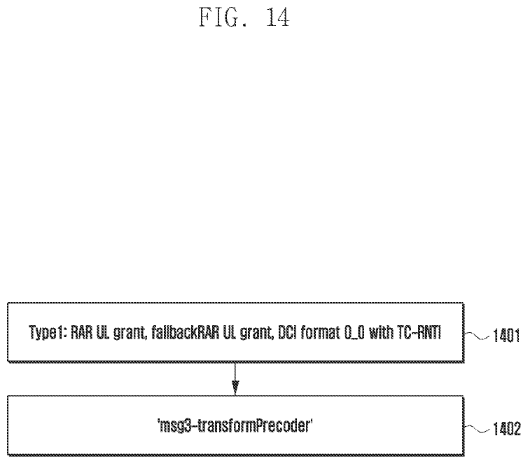

FIG. 14 illustrates a UE operation procedure related to Type 1 transform precoding determination according to an embodiment.

When PUSCH Type is Type 1 (1401), a waveform to be used is determined based on msg3-transformPrecoder or msgA-transformPrecoder (1402) in the RRC.

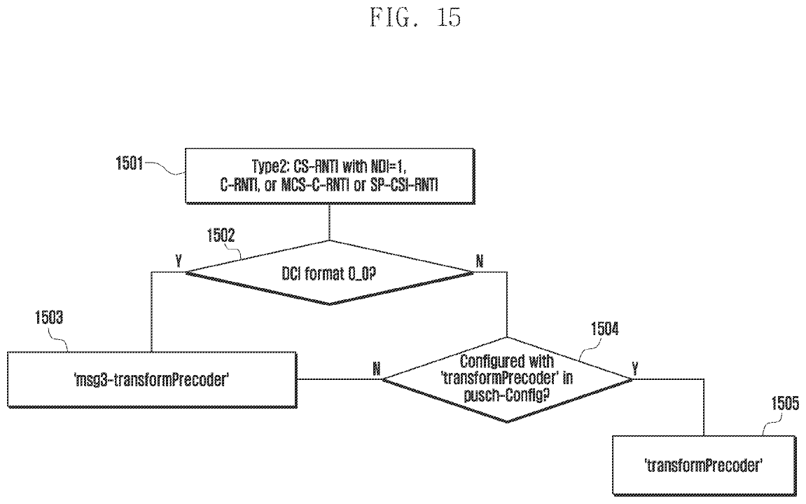

FIG. 15 illustrates a UE operation procedure related to Type 2 transform precoding determination according to an embodiment.

When PUSCH Type is Type 2 in step 1501, transform precoding is determined depending on whether the DCI format is 0_0 in step 1502. When the DCI format is 0_0 in step 1502, as in Type 1, the Type 2 waveform is determined according to msg3-transformPrecoder in step 1503 or msgA-transformPrecoder. When the DCI format is not 0_0 in step 1502, the waveform depends on whether transformPrecoder is configured in PUSCH-Config in step 1504. When transformPrecoder is not configured in PUSCH-Config in step 1504, the Type 2 waveform is determined according to msg3-transformPrecoder in step 1503 or msgA-transformPrecoder. When transformPrecoder is configured, whether to apply transform precoding is determined according to the corresponding configuration in step 1505).

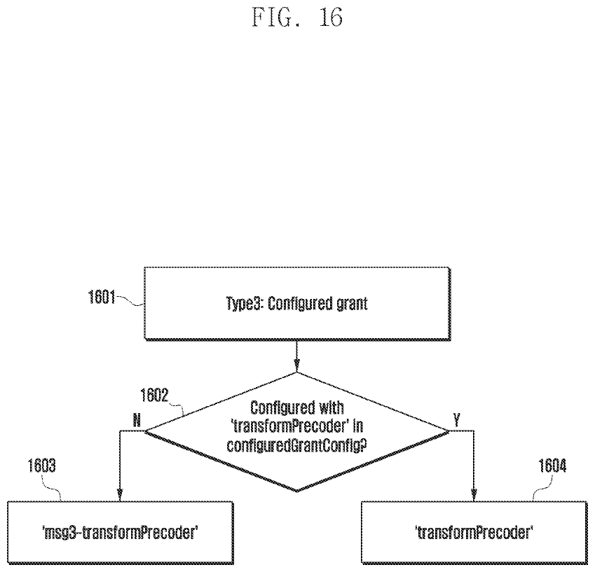

FIG. 16 illustrates a UE operation procedure related to Type 3 transform precoding determination according to an embodiment.

When PUSCH Type is Type 3 in step 1601, transform precoding is determined depending on whether transformPrecoder is configured in configuredGrantConfig.

If transformPrecoder is not configured in step 1602, the Type 3 waveform is determined according to msg3-transformPrecoder in step 1603 or msgA-transformPrecoder. When transformPrecoder is configured in step 1602, whether to apply transform precoding is determined according to the corresponding configuration in step 1604.

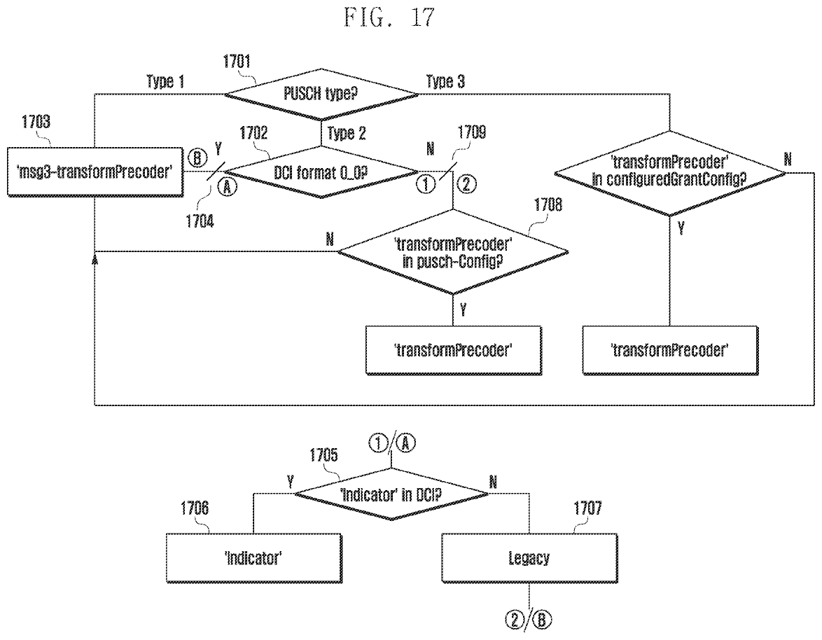

FIG. 17 illustrates whether to apply transform precoding according to three PUSCH types affected by transform precoding according to an embodiment.

The existing operation regarding whether to apply transform precoding to a UE for each type is the same as in FIGS. 14 to 16. Type 1 is a PUSCH type related to random access, so it is inefficient to dynamically determine to apply transform precoding. Type 3 is a configured grant, so the configuration once applied is not easily changed to prevent repetitive PUSCH resource allocation. Thus, similarly dynamic waveform indication may be inefficient. However, in Type 2, PUSCH resources are allocated by DCI, so dynamic waveform indication is the most efficient among the three types.

In FIG. 17, when a DCI format is 0_0 in step 1702, the Type 2 waveform is determined according to msg3-transformPrecoder in step 1703 or msgA-transformPrecoder. If a dynamic waveform indication is indicated by the DCI at 1704, then in step 1705, the UE determines a waveform according to the information indicated in the DCI in step 1706. When the DCI does not include a dynamic waveform indication, the existing legacy operation is performed in step 1707. That is, in case of performing the existing operation, Type 2 waveform is determined according to msg3-transformPrecoder in step 1703 or msgA-transformPrecoder. However, since DCI format 0_0 in step 1702 operates in a fallback mode, the fields within the DCI are expected to remain as they are, so a dynamic waveform will be implicitly indicated.

When the DCI format is not 0_0 in step 1702, the waveform depends on whether transformPrecoder is configured in PUSCH-Config in step 1708. If a dynamic waveform indication is indicated by the DCI at 1709, then in step 1705, the UE determines the waveform according to the information indicated in the DCI in step 1706, and when the dynamic waveform indication is not included by the DCI, the existing operation in step 1707 may be performed. That is, when the dynamic waveform indication is not included by the DCI, the waveform to be applied to Type 2 is determined according to the determination result in 1708. Unlike DCI format 0_0 in step 1702, in DCI format 0_1 or 0_2, additional fields for dynamic waveform indication may be defined within fields within the DCI, so dynamic waveforms may be indicated explicitly or implicitly.

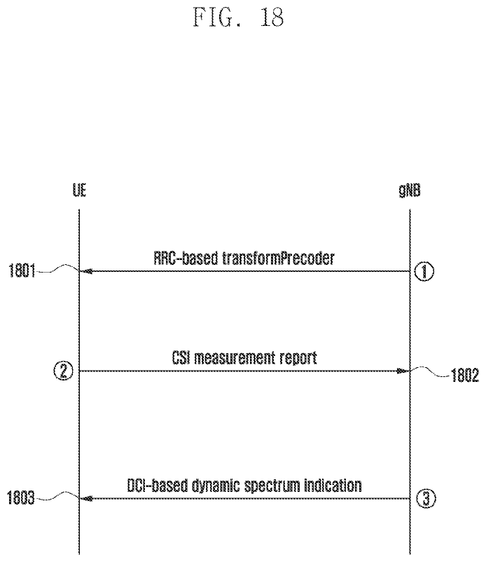

FIG. 18 illustrates a method of DCI-based signaling from a base station to a UE for dynamic waveform indication according to an embodiment.

In FIG. 18, a base station may instruct a UE a waveform to be used through transformPrecoder based on RRC as before in step 1801. The UE may periodically transmit the measured channel state to the base station in step 1802. For example, the UE may transmit the channel state while moving from a cell center to a border, or from the border to the cell center. In this case, if it is determined that coverage problems are expected and that waveform should be indicated dynamically to the UE, the base station may allow the UE to determine the waveform for uplink transmission through DCI-based dynamic waveform indication in step 1803.

### Second Embodiment

The second embodiment describes ambiguities in the number of bits of fields or associated tables affected by dynamic waveform indication in a DCI format and describes a solution to eliminate these ambiguities.

The following example assumes that DCI format 0_0 has no additional field for dynamic waveform indication due to a fallback mode, and DCI format 0_1 and 0_2 are situations where dynamic waveform indication explicitly exists. In this case, when a UE decodes DCI, the DCI size may be ambiguous or the associated table may not be interpreted properly depending on the dynamic waveform indication due to the additional bits related to the dynamic waveform indication.

In a current DCI format 0_1/0_2, information related to transform precoding may be expressed with multiple bits, such as whether to apply transform precoding, as follows.
Precoding information and number of layers: 0, . . . , 6 bits
Second precoding information: 0, . . . , 5 bits
Antenna ports: 2, . . . , 5 bits
PTRS-DMRS association: 0, 2 bits
DMRS sequence initialization: 0 (transform precoder enabled), 1 (transform precoder disabled) bit
Among these, for example, DCI-related ambiguity for antenna ports will be described. As shown in Table 36 below, the DCI-related ambiguity for antenna ports may be divided into a total of 8 cases depending on whether to apply transform precoding, DMRS type and length, and whether π/2 BPSK modulation scheme is used.

TABLE 36

| | | Conditions | | |
|---|---|---|---|---|
| | | transform | | dmrs-UplinkTransformPrecoding |
| Case | The number of bits for | precoder = | (dmrs-Type, | and tp-pi2BPSK are both configured, |
| # | antenna ports | enabled/disabled | maxLength) | π/2 BPSK modulation is used? |
| 1 | 2 bits as defined by Tables | enabled | (1, 1) | Exception |
| | 7.3.1.1.2-6 | | | |
| 2 | 2 bits as defined by Tables | enabled | (1, 1) | Yes |
| | 7.3.1.1.2-6A | | | |
| 3 | 4 bits as defined by Tables | enabled | (1, 2) | Exception |
| | 7.3.1.1.2-7 | | | |
| 4 | 4 bits as defined by Tables | enabled | (1, 2) | Yes |
| | 7.3.1.1.2-7A | | | |
| 5 | 3 bits as defined by Tables | disabled | (1, 1) | — |
| | 7.3.1.1.2-8/9/10/11 | | | |
| | (rank = 1, 2, 3, 4) | | | |
| 6 | 4 bits as defined by Tables | disabled | (1, 2) | — |
| | 7.3.1.1.2-12/13/14/15 | | | |
| | (rank = 1, 2, 3, 4) | | | |
| 7 | 4 bits as defined by Tables | disabled | (2, 1) | — |
| | 7.3.1.1.2-16/17/18/19 | | | |
| | (rank = 1, 2, 3, 4) | | | |
| 8 | 5 bits as defined by Tables | disabled | (2, 2) | — |
| | 7.3.1.1.2-20/21/22/23 | | | |
| | (rank = 1, 2, 3, 4) | | | |

Among these, as shown in Table 36, cases where (dmrs-Type, maxLength) are the same may be grouped, there may be {1,2,5}, {3,4,6}, and {7} or {8} cases. Among the cases, in the case of {7} or {8}, there is only one type of (dmrs-Type, maxLength), so there is no ambiguity. On the other hand, in the case of {1,2,5} or {3,4,6}, multiple cases occur, so there is ambiguity about the DCI size or which table should be identified.

In the case of {3,4,6}, the number of bits for the antenna port is the same, 4 bits, regardless of transform precoding. Therefore, even if there are additional bits for dynamic waveform indication, the total number of bits for the antenna port is 4 bits, and thus, only {3,4,6} is applicable if the number of bits and the conditions of (dmrs-Type, maxLength) are met. Therefore, a method is needed to determine which table among case of {3, 4, 6} is identified. As described previously, the final waveform is determined according to the dynamic waveform indication, so the UE may identify each table according to whether to apply transform precoding by dividing the cases into {3,4} and {6}. In the case of {3,4} where transform precoding is applied, a table to be used may be determined depending on whether the π/2 BPSK modulation scheme is used.

In the case of {1,2,5}, unlike the case of {3,4,6}, the number of bits is different depending on whether to apply RRC-based transform precoding. As the dynamic waveform indication is transmitted through DCI, the UE does not know a bit to be used according to the final waveform until the UE identifies the DCI. Thus, the UE may determine the number of bits for the antenna port with max (the number of bits when transform precoder=enabled, the number of bits when transform precoder=disabled). That is, the UE assumes that the number of bits for the antenna port is 3 bits and decoding is performed and may use all three tables with {tables when transform precoder=enabled}∪{tables when transform precoder=disabled} regardless of whether to apply RRC-based transform precoding. However, it may be classified into whether {1,2} is applied or whether {5} is applied depending on whether to apply transform precoding indicated by the dynamic waveform indication. In the case of {1,2} where transform precoding is applied, a table to be used may be determined depending on whether π/2 BPSK modulation scheme is used.

Each table included in Table 36 and referenced to determine the number of bits for the antenna port may be determined according to the number of DMRS ports and DMRS CDM groups in Table 37 below.

TABLE 37
Table 7.3.1.1.2-6: Antenna port(s), transform precoder is
enabled, dmrs-Type = 1, maxLength = 1, except that
dmrs-UplinkTransformPrecoding and tp-pi2BPSK are
both configured and π/2-BPSK modulation is used

| | Number of DMRS CDM | DMRS |
|---|---|---|
| Value | group(s) without data | port(s) |
| 0 | 2 | 0 |
| 1 | 2 | 1 |
| 2 | 2 | 2 |
| 3 | 2 | 3 |

Table 7.3.1.1.2-6A: Antenna port(s), transform precoder is enabled,
dmrs-UplinkTransformPrecoding and tp-pi2BPSK are both configured,
π/2-BPSK modulation is used, dmrs-Type = 1, maxLength = 1

| | Number of DMRS CDM | DMRS |
|---|---|---|
| Value | group(s) without data | port(s) |
| 0 | 2 | 0, n_{SCID} = 0 |
| 1 | 2 | 0, n_{SCID} = 1 |
| 2 | 2 | 2, n_{SCID} = 0 |
| 3 | 2 | 2, n_{SCID} = 1 |

Table 7.3.1.1.2-7: Antenna port(s), transform precoder is
enabled, dmrs-Type = 1, maxLength = 2, except that
dmrs-UplinkTransformPrecoding and tp-pi2BPSK are
both configured and π/2-BPSK modulation is used

| | Number of DMRS | | Number of |
|---|---|---|---|
| | CDM group(s) | DMRS | front-load |
| Value | without data | port(s) | symbols |
| 0 | 2 | 0 | 1 |
| 1 | 2 | 1 | 1 |
| 2 | 2 | 2 | 1 |
| 3 | 2 | 3 | 1 |
| 4 | 2 | 0 | 2 |
| 5 | 2 | 1 | 2 |
| 6 | 2 | 2 | 2 |
| 7 | 2 | 3 | 2 |
| 8 | 2 | 4 | 2 |
| 9 | 2 | 5 | 2 |
| 10 | 2 | 6 | 2 |
| 11 | 2 | 7 | 2 |
| 12-15 | Reserved | Reserved | Reserved |

Table 7.3.1.1.2-7A: Antenna port(s), transform precoder is enabled,
dmrs-UplinkTransformPrecoding and tp-pi2BPSK are both configured,
π/2-BPSK modulation is used, dmrs-Type = 1, maxLength = 2

| | Number of DMRS | | Number of |
|---|---|---|---|
| | CDM group(s) | DMRS | front-load |
| Value | without data | port(s) | symbols |
| 0 | 2 | 0, n_{SCID} = 0 | 1 |
| 1 | 2 | 0, n_{SCID} = 1 | 1 |
| 2 | 2 | 2, n_{SCID} = 0 | 1 |
| 3 | 2 | 2, n_{SCID} = 1 | 1 |
| 4 | 2 | 0, n_{SCID} = 0 | 2 |
| 5 | 2 | 0, n_{SCID} = 1 | 2 |
| 6 | 2 | 2, n_{SCID} = 0 | 2 |
| 7 | 2 | 2, n_{SCID} = 1 | 2 |
| 8 | 2 | 4, n_{SCID} = 0 | 2 |
| 9 | 2 | 4, n_{SCID} = 1 | 2 |
| 10 | 2 | 6, n_{SCID} = 0 | 2 |
| 11 | 2 | 6, n_{SCID} = 1 | 2 |
| 12-15 | Reserved | Reserved | Reserved |

Table 7.3.1.1.2-8: Antenna port(s), transform precoder
is disabled, dmrs-Type = 1, maxLength = 1, rank = 1

| | Number of DMRS CDM | DMRS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Table 7.3.1.1.2-9: Antenna port(s), transform precoder
is disabled, dmrs-Type = 1, maxLength = 1, rank = 2

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

Table 7.3.1.1.2-10: Antenna port(s), transform precoder
is disabled, dmrs-Type = 1, maxLength = 1, rank = 3

| | Number of DMRS CDM | DMRS |
|---|---|---|
| Value | group(s) without data | port(s) |
| 0 | 2 | 0-2 |
| 1-7 | Reserved | Reserved |

Table 7.3.1.1.2-11: Antenna port(s), transform precoder
is disabled, dmrs-Type = 1, maxLength = 1, rank = 4

| | Number of DMRS CDM | DMRS |
|---|---|---|
| Value | group(s) without data | port(s) |
| 0 | 2 | 0-3 |
| 1-7 | Reserved | Reserved |

Table 7.3.1.1.2-12: Antenna port(s), transform precoder
is disabled, dmrs-Type = 1, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Table 7.3.1.1.2-13: Antenna port(s), transform precoder
is disabled, dmrs-Type = 1, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Table 7.3.1.1.2-14: Antenna port(s), transform precoder
is disabled, dmrs-Type = 1, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

Table 7.3.1.1.2-15: Antenna port(s), transform precoder
is disabled, dmrs-Type = 1, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

Table 7.3.1.1.2-16: Antenna port(s), transform precoder
is disabled, dmrs-Type = 2, maxLength = 1, rank = 1

| | Number of DMRS CDM | DMRS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

Table 7.3.1.1.2-17: Antenna port(s), transform precoder
is disabled, dmrs-Type = 2, maxLength = 1, rank = 2

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

Table 7.3.1.1.2-18: Antenna port(s), transform precoder
is disabled, dmrs-Type = 2, maxLength = 1, rank = 3

| | Number of DMRS CDM | DMRS |
|---|---|---|
| Value | group(s) without data | port(s) |
| 0 | 2 | 0-2 |
| 1 | 3 | 0-2 |
| 2 | 3 | 3-5 |
| 3-15 | Reserved | Reserved |

Table 7.3.1.1.2-19: Antenna port(s), transform precoder
is disabled, dmrs-Type = 2, maxLength = 1, rank = 4

| | Number of DMRS CDM | DMRS |
|---|---|---|
| Value | group(s) without data | port(s) |
| 0 | 2 | 0-3 |
| 1 | 3 | 0-3 |
| 2-15 | Reserved | Reserved |

Table 7.3.1.1.2-20: Antenna port(s), transform precoder
is disabled, dmrs-Type = 2, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

Table 7.3.1.1.2-21: Antenna port(s), transform precoder
is disabled, dmrs-Type = 2, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

Table 7.3.1.1.2-22: Antenna port(s), transform precoder
is disabled, dmrs-Type = 2, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5 , 10 | 2 |
| 6-31 | Reserved | Reserved | Reserved |

Table 7.3.1.1.2-23: Antenna port(s), transform precoder
is disabled, dmrs-Type = 2, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

Table 37 describes antenna ports, and may be similarly applied for precoding information and number of layers, second precoding information, PTRS-DMRS association, DMRS sequence initialization, etc.

For frequency domain resource allocation (FDRA), there are two resource allocation types: 0 and 1. In the case of RA type 0, frequency domain resource allocation may be expressed as a bitmap RBG units.

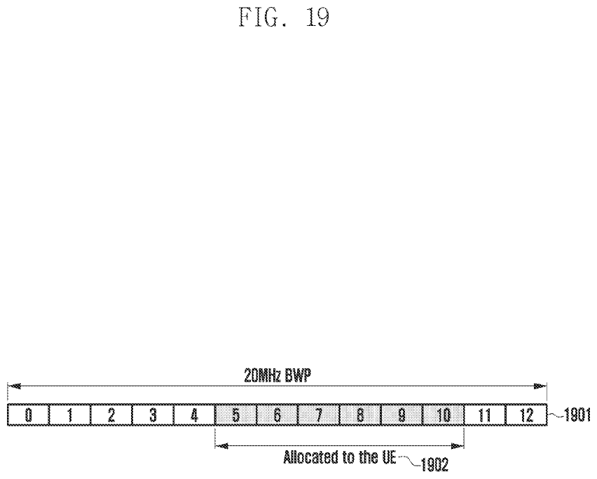

FIG. 19 illustrates resource allocation type 0 of FDRA according to an embodiment.

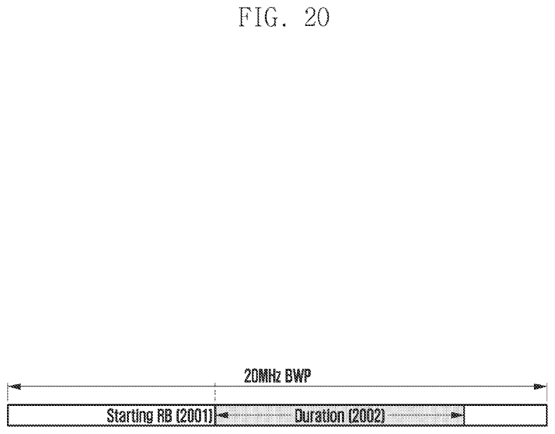

In FIG. 19, assuming that BWP is 20 MHz BWP and carrier spacing is 30 kHz, a total of 51 RBs are required. Here, assuming that the size of one RBG is P=4, there are a total of N_{RBG=}13 RBGs (1901). Assuming that resources have been allocated to RBGs 5 to 10 in the ith BWP for the corresponding UE (1902), the starting RB of the BWP is N_{BWP,i}^{start}=5 and N_{BWP,i}^{size}=6. The base station uses RA type 0 to transmit a bitmap consisting of 13 bits of 0000011111100 to the UE. FIG. 20 illustrates resource allocation type 1 of FDRA according to an embodiment.

As illustrated in FIG. 20, in the case of RA type 1, rather than transmitting the bitmap of the entire RBG unit, an allocated RB starting point 2001 and a resource allocation section 2002 of N_{RB}^{UL,BWP} may be configured. The resource allocation section 2002 may be allocated until the end of the BWP, so the maximum number of bits required to configure the RB starting point 2001 and the resource allocation section 2002 is 11 bits.

For the above two RA types, CP-OFDM may be used in both RA types 0 and 1, and DFT-s-OFDM may only be used in RA type 1. That is, RA type 0 may be configured only for when transform precoding is not applied, and RA type 1 may be configured regardless of whether transform precoding is applied.

If the dynamic waveform indication is used, only RA type 1 may be used. In this case, scheduling flexibility may be reduced.

Alternatively, the dynamic waveform indication may be used to dynamically indicate RA type 0 to 1 or RA type 1 to 0. Therefore, a problem arises as to what reference should be used to determine the number of FDRA bits. A solution to this is described with reference to Table 38 below.

TABLE 38

| Resource | The number of bits | |
|---|---|---|
| allocation | (section 7.3.1.1.2 of TS38.212) | Note |
| RA type 0 | N_{RBG} | The total number of RBGs (N_{RBG}) for a |
| | | uplink bandwidth part i of size |
| | | N_{BWP, i}^{size}, PRBs is given by N_{RBG} = |
| | | ┌(N_{BWP, i}^{size} + (N_{BWP, i}^{start} mod P))/P┐ |
| RA type 1 | ┌log₂(N_{RB}^{UL, BWP}(N_{RB}^{UL, BWP} + 1))/2┐ | |
| resourceAllocation = | max(log₂(N_{RB}^{UL, BWP}(N_{RB}^{UL, BWP} + 1))/ | If resourceAllocation = ‘dynamicSwitch’, |
| dynamicSwitch | 2, N_{RBG}) + 1 | the MSB bit is used to indicate resource |
| | | allocation type 0 or resource allocation |
| | | type 1 |

With reference to Table 38, if the RA type is not configured to either RA Type 0 or RA Type 1 by RRC configuration, and resourceAllocation=dynamicSwitch is configured, the dynamic waveform indication is configured and the 1 bit of MSB for the RA type to be used and the maximum number of bits required for RA type 0 and RA type 1 becomes the number of bits for

FDRA. Similarly, for DCI-based dynamic waveform indication, the maximum number of bits required for RA Type 0 and RA Type 1 may be applied as the number of bits for FDRA. That is, in the case of DCI-based dynamic waveform indication, the number of bits required for FDRA may be max(log₂(N_{RB}^{UL,BWP}(N_{RB}^{UL,BWP}+1))/2,N_{RBG}) bits In this process, an additional 1 bit of MSB is unnecessary since the dynamic waveform indication will be indicated implicitly or explicitly using an additional field in the DCI.

### Third Embodiment

The third embodiment describes ambiguity in determining a modulation scheme and a code rate due to dynamic waveform indication and discloses a method to solve this ambiguity.

Table 39 below lists several cases for determining whether to apply transform precoding in an NR and a MCS table for each DCI format and each RNTI.

TABLE 39

| | RRC: | | | |
|---|---|---|---|---|
| | transform | | PUSCH scheduled by a PDCCH | |
| Case | precoding | MCS table configuration | with . . . | Table |
| 1-D | disabled | mcs-TableDCI-0-2 (pusch-Config) = | DCI format 0_2 with C-RNTI or | Table 5.1.3.1-2 |
| | | ‘qam256’ | SP-CSI-RNTI | |
| 2-D | disabled | not configured with MCS-C-RNTI, | DCI format 0_2 with C-RNTI or | Table 5.1.3.1-3 |
| | | mcs-TableDCI-0-2 (pusch-Config) = | SP-CSI-RNTI | |
| | | ‘qam64LowSE’ | | |
| 3-D | disabled | mcs-Table (pusch-Config) = | DCI format 0_1 with C-RNTI or | Table 5.1.3.1-2 |
| | | ‘qam256’ | SP-CSI-RNTI | |
| 4-D | disabled | not configured with MCS-C-RNTI, | a DCI format other than DCI | Table 5.1.3.1-3 |
| | | mcs-Table (pusch-Config) = | format 0_2 in a USSS with C-RNTI | |
| | | ‘qam64LowSE’ | or SP-CSI-RNTI | |
| 5-D | disabled | configured with MCS-C-RNTI | MCS-C-RNTI | Table 5.1.3.1-3 |
| 6-D | disabled | mcs-Table (configuredGrantConfig) = | CS-RNTI or if PUSCH is | Table 5.1.3.1-2 |
| | | ‘qam256’ | transmitted with configured | |
| | | | grant | |
| 7-D | disabled | mcs-Table (configuredGrantConfig) = | CS-RNTI or if PUSCH is | Table 5.1.3.1-3 |
| | | ‘qam64LowSE’ | transmitted with configured | |
| | | | grant | |
| 8-D | disabled | for a MsgA PUSCH transmission | | Table 5.1.3.1-1 |
| 9-D | disabled | UE requests repetition of PUSCH | | Table 6.1.4.1-3, |
| | | scheduled by RAR UL grant, when | | Table 5.1.3.1-1 |
| | | transmitting PUSCH scheduled by | | |
| | | RAR UL grant | | |
| 10-D | disabled | UE requests repetition of PUSCH | | Table 6.1.4.1-4, |
| | | scheduled by RAR UL grant, when | | Table 5.1.3.1-1 |
| | | transmitting PUSCH scheduled by | | |
| | | DCI format 0_0 with CRC scrambled | | |
| | | by the TC-RNTI | | |
| 11-D | disabled | else | | Table 5.1.3.1-1 |
| 1-E | enabled | mcs-TableTransformPrecoderDCI-0-2 | DCI format 0_2 with C-RNTI or | Table 5.1.3.1.-2 |
| | | (pusch-Config) = ‘qam256’ | SP-CSI-RNTI | |
| 2-E | enabled | not configured with MCS-C-RNTI, | DCI format 0_2 with C-RNTI or | Table 6.1.4.1-2 |
| | | mcs-TableTransformPrecoderDCI-0-2 | SP-CSI-RNTI | |
| | | (pusch-Config) = ‘qam64LowSE’ | | |
| 3-E | enabled | mcs-TableTransformPrecoder | DCI format 0_1 with C-RNTI or | Table 5.1.3.1.-2 |
| | | (pusch-Config) = ‘qam256’ | SP-CSI-RNTI | |
| 4-E | enabled | not configured with MCS-C-RNTI, | a DCI format other than DCI | Table 6.1.4.1-2 |
| | | mcs-TableTransformPrecoder | format 0_2 in a USSS with C-RNTI | |
| | | (pusch-Config) = ‘gam64LowSE’ | or SP-CSI-RNTI | |
| 5-E | enabled | configured with MCS-C-RNTI | MCS-C-RNTI | Table 6.1.4.1-2 |
| 6-E | enabled | mcs-TableTransformPrecoder | CS-RNTI or if PUSCH is | Table 5.1.3.1-2 |
| | | (configuredGrantConfig) = ‘qam256’ | transmitted with configured | |
| | | | grant | |
| 7-E | enabled | mcs-Table TransformPrecoder | CS-RNTI or if PUSCH is | Table 6.1.4.1-2 |
| | | (configuredGrantConfig) = | transmitted with configured | |
| | | ‘qam64LowSE’ | grant | |
| 8-E | enabled | for a MsgA PUSCH transmission | (UE shall use q = 2) | Table 6.1.4.1-1 |
| 9-E | enabled | UE requests repetition of PUSCH | | Table 6.1.4.1-3, |
| | | scheduled by RAR UL grant, when | | Table 6.1.4.1-1 |
| | | transmitting PUSCH scheduled by | | |
| | | RAR UL grant | | |
| 10-E | enabled | UE requests repetition of PUSCH | | Table 6.1.4.1-4, |
| | | scheduled by RAR UL grant, when | | Table 6.1.4.1-1 |
| | | transmitting PUSCH scheduled by | | |
| | | DCI format 0_0 with CRC scrambled | | |
| | | by the TC-RNTI | | |
| 11-6 | enabled | else | | Table 6.1.4.1-1 |

There could be 11 cases depending on whether to apply transform precoding in the second column, and the cases can be classified into case number-D and case number-E, respectively. Each MCS table is determined according to Type 0 (random access), Type 1 (dynamic grant), and Type 2 (configured grant), which are described in the first embodiment, and the MCS table configuration determined according to the modulation scheme and the DCI format scrambled with a specific RNTI present in the PDCCH scheduling the PUSCH. Since each case number in case number-D and case number-E is a pair, a MCS table to be used in the case number may be determined based on whether to apply transform precoding.

An example of this is shown in Table 40 below.

TABLE 40
transformPrecoder = disabled
2-D, 4-D, 5-D, 7-D
Table [symbol] : MCS index table [symbol] for PDSCH

| MCS | Modulation | Target code Rate | Spectral |
|---|---|---|---|
| index [symbol] | Order [symbol] | R × [1024] | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |
| 28 | [symbol] | [symbol] | [symbol] |

| | | |
|---|---|---|
| 29 | [symbol] | reserved |
| 30 | [symbol] | reserved |
| 31 | [symbol] | reserved |

transformPrecoder = enabled
2-E, 4-E, 5-E, 7-E
Table [symbol] : MCS index table [symbol] for
PUSCH with transform precoding and 64QAM

| MCS | Modulation | Target code Rate | Spectral |
|---|---|---|---|
| index [symbol] | Order [symbol] | R × 1024 | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |

| | | |
|---|---|---|
| 28 | [symbol] | reserved |
| 29 | [symbol] | reserved |
| 30 | [symbol] | reserved |
| 31 | [symbol] | reserved |

8-D, 9-D, 10-D, 11-D
Table [symbol] : MCS index table [symbol] for PDSCH

| MCS | Modulation | Target code Rate | Spectral |
|---|---|---|---|
| index [symbol] | Order [symbol] | R × [1024] | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |
| 28 | [symbol] | [symbol] | [symbol] |

| | | |
|---|---|---|
| 29 | [symbol] | reserved |
| 30 | [symbol] | reserved |
| 31 | [symbol] | reserved |

8-E, 9-E, 10-E, 11-E
Table [symbol] : MCS index table [symbol] for
PUSCH with transform precoding and 64QAM

| MCS | Modulation | Target code Rate | Spectral |
|---|---|---|---|
| index [symbol] | Order [symbol] | R × 1024 | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |

| | | |
|---|---|---|
| 28 | [symbol] | reserved |
| 29 | [symbol] | reserved |
| 30 | [symbol] | reserved |
| 31 | [symbol] | reserved |

1-D, 3-D, 6-D, 1-E, 3-E, 6-E
Table 5.1.3.1-2: MCS index table 2 for PDSCH

| MCS | Modulation | Target code Rate | Spectral |
|---|---|---|---|
| index [symbol] | Order [symbol] | R × [1024] | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |

| | | |
|---|---|---|
| 28 | [symbol] | reserved |
| 29 | [symbol] | reserved |
| 30 | [symbol] | reserved |
| 31 | [symbol] | reserved |

9-D, 9-E
Table 6.1.4.1-1: MCS index table for
PUSCH with transform precoding and 64QAM

| MCS | Modulation | Target code Rate | Spectral |
|---|---|---|---|
| index [symbol] | Order [symbol] | R × 1024 | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |

| | | |
|---|---|---|
| 28 | [symbol] | reserved |
| 29 | [symbol] | reserved |
| 30 | [symbol] | reserved |
| 31 | [symbol] | reserved |

10-D, 10-E
Table 6.1.4.1-2: MCS index table 2 for
PUSCH with transform precoding and 64QAM

| MCS | Modulation | Target code Rate | Spectral |
|---|---|---|---|
| index [symbol] | Order [symbol] | R × 1024 | efficiency |
| 0 | [symbol] | [symbol] | [symbol] |
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |

| | | |
|---|---|---|
| 28 | [symbol] | reserved |
| 29 | [symbol] | reserved |
| 30 | [symbol] | reserved |
| 31 | [symbol] | reserved |

[symbol]

indicates data missing or illegible when filed

In Table 40, for other equivalent conditions, the cases of {2,4,5,7} and {8,9,10,11} are paired depending on whether to apply transform precoding, but the MCS table identifying the pair may be different for each modulation scheme and each code rate. In addition, in case of applying transform precoding, π/2 BPSK modulation scheme may be used, so the code rate may vary depending on q in Table 40, and the spectral efficiency may also vary.

Even if the dynamic waveform indication is added to the case, Type 0 (random access), Type 1 (dynamic grant), and Type 2 (configured grant) and the MCS table configuration determined according to the modulation scheme and the DCI format scrambled with specific RNTI present in the PDCCH scheduling the PUSCH does not change. However, since only the application of transform precoding is different, the MCS table is finally determined according to the dynamic waveform indication. For example, if transformPrecoder=disabled is configured through RRC in case number=2, the terminal may refer to the MCS Table 5.1.3.1-3 indicated by the 2-D. However, if the dynamic waveform indication is transmitted through DCI and the application of transform precoding is indicated, the UE may refer to the MCS Table 6.1.4.1-2 indicated by 2-E in the case of case number=2. For reference, the MCS tables 5.1.3.1-2, 6.1.4.1-3, and 6.1.4.1-4 are referred by case number-D or case number-E, so in this case, whether to apply transform precoding is irrelevant, which eliminates ambiguity.

### Fourth Embodiment

The fourth embodiment describes PUSCH waveform switching in a retransmission situation due to HARQ.

If a waveform varies depending on initial transmission and retransmission, various ambiguities are involved. The DCI format or RA type may change, and the MCS level may also change. Since a base station has scheduling restrictions for each condition, the base station must consider waveform switching for initial transmission and retransmission.

A method to solve this structural problem is to maintain the waveforms of initial transmission and retransmission the same. In this case, the UE performs retransmission under the assumption that it will continue to use the waveform used for initial PUSCH transmission during a HARQ retransmission period.

However, the waveform of initial transmission and the waveform of retransmission may be determined differently. In this case, the UE does not expect that the scheduling is conducted with an RA type in which transform precoding is not considered. However, the following discloses factors to be considered.

Table 41 below shows two cases where both initial transmission and retransmission are DCI format 0_1 or 0_2.

TABLE 41

| Case # | | 1^{st} transmission | 2^{nd} transmission | Note |
|---|---|---|---|---|
| Case | DCI format | 0_1/0_2 | 0_1/0_2 | |
| 1a | RA type | Type 0, 1 | Type 0, 1 | |
| | PUSCH waveform | dynamic transform | dynamic transform | Scheduling restriction |
| | according to . . . | precoding indicator | precoding indicator | |
| | | (explicit/implicit) | (explicit/implicit) | |
| | I_{MCS} | <27 or 28 | <27 or 28 | i.e., RA can be changed |
| Case | DCI format | 0_1/0_2 | 0_1/0_2 | |
| 1b | RA type | Type 0, 1 | Type 0, 1 | |
| | PUSCH waveform | dynamic transform | dynamic transform | Scheduling restriction |
| | according to . . . | precoding indicator | precoding indicator | |
| | | (explicit/implicit) | (explicit/implicit) | |
| | I_{MCS} | <27 or 28 | ≥27 or 28 | i.e., RA is unchanged |

Table 41 uses the same DCI format as Case 1a and 1b, but each field included in the UL grant may be configured independently for each of an initial transmission and retransmission. In other words, link adaptation is possible during retransmission, unlike initial transmission. For example, (I_{MCS}, RAtype) may be configured as (20, RA type 1: 10 RBs contiguous) during initial transmission and (15, RA type 0: 30 RBs non-contiguous) during retransmission. In this way, for the same transport block, when the RA type changes, the code rate also changes. In the above example, the UE may use CP-OFDM for initial transmission and use DFT-s-OFDM indicated through the dynamic waveform indication for retransmission. In this case, when DFT-s-OFDM is used, only RA type 1 may be used, and the use of DFT-s-OFDM may be indicated by considering the scheduling restriction of the base station for the number M_{RB}^{PUSCH}=2^{α}^{₂}·3^{α}^{₃}·5^{α}^{₅} of RBs that may be scheduled on the PUSCH according to {α₂,α₃,α₅}, which is composed of an integer.

In addition, case 1b is similar to case 1a, and is refers to when only the MCS level is I_{MCS}≥27 or 28 at the time of retransmission. In this case, the UE follows a previous UL grant without changing the RA type field, so the same RA type as the initial or previous transmission is applied.

Table 42 below shows a case where DCI format 0_1 or 0_2 is used for initial transmission and DCI format 0_0 is used for retransmission.

TABLE 42

| | | | | |
|---|---|---|---|---|
| Case | DCI format | 0_1/0_2 | 0_0 | |
| 2a | RA type | Type 0, 1 | Type 1 | |
| | PUSCH waveform | dynamic transform | RRC | Scheduling restriction |
| | according to . . . | precoding indicator | (or implicit | |
| | | (explicit/implicit) | method) | |
| | I_{MCS} | <27 or 28 | <27 or 28 | i.e., RA can be changed |
| Case | DCI format | 0_1/0_2 | 0_0 | |
| 2b | RA type | Type 0, 1 | | |
| | PUSCH waveform | dynamic transform | RRC | Scheduling restriction |
| | according to . . . | precoding indicator | (or implicit | |
| | | (explicit/implicit) | method) | |
| | I_{MCS} | <27 or 28 | ≥27 or 28 | i.e., RA is unchanged |

Cases 2a and 2b are when different DCI formats are used for initial transmission and retransmission. DCI format 0 0 for retransmission operates in a fallback mode, and thus, is fixed to RA type 1. The corresponding DCI format does not include dynamic waveform indication. During initial transmission, there may be a case where the waveform determined through dynamic waveform indication and the waveform determined through RRC are different. For example, if DFT-s-OFDM is used during initial transmission and CP-OFDM is used according to RRC configuration during retransmission, a PUSCH coverage may be very low. Therefore, if DCI format 0_0, a fallback mode, is used during retransmission, it may be reasonable to use the same waveform as the initial or previous transmission. Other scheduling restrictions and the content related to I_{MCS} are the same as cases 1a and 1b.

In case 2b with I_{MCS}≥27 or 28, the same RA type as the initial or previous transmission is used, so a conflict may occur with the characteristics of DCI format 0_0, which is fixed to RA type 1. In other words, there is no problem when the initial transmission is RA type 1, but a problem occurs when the initial transmission is RA type 0. Therefore, in the case of DCI format 0_0 during retransmission, it can be configured to use RA type 1 or the existing RA type.

Table 43 below shows a case where DCI format 0_0 is used for initial transmission and DCI format 0_1 or 0_2 is used for retransmission.

TABLE 43

| | | | | |
|---|---|---|---|---|
| Case | DCI format | 0_0 | 0_1/0_2 | |
| 3a | RA type | Type 1 | Type 0, 1 | |
| | PUSCH waveform | RRC | dynamic transform | Scheduling restriction |
| | according to . . . | (or implicit | precoding indicator | |
| | | method) | (explicit/implicit) | |
| | I_{MCS} | <27 or 28 | <27 or 28 | i.e., RA can be changed |
| Case | DCI format | 0_0 | 0_1/0_2 | |
| 3b | RA type | Type 1 | Type 1 | |
| | PUSCH waveform | RRC | dynamic transform | Scheduling restriction |
| | according to . . . | (or implicit | precoding indicator | |
| | | method) | (explicit/implicit) | |
| | I_{MCS} | <27 or 28 | ≥27 or 28 | i.e., RA is unchanged |

Cases 3a and 3b are when initial transmission and retransmission use different DCI formats. DCI format 0_0 for initial transmission operates in a fallback mode and is fixed to RA type 1. Also, as described earlier, the corresponding DCI format does not include dynamic waveform indication. During initial transmission, the waveform determined by the dynamic waveform indication and the waveform determined by RRC may be different. Unlike cases 2a and 2b, CP-OFDM may be used by RRC configuration during initial transmission, and DFT-s-OFDM may be used through dynamic waveform indication to satisfy PUSCH coverage during retransmission. Other scheduling restrictions and contents related to I_{MCS} are the same as cases 1a and 1b.

In case 3b with I_{MCS}≥27 or 28, the same RA type as the initial or previous transmission must be used, so the RA type of retransmission must be the same as DCI format 0_0, which is fixed to RA type 1.

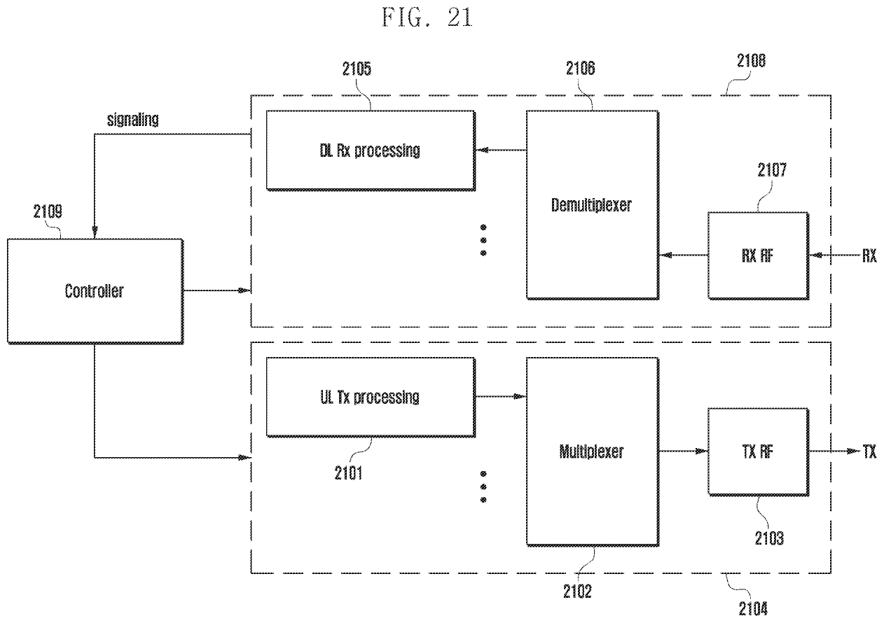

FIG. 21 illustrates a transmitter and receiver of a UE in a wireless communication system, according to an embodiment. Devices unrelated to the disclosure are not illustrated or described for convenience of description.

In FIG. 21, a UE may include a transmitter 2104 including a UL transmission processing block 2101, a multiplexer 2102, and a transmission RF block 2103, a receiver 2108 including a DL reception processing block 2105, a demultiplexer 2106, a reception RF block 2107, and a controller 2109. The controller 2109 may control the respective constitution blocks of the receiver 2108 for receiving a data channel or a control channel transmitted by a base station as described above and the respective constitution blocks of the transmitter 2104 for transmitting a UL signal.

The UL transmission processing block 2101 in the transmitter 2104 of the UE may generate a signal to be transmitted by performing processes such as channel coding, modulation, etc., which signal may be multiplexed with other UL signals by the multiplexer 2102, undergo signal processing by the transmission RF block 2103, and then transmitted to the base station.

The receiver 2108 of the UE may demultiplex a signal received from the base station and distribute the resulting signals to respective DL reception processing blocks. The DL reception processing block 2105 may obtain control information or data transmitted by the base station by performing processes such as demodulation, channel decoding, etc., on a DL signal from the base station. The receiver 2108 of the UE may support operation of the controller 2109 by applying an output result of the DL reception processing block to the controller 2109.

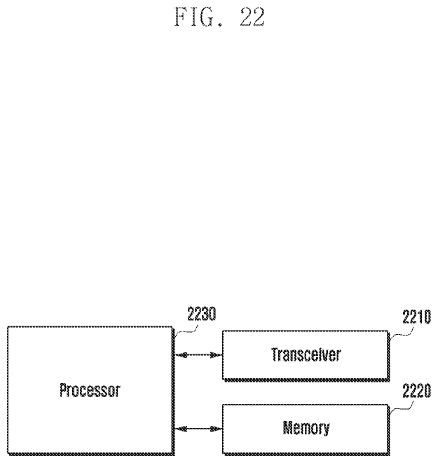

FIG. 22 is a block diagram of a structure of a UE according to an embodiment.

In FIG. 22, the UE may include a processor 2230, a transceiver 2210, and a memory 2220. However, the components of the UE are not limited to the above-described example. For example, the UE may include more or fewer components than those described above. The processor 2230, the transceiver 2210, and the memory 2220 may be implemented as a single chip. The transceiver 2210 in FIG. 22 may include the transmitter 2104 and the receiver 2108 in FIG. 21 In addition, the processor 2230 in FIG. 22 may include the controller 2109 in FIG. 21.

The processor 2230 may control a series of processes such that the UE may operate according to an embodiment. For example, components of the UE may be controlled to perform the transmission and reception method of the UE depending on whether a base station mode is a base station energy saving mode or a base station normal mode. The processor 2230 may include one or more processors and perform the UE transmission and reception methods in a wireless communication system to which the carrier aggregation is applied, by executing programs stored in the memory 2220.

The transceiver 2210 may transmit or receive signals to or from the base station. The signals transmitted or received to or from the base station may include control information and data. The transceiver 2210 may include an RF transmitter for up-converting and amplifying a frequency of a signal to be transmitted and an RF receiver for low-noise amplifying a received signal and down-converting its frequency. However, the transceiver 2210, and components of the transceiver 2210 are not limited to the RF transmitter and the RF receiver. The transceiver 2210 may receive a signal via a radio channel and output the signal to the processor 2230 and transmit a signal output from the processor 2230 via a radio channel.

The memory 2220 may store data and programs necessary for operations of the UE. The memory 2220 may store control information or data included in a signal transmitted or received by the UE. The memory 2220 may be composed of storage media, such as read-only memory

(ROM), random access memory (RAM), hard discs, compact disc (CD)-ROM, and digital versatile discs (DVDs), or a combination thereof. In addition, the memory 2220 may include a plurality of memories. The memory 2220 may store a program for performing transmission and reception operations of the UE according to whether the base station mode in the embodiments of the disclosure described above is the base station energy saving mode or the base station normal mode.

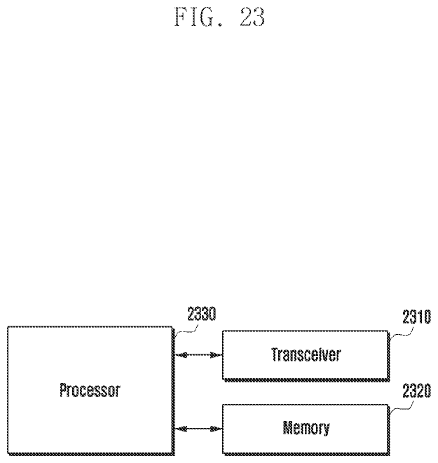

FIG. 23 is a block diagram illustrating a structure of a base station according to an embodiment.

As illustrated in FIG. 23, the base station may include a processor 2330, a transceiver 2310, and a memory 2320. However, the components of the base station are not limited to the above-described example. For example, the base station may include more or fewer components than those described above. The processor 2330, the transceiver 2310, and the memory 2320 may be implemented as a single chip.

The processor 2330 may control a series of processes such that the base station may operate according to the above-described embodiments. For example, the components of the base station may be controlled so that the base station performs a method of scheduling the UE according to whether the base station mode is the base station energy saving mode or the base station normal mode. The processor 2330 may include one or more processors and perform the method of scheduling a UE according to whether the base station mode of the disclosure described above is the base station energy saving mode or the base station normal mode by executing the program stored in the memory 2320.

The transceiver 2310 may transmit or receive signals to or from the UE. The signals transmitted or received to or from the UE may include control information and data. The transceiver 2310 may include an RF transmitter for up-converting and amplifying a frequency of a signal to be transmitted, an RF receiver for low-noise amplifying a received signal and down-converting its frequency, and the like. However, the transceiver 2310, and components of the transceiver 2310 are not limited to the RF transmitter and the RF receiver. The transceiver 2310 may receive a signal via a radio channel and output the signal to the processor 2330 and transmit a signal output from the processor 2330 via a radio channel.

The memory 2320 may store data and programs necessary for operations of the base station and may store control information or data included in a signal transmitted or received by the base station. The memory 2320 may be composed of storage media, such as ROM, RAM, hard discs, CD-ROM, and DVDs, or a combination thereof. The memory 2320 may also include a plurality of memories. The memory 2320 may store a program for performing the method of scheduling the UE according to whether the base station mode in the embodiments of the disclosure described above is the base station energy saving mode or the base station normal mode.

It is understood that combinations of blocks in flowcharts or process flow diagrams may be performed by computer program instructions. Because these computer program instructions may be loaded into a processor of a general-purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-executable or computer-readable memory capable of directing a computer or another programmable data processing apparatus to implement a function in a particular manner, and thus the instructions stored in the computer-executable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in a computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a terminal in a wireless communication system, the method comprising:
receiving downlink control information (DCI) from a base station;
identifying whether the DCI includes a dynamic waveform indicator; and
in case that the DCI includes the dynamic waveform indicator, transmitting, to the base station, an uplink signal through a physical uplink shared channel (PUSCH) based on an uplink waveform indicated by the dynamic waveform indicator.

2. The method of claim 1, wherein in case that the DCI includes the dynamic waveform indicator, a resource allocation type for the PUSCH is not determined as being a type 0, and a demodulation reference signal (DMRS) type for the PUSCH is not determined as being a type 2.

3. The method of claim 1, wherein in case that cyclic prefix orthogonal frequency division multiplexing (CP-OFDM) is indicated by information included in a radio resource control (RRC) message and discrete fourier transform spread orthogonal frequency division multiplexing (DFT-S-OFDM) is indicated by the dynamic waveform indicator, a resource allocation type for the PUSCH is determined as being a type 1.

4. The method of claim 3, wherein in case that the CP-OFDM is indicated by information included in the RRC message and the DFT-S-OFDM is indicated by the dynamic waveform indicator, the DMRS type for the PUSCH is determined as being the type 1.

5. A method performed by a base station in a wireless communication system, the method comprising:
transmitting downlink control information (DCI) to a terminal; and
in case that the DCI includes a dynamic waveform indicator, receiving, from the terminal, an uplink signal through a physical uplink shared channel (PUSCH) based on an uplink waveform indicated by the dynamic waveform indicator.

6. The method of claim 5, wherein in case that the DCI includes the dynamic waveform indicator, a resource allocation type for the PUSCH is not determined as being a type 0, and a demodulation reference signal (DMRS) type for the PUSCH is not determined as being a type 2.

7. The method of claim 5, wherein in case that cyclic prefix orthogonal frequency division multiplexing (CP-OFDM) is indicated by information included in a radio resource control (RRC) message and discrete fourier transform spread orthogonal frequency division multiplexing (DFT-S-OFDM) is indicated by the dynamic waveform indicator, a resource allocation type for the PUSCH is determined as being a type 1.

8. The method of claim 7, wherein in case that the CP-OFDM is indicated by information included in the RRC message and the DFT-S-OFDM is indicated by the dynamic waveform indicator, the DMRS type for the PUSCH is determined as being the type 1.

9. A terminal in a wireless communication system, the terminal comprising:
a transceiver; and
a controller coupled with the transceiver and configured to:
receive downlink control information (DCI) from a base station,
identify whether the DCI includes a dynamic waveform indicator, and
in case that the DCI includes a dynamic waveform indicator, transmit, to the base station, an uplink signal through a physical uplink shared channel (PUSCH) based on an uplink waveform indicated by the dynamic waveform indicator.

10. The terminal of claim 9, wherein in case that the DCI includes the dynamic waveform indicator, a resource allocation type for the PUSCH is not determined as being a type 0, and a demodulation reference signal (DMRS) type for the PUSCH is not determined as being a type 2.

11. The terminal of claim 9, wherein in case that cyclic prefix orthogonal frequency division multiplexing (CP-OFDM) is indicated by information included in a radio resource control (RRC) message, if discrete fourier transform spread orthogonal frequency division multiplexing (DFT-S-OFDM) is indicated by the dynamic waveform indicator, a resource allocation type for the PUSCH is determined as being a type 1.

12. The terminal of claim 11, wherein in case that the CP-OFDM is indicated by information included in the RRC message and the DFT-S-OFDM is indicated by the dynamic waveform indicator, the DMRS type for the PUSCH is determined as being the type 1.

13. A base station in a wireless communication system, the base station comprising:
a transceiver; and
a controller coupled with the transceiver and configured to:
transmit downlink control information (DCI) to a terminal, and
in case that the DCI includes a dynamic waveform indicator, receiving, from the terminal, an uplink signal through a physical uplink shared channel (PUSCH) based on an uplink waveform indicated by the dynamic waveform indicator.

14. The base station of claim 13, wherein in case that the DCI includes the dynamic waveform indicator, a resource allocation type for the PUSCH is not determined as being a type 0, and a demodulation reference signal (DMRS) type for the PUSCH is not determined as being a type 2.

15. The base station of claim 14, wherein in case that cyclic prefix orthogonal frequency division multiplexing (CP-OFDM) is indicated by information included in a radio resource control (RRC) message and discrete fourier transform spread orthogonal frequency division multiplexing (DFT-S-OFDM) is indicated by the dynamic waveform indicator, the resource allocation type for the PUSCH is determined as being a type 1 and the DMRS type for the PUSCH is determined as being a type 1.
